(19) United States
(12) Patent Application Publication
(10) Pub. No.: US 2026/0277016 A1
(43) Pub. Date: Sep. 17, 2026

(54) DISPLAY DEVICE

(71) Applicant: Beijing Shiyan Technology Co., Ltd., Beijing (CN)

(72) Inventors: Jian GAO, Beijing (CN); Xue DONG, Beijing (CN); Tao HONG, Beijing (CN); Kuanjun PENG, Beijing (CN); Zhongyuan WU, Beijing (CN)

(21) Appl. No.: 19/670,595

(22) Filed: May 7, 2026

Related U.S. Application Data
(63) Continuation-in-part of application No. 18/703,335, filed on Nov. 30, 2022.
(63) Continuation-in-part of application No. PCT/CN2025/075339, filed on Jan. 26, 2025.

(51) Int. Cl. G02B 30/28; G02B 30/31

(52) U.S. Cl. CPC G02B 30/28; G02B 30/31

(57) ABSTRACT

A display device includes a display panel including pixel repetition units arranged in an array along a first direction and a second direction. Each pixel repetition unit includes pixel islands arranged consecutively in the second direction. Each pixel island includes sub-pixels arranged to be spaced apart from each other in the first direction. The pixel repetition units include pixel repetition unit rows arranged in the second direction. The sub-pixels in one pixel repetition unit row of a pair of adjacent two pixel repetition unit rows of at least some of pairs of adjacent two pixel repetition unit rows are staggered relative to the sub-pixels in the other pixel repetition unit row of the pair of adjacent two pixel repetition unit rows in the first direction. A lengthwise direction of each sub-pixel is neither parallel nor perpendicular to the second direction.

### CROSS-REFERENCE TO RELATED APPLICATIONS

This is a Continuation-In-Part of U.S. patent application Ser. No. 18/703,335 filed Apr. 20, 2024, which is a National Phase Application filed under 35 U.S.C. 371 as a national stage of PCT/CN2022/135658 filed on Nov. 30, 2022; further, this Continuation-In-Part claims priority to PCT/CN2025/075339 filed on Jan. 26, 2025, the entire content of each of which is incorporated herein by reference.

### TECHNICAL FIELD

The present disclosure relates to the field of display technology, and in particular, to a display device.

### BACKGROUND

With continuous development of display technology, three-dimensional (3D) display technology is attracting more and more attention. The three-dimensional display technology can make a display picture become three-dimensional and realistic. The principle thereof is as follows: a left eye image and a right eye image with certain parallax are received by the left eye and the right eye of a person respectively, and after the two parallax images are received by the left eye and the right eye of the person respectively, information of the images is superposed and fused through the brain, such that a 3D visual display effect can be achieved. In order to realize compatibility of super multi-view 3D display and light field display, traditional sub-pixels are formed into pixel island structures, and each pixel island includes a plurality of sub-pixels. In a case where the display information of the plurality of sub-pixels is different from each other and a single eye enters a plurality of views (or viewpoints), traditional light field display can be realized. In a case where the display information of the plurality of sub-pixels is different from each other and a single eye enters a single view, super multi-view light field 3D display can be realized.

However, 3D display products in the prior art have a problem of Moire fringes.

### SUMMARY

Embodiments of the present disclosure provide a display device, including:
a display panel, including a plurality of pixel repetition units arranged in an array along a row direction and a column direction, wherein each of the pixel repetition units includes a plurality of pixel islands arranged consecutively in the column direction, each of the pixel islands includes a plurality of sub-pixels arranged to be spaced apart from each other in the row direction, the plurality of pixel repetition units include a plurality of pixel repetition unit rows arranged in the column direction, and the sub-pixels in one pixel repetition unit row of a pair of adjacent two pixel repetition unit rows of at least some of pairs of adjacent two pixel repetition unit rows are staggered relative to the sub-pixels in the other pixel repetition unit row of the pair of adjacent two pixel repetition unit rows in the row direction;
the sub-pixels in any one pixel repetition unit row are staggered relative to the sub-pixels in another pixel repetition unit row adjacent to the any one pixel repetition unit row in the row direction; and
a light splitting assembly, positioned on a display side of the display panel and including a plurality of light splitting repetition units which extend in the column direction and are consecutively arranged in the row direction, wherein each of the light splitting repetition units include M light splitting structures which extend in the column direction and are consecutively arranged in the row direction, and each light splitting repetition unit corresponds to N columns of the sub-pixels in each pixel repetition unit row, where each of M and N is an integer greater than 1, and M is coprime with N.

In some embodiments, the plurality of pixel repetition unit rows are divided into a plurality of pixel repetition unit groups, and each of the pixel repetition unit groups includes M pixel repetition unit rows; in each pixel repetition unit group, the sub-pixels in one pixel repetition unit row of any adjacent two pixel repetition unit rows are staggered relative to the sub-pixels in the other pixel repetition unit row of the adjacent two pixel repetition unit rows in the row direction; each pixel repetition unit group includes subunits in one-to-one correspondence with the plurality of light splitting repetition units; and
in each subunit, a ratio Jj of a staggered vector by which a c-th sub-pixel in a j-th pixel repetition unit row is staggered relative to the c-th sub-pixel in a first pixel repetition unit row in the row direction to a width of each sub-pixel in the row direction satisfies Jj=±E/M, where c is an integer greater than or equal to 1 and less than or equal to N, j is an integer greater than 1 and less than or equal to M, and E is an integer greater than or equal to 1, not equal to M, and not equal to an integer multiple of M.

In some embodiments, in a 2-nd to an M-th pixel repetition unit rows in each subunit, Jj corresponding to any two pixel repetition unit rows is not equal to each other, and an absolute value of a difference between Jj corresponding to any two pixel repetition unit rows is not an integer greater than or equal to 1.

In some embodiments, for the pair of adjacent two pixel repetition unit rows of at least some of pairs of adjacent two pixel repetition unit rows in each subunit, a ratio ΔJ of a staggered vector by which the c-th sub-pixel in one pixel repetition unit row is staggered relative to the c-th sub-pixel in the other pixel repetition unit row in the row direction to the width of each sub-pixel in the row direction is not equal to

$$\pm C \frac{1}{M} or \pm C \frac{M - 1}{M} ,$$

where C is an integer greater than 0.

In some embodiments, E is an integer greater than or equal to 1 and less than or equal to M−1.

In some embodiments, for the pair of adjacent two pixel repetition unit rows of at least some of pairs of adjacent two pixel repetition unit rows in each subunit, a ratio ΔJ of a staggered vector by which the c-th sub-pixel in one pixel repetition unit row is staggered relative to the c-th sub-pixel in the other pixel repetition unit row in the row direction to the width of each sub-pixel in the row direction is not equal to ±1/M or ±(M−1)/M.

In some embodiments, the sub-pixels in different subunits in a same pixel repetition unit row in each pixel repetition unit group have a same staggered vector.

In some embodiments, each light splitting repetition unit corresponds to K columns of pixel islands in each pixel repetition unit row, where K is an integer greater than 1.

In some embodiments, N is coprime with K.

In some embodiments, N/K is an integer.

In some embodiments, each of the pixel islands includes n sub-pixels arranged to be spaced apart from each other in the row direction, where n is an integer greater than 1; each light splitting repetition unit corresponds to and covers K columns of pixel islands in at least part of pixel repetition unit rows, and N=K×n, where K is an integer greater than 1, and M is coprime with K.

In some embodiments, outgoing light emitted from light emitting regions of N columns of sub-pixels in each pixel repetition unit row and then split by M light splitting structures forms a continuous light emitting region in a space.

In some embodiments, in the row direction, a width of M light splitting structures is equal to a width of N columns of sub-pixels.

In some embodiments, each sub-pixel includes a sub-pixel opening, and in the row direction, a ratio of a total width of n sub-pixel openings to a width of each pixel island is greater than or equal to 0.9/M and less than or equal to 1.

In some embodiments, in the row direction, the light emitting regions of N columns of sub-pixels in each pixel repetition unit row are complementarily spliced together in the space.

In some embodiments, in the row direction, a ratio of a width of each sub-pixel opening to the width of each pixel island is 1/M.

In some embodiments, in the row direction, the light emitting regions of N columns of sub-pixels in each pixel repetition unit row spatially overlap with each other.

In some embodiments, in the row direction, the light emitting regions of N columns of sub-pixels spatially overlap with each other uniformly.

In some embodiments, in the row direction, a ratio of a width of each sub-pixel opening to the width of each pixel island is i/M, where i is an integer greater than 1 and less than or equal to M−1.

In some embodiments, M is 5, J2 is −2/5 or 3/5, J3 is ⅕ or −4/5, J4 is −1/5 or 4/5, and J5 is ⅖ or −3/5.

In some embodiments, the display device further includes:
a spacer dielectric layer positioned between the light splitting assembly and the display panel.

In some embodiments, each of the light splitting structures is one of a geometric lens, a diffractive lens, a liquid crystal lens, or a liquid lens.

In some embodiments, each of the pixel repetition units includes three pixel islands arranged consecutively in the column direction; and
in each pixel repetition unit, the sub-pixels of a same pixel island have a same display color, and the sub-pixels of different pixel islands have different display colors.

In some embodiments, the display device further includes:
an eye tracking system for determining a position of an eye of a user in real time.

Embodiments of the present disclosure provide another display device, which includes:
a display panel including a display region, a plurality of pixel bars extending in a first direction and arranged in a second direction, and a plurality of light shielding portions; the first direction intersects with the second direction; an orthogonal projection of the plurality of light shielding portions on the display panel includes in the display region: a plurality of opening regions arranged in an array, and light shielding regions located between the opening regions; the plurality of light shielding portions include: a plurality of first light shielding portions extending in the first direction, and a plurality of second light shielding portions extending in a direction intersecting with the first direction; each pixel bar includes a plurality of sub-pixels arranged in the first direction; orthogonal projections of at least some of the first light shielding portions on the display panel respectively overlap with orthogonal projections of regions between pixel bars adjacent to the at least some of the first light shielding portions on the display panel, and orthogonal projections of at least some of the second light shielding portions on the display panel respectively overlap with orthogonal projections of the pixel bars on the display panel; and
a light splitting assembly positioned on a display side of the display panel; the light splitting assembly includes a plurality of light splitting structures extending in a third direction and arranged in a fourth direction; the third direction intersects with the fourth direction; and an included angle θ1 between the third direction and a direction of a normal line of the first direction is greater than or equal to 0° and less than or equal to 90°.

In some embodiments, the display panel is a liquid crystal display panel, the liquid crystal display panel including:
an array substrate including the plurality of pixel bars, a plurality of first signal lines, and a plurality of second signal lines; orthogonal projections of the first signal lines on the display panel and orthogonal projections of the second signal lines on the display panel fall into the light shielding regions; at least some of the first signal lines and at least some of the second signal lines are electrically connected to the plurality of pixel bars; the plurality of first signal lines extend along a horizontal direction, and the plurality of second signal lines extend along a vertical direction; the horizontal direction is perpendicular to the vertical direction, and the first direction is the horizontal direction or the vertical direction; and the first signal lines or the second signal lines also serve as the second light shielding portions;
an opposite substrate arranged opposite to the array substrate and including the first light shielding portions; and
a first liquid crystal layer positioned between the array substrate and the opposite substrate.

In some embodiments, the sub-pixels include pixel electrodes, orthogonal projections of the opening regions on the display panel overlap with orthogonal projections of the pixel electrodes on the display panel; and
the number of the second light shielding portions is less than the number of the pixel electrodes included in each pixel bar.

In some embodiments, each sub-pixel includes a pair of first sides extending in a direction intersecting with the first direction, an included angle θ2 between each first side and the direction of the normal line of the first direction is greater than 0° and less than 90°, and an included angle between an extending direction of each second light shielding portion and each first side is greater than 0°; and
orthogonal projections of the second light shielding portions on the display panel overlap with orthogonal projections of the sub-pixels on the display panel.

In some embodiments, the pixel electrodes and the first sides extend in a same direction, and orthogonal projections of the pixel electrodes on the display panel overlap with the orthogonal projections of the second light shielding portions on the display panel.

In some embodiments, the included angle θ1 between the third direction and the direction of the normal line of the first direction satisfies:

$$0.9 \times \frac{j \times P 2}{P 1} \leq \vert tan θ 1 \vert \leq 1.1 \times \frac{j \times P 2}{P 1} ;$$

where P1 is a period in which the pixel bars 2 are arranged, P2 is a period in which the sub-pixels in each pixel bar are arranged in the first direction, and j is an integer greater than or equal to 0.

In some embodiments, a total length of a region where a first preset length line segment overlaps with each second light shielding portion in the third direction is a first length; within each light splitting structure, first lengths corresponding to any first preset length line segment are equal to each other; the first preset length line segment extends along the third direction, and a length of a projection of the first preset length line segment on the direction of the normal line of the first direction is a difference between P1 and P4, where P1 is the period in which the pixel bars are arranged, and P4 is a width of each first light shielding portion in a direction perpendicular to the first direction.

In some embodiments, the included angle θ1 between the third direction and the direction of the normal line of the first direction satisfies:

$$0.9 \times \frac{i \times P 3}{P 1 - P 4} \leq \vert tan θ 1 \vert \leq 1.1 \times \frac{i \times P 3}{P 1 - P 4} ;$$

where P3 is a period in which the second light shielding portions are arranged in the first direction, a length of each second light shielding portion in the third direction is a second length, and i is a value obtained by rounding a ratio of the first length to the second length.

In some embodiments, the extending direction of each second light shielding portion is perpendicular to the first direction.

In some embodiments, an included angle θ3 between the extending direction of each second light shielding portion and the direction of the normal line of the first direction is greater than 0° and less than 90°.

In some embodiments, the included angle θ1 between the third direction and the direction of the normal line of the first direction satisfies:

$$\vert tan θ 1 \text{\textbar >} 1.1 \times \frac{i \times P 3}{P 1 - P 4} or \vert tan θ1 \vert < 0.9 \times \frac{i \times P 3}{P 1 - P 4} ; and$$

$$0.9 \times \frac{i \times P 3 - ( P 1 - P 4 ) \times tan θ 3}{P 1 - P 4} \leq \vert tan θ 1 \vert \leq 1.1 \times \frac{i \times P 3 - ( P 1 - P 4 ) \times tan θ 3}{P 1 - P 4} ;$$

where P3 is the period in which the second light shielding portions are arranged in the first direction, θ3 is the included angle between the extending direction of each second light shielding portion and the direction of the normal line of the first direction, the length of each second light shielding portion in the third direction is the second length, and i is the value obtained by rounding the ratio of the first length to the second length.

In some embodiments, the extending direction of each second light shielding portion is perpendicular to the first direction, the plurality of light shielding portions further include a plurality of third light shielding portions, each third light shielding portion includes at least one light shielding sub-portion, and each light shielding sub-portion includes a first portion;
an orthogonal projection of each first portion on the display panel does not overlap with the orthogonal projection of each of a respective first light shielding portion and a respective second light shielding portion on the display panel, and the orthogonal projection of each first portion on the display panel is adjacent to the orthogonal projection of the respective first light shielding portion or the respective second light shielding portion on the display panel;
the total length of the region where the first preset length line segment overlaps with each second light shielding portion in the third direction is the first length, a total length of a region where the first preset length line segment overlaps with each first portion of each third light shielding portion in the third direction is a third length, the third length is greater than or equal to 0; the length of each second light shielding portion in the third direction is the second length, and a total length of all first portions of each third light shielding portion in the third direction is a fourth length;
the value obtained by rounding the ratio of the first length to the second length is a first ratio, and a value obtained by rounding a ratio of the third length to the fourth length is a second ratio;
within each light splitting structure, a sum of the first ratio and the second ratio corresponding to any first preset length line segment is equal; and
the first preset length line segment extends along the third direction, and the length of the projection of the first preset length line segment on the direction of the normal line of the first direction is the difference between P1 and P4, where P1 is the period in which the pixel bars are arranged, and P4 is the width of each first light shielding portion in the direction perpendicular to the first direction.

In some embodiments, a sum S of areas of orthogonal projections of the first portions included in each third light shielding portion on the display panel satisfies:

$$0.9 \times ( P 4 - \frac{P 1 \times \vert tan θ 1 \vert - {i}^{′} \times P 3}{\vert tan θ 1 \vert} ) \times P 5 \leq S \leq 1 \text{.1} \times ( P 4 - \frac{P 1 \times \vert tan θ 1 \vert - {i}^{′} \times P 3}{\vert tan θ 1 \vert} ) \times P 5 ;$$

where

$$\vert tan θ 1 \vert > 1.1 \times \frac{i \times P 3}{P 1 - P 4} , or \vert tan θ1 \vert < 0.9 \times \frac{i \times P 3}{P 1 - P 4} ;$$

P3 is the period in which the second light shielding portions are arranged in the first direction, P5 is a width of each second light shielding portion in the first direction, i is the value obtained by rounding the ratio of the first length to the second length, and i′ is the sum of the first ratio and the second ratio.

In some embodiments, each third light shielding portion includes a plurality of light shielding sub-portions having equal areas.

In some embodiments, the plurality of light shielding sub-portions include a first light shielding sub-portion and a second light shielding sub-portion respectively located on both sides of a respective second light shielding portion in the first direction; and
orthogonal projections of first portions on the display panel are adjacent to the orthogonal projection of the respective second light shielding portion on the display panel.

In some embodiments, the first light shielding sub-portion and the second light shielding sub-portion are staggered relative to each other in the direction of the normal line of the first direction.

In some embodiments, a distance P9 by which the first light shielding sub-portion and the second light shielding sub-portion are staggered relative to each other in the direction of the normal line of the first direction satisfies:

$$0.9 \times \frac{P 5}{\vert tan θ 1 \vert} \leq P 9 \leq 1.1 \times \frac{P 5}{\vert tan θ 1 \vert} .$$

In some embodiments, a distance P8 between the first light shielding sub-portion or the second light shielding sub-portion and a nearest first light shielding portion satisfies:

$$0.9 \times ( P 1 - P 4 - \frac{( {i}^{′} - 1 ) \times P 3 + \frac{P 5}{2}}{\vert tan θ 1 \vert} ) \leq P 8 \leq 1.1 \times ( P 1 - P 4 - \frac{( {i}^{′} - 1 ) \times P 3 + \frac{P 5}{2}}{\vert tan θ 1 \vert} ) ,$$

where i′ is greater than or equal to 2.

In some embodiments, the first portion of the first light shielding sub-portion has the same shape as a shape of the first portion of the second light shielding sub-portion;
each first portion includes a pair of sides parallel to the first direction and another pair of sides perpendicular to the first direction;
a length P10 of each side perpendicular to the first direction of each first portion satisfies:

$$0.9 \times ( P 4 - \frac{P 1 \times \vert tan θ 1 \vert - {i}^{′} \times P 3}{\vert tan θ 1 \vert} ) \times \frac{P 5}{2} \leq P 10 \leq 1.1 \times ( P 4 - \frac{P 1 \times \vert tan θ 1 \vert - {i}^{′} \times P 3}{\vert tan θ 1 \vert} ) \times \frac{P 5}{2} ;$$

and
a length P11 of each side parallel to the first direction of each first portion satisfies:

$$0.9 \times \frac{P 5}{2} \leq P 11 \leq 1.1 \times \frac{P 5}{2} .$$

In some embodiments, each third light shielding portion includes a first light shielding sub-portion and a second light shielding sub-portion respectively located on both sides of a respective second light shielding portion in the first direction; and
orthogonal projections of first portions on the display panel are respectively adjacent to the orthogonal projections of the first light shielding portions on two sides of a respective pixel bar on the display panel.

In some embodiments, a distance P12 between two farthest sides of the first light shielding sub-portion and the second light shielding sub-portion in the direction of the normal line of the first direction satisfies: 0.9×(P1−P4)≤P12≤1.1×(P1−P4).

In some embodiments, a distance P13 between two farthest sides of the first light shielding sub-portion and the second light shielding sub-portion in the first direction satisfies: 0.9×(i′×P3−P5)≤P13≤1.1×(i′×P3−P5), where P5 is the width of each second shielding portion in the first direction, and i′ is greater than or equal to 1.

In some embodiments, the first portion of the first light shielding sub-portion has the same shape as a shape of the first portion of the second light shielding sub-portion;
each first portion includes a pair of sides parallel to the first direction and another pair of sides perpendicular to the first direction;
a length P10 of each side perpendicular to the first direction of each first portion satisfies:

$$0.9 \times \frac{P 5}{\vert tan θ 1 \vert} \leq P 10 \leq - 1.1 \times \frac{P 5}{\vert tan θ 1 \vert} ;$$

a length P11 of each side parallel to the first direction of each first portion satisfies:

$$0.9 \times ( P 4 - \frac{P 1 \times \vert tan θ 1 \vert - {i}^{′} \times P 3}{\vert tan θ 1 \vert} ) \times \frac{\vert tan θ 1 \vert}{2} \leq P 11 \leq 1 \text{.1} \times ( P4 - \frac{P 1 \times \vert tan θ 1 \vert - {i}^{′} \times P 3}{\vert tan θ 1 \vert} ) \times \frac{\vert tan θ 1 \vert}{2} ;$$

where i′ is greater than or equal to 1; and
a line connecting endpoints, which are at one end of their extending direction, of two closest sides extending along the first direction and respectively located in the first light shielding sub-portion and the second light shielding sub-portion forms an included angle, which is equal to 01, with the direction of the normal line of the first direction.

In some embodiments, each light shielding sub-portion includes a pair of sides parallel to the first direction and another pair of sides perpendicular to the first direction;
in the first direction, a sum H of lengths of the sides of all the first portions included in each third light shielding portion satisfies:

$$0.9 \times ( P 4 - \frac{P 1 \times \vert tan θ 1 \vert - {i}^{′} \times P 3}{\vert tan θ 1 \vert} ) \times \vert tan θ 1 \vert \leq H \leq 1 \text{.1} \times ( P 4 - \frac{P 1 \times \vert tan θ 1 \vert - {i}^{′} \times P 3}{\vert tan θ 1 \vert} ) \times \vert tan θ1 \vert ;$$

and
a length P10 of each side perpendicular to the first direction of each first portion satisfies:

$$0.9 \times \frac{P 5}{\vert tan θ 1 \vert} \leq P 10 \leq 1.1 \times \frac{P 5}{\vert tan θ 1 \vert} ;$$

where i′ is greater than or equal to 1.

In some embodiments, each third light shielding portion includes a plurality of light shielding sub-portions having different areas.

In some embodiments, each third light shielding portion includes a first light shielding sub-portion and a second light shielding sub-portion having different areas; and
orthogonal projections of first portions on the display panel are respectively adjacent to the orthogonal projections of the first light shielding portions on two sides of a respective pixel bar on the display panel.

In some embodiments, a distance P12 between two farthest sides of the first light shielding sub-portion and the second light shielding sub-portion in the direction of the normal line of the first direction satisfies: 0.9×(P1−P4)≤P12≤1.1×(P1−P4);
a distance P13 between two farthest sides of the first light shielding sub-portion and the second light shielding sub-portion in the first direction satisfies: 0.9×(P3−P5)≤P13≤1.1×(P3−P5), where P5 is the width of each second shielding portion in the first direction, and i′ is greater than or equal to 1; and
a line connecting endpoints, which are at one end of their extending direction, of two closest fifth sides respectively located in the first light shielding sub-portion and the second light shielding sub-portion forms an included angle, which is equal to θ1, with the direction of the normal line of the first direction.

In some embodiments, the third light shielding portions and the second light shielding portions are located in a same layer.

In some embodiments, the third light shielding portions and the first light shielding portions are located in a same layer.

In some embodiments, the third light shielding portions are located in a layer different from a layer where the second light shielding portions are located, and each light shielding sub-portion further includes a second portion; and
an orthogonal projection of the second portion on the display panel falls into the orthogonal projection of a respective second light shielding portion on the display panel.

In some embodiments, each third light shielding portion includes two light shielding sub-portions having equal areas; and
orthogonal projections of the two light shielding sub-portions included in each third light shielding portion on the display panel are respectively positioned on two sides of the orthogonal projection of a respective second light shielding portion on the display panel in the first direction, and the orthogonal projection of the second portion on the display panel overlaps with the orthogonal projection of the respective second light shielding portion on the display panel.

In some embodiments, an area S′ of the orthogonal projection of each light shielding sub-portion on the display panel satisfies:

$$0.9 \times \frac{P {5}^{2}}{2 \vert tan θ 1 \vert} \leq S ' \leq 1.1 \times \frac{P {5}^{2}}{2 \vert tan θ 1 \vert} ;$$

where

$$\vert tan θ1 \vert > 1.1 \times \frac{i \times P 3}{P 1 - P 4} , or \vert tan θ1 \vert < 0.9 \times \frac{i \times P 3}{P 1 - P 4} ;$$

P3 is the period in which the second light shielding portions are arranged in the first direction; P5 is the width of each second light shielding portion in the first direction; a length of each second light shielding portion in the third direction is a second length, and i is a value obtained by rounding the ratio of the first length to the second length.

In some embodiments, each light shielding sub-portion includes a pair of sides parallel to the first direction and another pair of sides perpendicular to the first direction;
a length P15 of each side parallel to the first direction of each light shielding sub-portion satisfies:

$$0.9 \times \frac{P 5}{2} \leq P 15 \leq 1.1 \times \frac{P 5}{2} ;$$

and
a length P16 of each side perpendicular to the first direction of each light shielding sub-portion satisfies:

$$0.9 \times \frac{P 5}{\vert tan θ1 \vert} \leq P 16 \leq 1.1 \times \frac{P 5}{\vert tan θ1 \vert} .$$

In some embodiments, θ2=θ1.

In some embodiments, each sub-pixel includes a pair of first sides extending perpendicular to the first direction, and each second light shielding portion extends perpendicular to the first direction.

In some embodiments, the sub-pixels in each pixel bar uniformly emit light in a direction intersecting with the sub-pixels.

In some embodiments, the sub-pixels in each pixel bar emit light non-uniformly in a direction intersecting with the sub-pixels,

$$0.9 \times \frac{j \times P 2}{P 1} \leq \vert tan θ1 \vert \leq 1.1 \times \frac{j \times P 2}{P 1} ,$$

and θ1=θ2;
The plurality of pixel bars are divided into a plurality of compensation groups, each compensation group includes N repetition units, and each repetition unit includes multiple pixel bars emitting light of different colors; and
in the first direction, a ratio Vk of a distance between a start point of the first sub-pixel in each pixel bar in each repetition unit and a preset start point to the period in which the sub-pixels are arranged satisfies

$$Vk = \pm C \frac{E}{N} ,$$

where k is an integer greater than or equal to 1 and less than or equal to N, C is an integer greater than 0, and E is an integer greater than or equal to 0 and less than N.

In some embodiments, C=1; in each compensation group, values of Vk corresponding to the N repetition units form an arithmetic progression, and a common difference of the arithmetic progression is 1/N.

In some embodiments, the sub-pixels in each pixel bar emit light non-uniformly in the direction intersecting with the sub-pixels,

$$\vert tan θ1 \vert > 1.1 \times \frac{j \times P 2}{P 1} or \vert tan θ1 \vert < 0.9 \times \frac{j \times P 2}{P 1} ,$$

and θ1=θ2.
the included angle θ1 between the third direction and the direction of the normal line of the first direction satisfies:

$$0.9 \times \frac{( 3 j \pm \frac{1}{Q} ) \times P 2}{3 P 1} \leq \vert tan θ1 \vert \leq 1.1 \times \frac{( 3 j \pm \frac{1}{Q} ) \times P 2}{3 P 1} ;$$

where Q is an integer greater than or equal to 2.

In some embodiments, the plurality of pixel bars include a plurality of first pixel bars, a plurality of second pixel bars, and a plurality of third pixel bars, and the plurality of pixel bars are periodically arranged by taking one of the first pixel bars, one of the second pixel bars and one of the third pixel bars as one of the repetition units; and
in the first direction, a ratio Vk of the distance between the start point of the first sub-pixel in each pixel bar and the preset start point and the period in which the sub-pixels are arranged satisfies

$$Vk = \pm C \frac{E}{3 Q} ,$$

where k is an integer greater than or equal to 1 and less than or equal to 3, C is an integer greater than 0, and E is an integer greater than or equal to 0 and less than 3.

In some embodiments, C=1; in each repetition unit, values of Vk corresponding to 3 pixel bars form an arithmetic progression having a common difference of

$$\frac{1}{3 Q} .$$

In some embodiments, the sub-pixels in each pixel bar emit light non-uniformly in the direction intersecting with the sub-pixels, and

$$0.9 \times \frac{j \times P 2}{P 1} \leq \vert tan θ1 \vert \leq 1.1 \times \frac{j \times P 2}{P 1} , θ 2 \neq θ1 ;$$

the included angle θ1 between the third direction and the direction of the normal line of the first direction and the included angle θ2 between each first side and the direction of the normal line of the first direction satisfy:

0.9×P2≤P1×(|tan θ1|−|tan θ2|)≤1.1×P2.

In some embodiments, the light splitting assembly includes one of a cylindrical lens array, a liquid crystal cylindrical lens array, a parallax barrier, or a liquid crystal dynamic parallax barrier.

In some embodiments, the display panel includes an array substrate and an opposite substrate disposed opposite to each other, and a plurality of first spacers and a first liquid crystal layer which are located between the array substrate and the opposite substrate; the opposite substrate is located on a side of the array substrate proximal to the light splitting assembly; the display panel includes the first light shielding portions and the second light shielding portions; an area of a pattern formed by the orthogonal projections of the first light shielding portions and the second light shielding portions on the display panel is a first area, an area of a pattern formed by the orthogonal projections of the first light shielding portions, the second light shielding portions, and the opening regions on the display panel is a second area, and a ratio of the first area to the second area is

$$\frac{Z 1}{Z 2}$$

where Z1 is less man Z2, Z1 and Z2 are coprime, Z1 is an integer, and Z2 is an integer greater than or equal to 2;
the light splitting assembly is a liquid crystal cell, and the liquid crystal cell includes a first substrate and a second substrate which are opposite to each other, and a second liquid crystal layer positioned between the first substrate and the second substrate; the second substrate is positioned on a side of the first substrate distal to the display panel;
the second substrate and/or the first substrate include a plurality of fourth light shielding portions; an orthogonal projection of each fourth light shielding portion on the second substrate overlaps with an orthogonal projection of a region between any adjacent two of the light splitting structures on the second substrate; in the horizontal direction or the vertical direction, a width P6 of each fourth light shielding portion and a width P7 of each first spacer satisfy: Z3×P6=Z4×P7, where Z3 and Z4 are integers and are coprime, and Z3=Z2;
or
the liquid crystal cell further includes a plurality of second spacers positioned between the first substrate and the second substrate; in the horizontal direction or the vertical direction, a width P8 of each second spacer and a width P7 of each first spacer satisfy: Z3×P8=Z4×P7, where Z3 and Z4 are integers and are coprime, and Z3=Z2.

In some embodiments, Z4=3m+1, where m is an integer greater than or equal to 1.

Embodiments of the present disclosure provide another display device, including:
a display panel, including a plurality of pixel repetition units arranged in an array along a first direction and a second direction, wherein each of the pixel repetition units includes a plurality of pixel islands arranged consecutively in the second direction, each of the pixel islands includes a plurality of sub-pixels arranged to be spaced apart from each other in the first direction, the plurality of pixel repetition units include a plurality of pixel repetition unit rows arranged in the second direction, and the sub-pixels in one pixel repetition unit row of a pair of adjacent two pixel repetition unit rows of at least some of pairs of adjacent two pixel repetition unit rows are staggered relative to the sub-pixels in the other pixel repetition unit row of the pair of adjacent two pixel repetition unit rows in the first direction; and
a light splitting assembly, positioned on a display side of the display panel and including M light splitting structures which extend in a third direction and are arranged in a fourth direction, the third direction intersects with the fourth direction, an included angle θ1 between the third direction and a direction of a normal line of the first direction is greater than or equal to 0° and less than or equal to 90°, and the light splitting assembly corresponds to N columns of the sub-pixels in each pixel repetition unit row, where each of M and N is an integer greater than 1, and M is coprime with N;
wherein a lengthwise direction of each sub-pixel (i.e., an extending direction of each sub-pixel or a direction in which each sub-pixel extends) is neither parallel nor perpendicular to the second direction.

In some embodiments, the display panel further includes a display region and a plurality of light shielding portions;
the first direction intersects with the second direction, an orthogonal projection of the plurality of light shielding portions on the display panel includes in the display region: a plurality of opening regions arranged in an array, and light shielding regions located between the opening regions; and
the plurality of light shielding portions include: a plurality of first light shielding portions extending in the first direction, and a plurality of second light shielding portions extending in a direction intersecting with the first direction.

In some embodiments, a column of sub-pixels arranged in the second direction forms a pixel bar; and
orthogonal projections of at least some of the first light shielding portions on the display panel respectively overlap with orthogonal projections of regions between pixel bars adjacent to the at least some of the first light shielding portions on the display panel, and orthogonal projections of at least some of the second light shielding portions on the display panel respectively overlap with orthogonal projections of the pixel bars on the display panel.

In some embodiments, the display panel is a liquid crystal display panel, the liquid crystal display panel including:
an array substrate including the pixel bars, a plurality of first signal lines, and a plurality of second signal lines; orthogonal projections of the first signal lines on the display panel and orthogonal projections of the second signal lines on the display panel fall into the light shielding regions; at least some of the first signal lines and at least some of the second signal lines are electrically connected to the pixel bars; the plurality of first signal lines extend along a horizontal direction, and the plurality of second signal lines extend along a vertical direction; the horizontal direction is perpendicular to the vertical direction, and the first direction is the horizontal direction or the vertical direction; and the first signal lines or the second signal lines also serve as the second light shielding portions;
an opposite substrate arranged opposite to the array substrate and including the first light shielding portions; and
a first liquid crystal layer positioned between the array substrate and the opposite substrate.

In some embodiments, the sub-pixels include pixel electrodes, orthogonal projections of the opening regions on the display panel overlap with orthogonal projections of the pixel electrodes on the display panel; and
a number of the second light shielding portions is less than a number of the pixel electrodes included in each pixel bar.

In some embodiments, each sub-pixel includes a pair of first sides extending in a direction intersecting with the first direction, an included angle θ2 between each first side and the direction of the normal line of the first direction is greater than 0° and less than 90°, and an included angle between an extending direction of each second light shielding portion and each first side is greater than 0°; and
orthogonal projections of the second light shielding portions on the display panel overlap with orthogonal projections of the sub-pixels on the display panel.

In some embodiments, the pixel electrodes included in the sub-pixels and the first sides extend in a same direction, and orthogonal projections of the pixel electrodes on the display panel overlap with the orthogonal projections of the second light shielding portions on the display panel.

In some embodiments, the included angle θ1 between the third direction and the direction of the normal line of the first direction satisfies:

$$0.9 \times \frac{j \times P 2}{P 1} \leq \vert tan θ1 \vert \leq 1.1 \times \frac{j \times P 2}{P 1} ;$$

where P1 is a period in which the pixel bars are arranged, P2 is a period in which the sub-pixels in each pixel bar are arranged in the first direction, and j is an integer greater than or equal to 0.

In some embodiments, a total length of a region where a first preset length line segment overlaps with each second light shielding portion in the third direction is a first length; within each light splitting structure, first lengths corresponding to any first preset length line segment are equal to each other; and
the first preset length line segment extends along the third direction, and a length of a projection of the first preset length line segment on the direction of the normal line of the first direction is a difference between P1 and P4, where P1 is a period in which the pixel bars are arranged, and P4 is a width of each first light shielding portion in a direction perpendicular to the first direction.

In some embodiments, the included angle θ1 between the third direction and the direction of the normal line of the first direction satisfies:

$$0.9 \times \frac{i \times P 3}{P 1 - P 4} \leq \vert tan θ1 \vert \leq 1.1 \times \frac{i \times P 3}{P 1 - P 4} ;$$

where P3 is a period in which the second light shielding portions are arranged in the first direction, a length of each second light shielding portion in the third direction is a second length, and i is a value obtained by rounding a ratio of the first length to the second length.

In some embodiments, the extending direction of each second light shielding portion is perpendicular to the first direction.

In some embodiments, an included angle θ3 between the extending direction of each second light shielding portion and the direction of the normal line of the first direction is greater than 0° and less than 90°.

In some embodiments, the included angle θ1 between the third direction and the direction of the normal line of the first direction satisfies:

$$\vert tan θ1 \vert > 1.1 \times \frac{i \times P 3}{P 1 - P 4} or \vert tan θ1 \vert < 0.9 \times \frac{i \times P 3}{P 1 - P 4} ; and$$

$$0.9 \times \frac{i \times P 3 - ( P 1 - P 4 ) \times tan θ3}{P 1 - P 4} \leq \vert tan θ1 \vert \leq 1.1 \times \frac{i \times P 3 - ( P 1 - P 4 ) \times tan θ3}{P 1 - P 4} ;$$

where P3 is a period in which the second light shielding portions are arranged in the first direction, θ3 is the included angle between the extending direction of each second light shielding portion and the direction of the normal line of the first direction, a length of each second light shielding portion in the third direction is a second length, and i is a value obtained by rounding a ratio of the first length to the second length.

In some embodiments, the extending direction of each second light shielding portion is perpendicular to the first direction, the plurality of light shielding portions further include a plurality of third light shielding portions, each third light shielding portion includes at least one light shielding sub-portion, and each light shielding sub-portion includes a first portion;
an orthogonal projection of each first portion on the display panel does not overlap with the orthogonal projection of each of a respective first light shielding portion and a respective second light shielding portion on the display panel, and the orthogonal projection of each first portion on the display panel is adjacent to the orthogonal projection of the respective first light shielding portion or the respective second light shielding portion on the display panel;
a total length of a region where a first preset length line segment overlaps with each second light shielding portion in the third direction is a first length, a total length of a region where the first preset length line segment overlaps with each first portion of each third light shielding portion in the third direction is a third length, the third length is greater than or equal to 0; a length of each second light shielding portion in the third direction is a second length, and a total length of all first portions of each third light shielding portion in the third direction is a fourth length;
a value obtained by rounding a ratio of the first length to the second length is a first ratio, and a value obtained by rounding a ratio of the third length to the fourth length is a second ratio;
within each light splitting structure, a sum of the first ratio and the second ratio corresponding to any first preset length line segment is equal; and
the first preset length line segment extends along the third direction, and a length of a projection of the first preset length line segment on the direction of the normal line of the first direction is a difference between P1 and P4, where P1 is a period in which the pixel bars are arranged, and P4 is a width of each first light shielding portion in a direction perpendicular to the first direction.

In some embodiments, a sum S of areas of orthogonal projections of the first portions included in each third light shielding portion on the display panel satisfies:

$$0.9 \times ( P 4 - \frac{P 1 \times \vert tan θ1 \vert - {i}^{′} \times P 3}{\vert tan θ1 \vert} ) \times P 5 \leq S \leq 1.1 \times ( P 4 - \frac{P 1 \times \vert tan θ1 \vert - {i}^{′} \times P 3}{\vert tan θ1 \vert} ) \times P 5 ;$$

where

$$\vert tan θ1 \vert > 1.1 \times \frac{i \times P 3}{P 1 - P 4} , or \vert tan θ1 \vert < 0.9 \times \frac{i \times P 3}{P 1 - P 4} ;$$

P3 is a period in which the second light shielding portions are arranged in the first direction, P5 is a width of each second light shielding portion in the first direction, i is the value obtained by rounding the ratio of the first length to the second length, and i′ is the sum of the first ratio and the second ratio.

In some embodiments, each third light shielding portion includes a plurality of light shielding sub-portions having equal areas.

In some embodiments, the plurality of light shielding sub-portions include a first light shielding sub-portion and a second light shielding sub-portion respectively located on both sides of a respective second light shielding portion in the first direction; and
orthogonal projections of first portions on the display panel are adjacent to the orthogonal projection of the respective second light shielding portion on the display panel.

In some embodiments, the first light shielding sub-portion and the second light shielding sub-portion are staggered relative to each other in the direction of the normal line of the first direction.

In some embodiments, a distance P9 by which the first light shielding sub-portion and the second light shielding sub-portion are staggered relative to each other in the direction of the normal line of the first direction satisfies:

$$0.9 \times \frac{P 5}{\vert tan θ 1 \vert} \leq P 9 \leq 1.1 \times \frac{P 5}{\vert tan θ 1 \vert} .$$

In some embodiments, in the first direction, a width of the M light splitting structures is equal to a width of N columns of sub-pixels.

### BRIEF DESCRIPTION OF THE DRAWINGS

To more clearly illustrate technical solutions according to embodiments of the present disclosure, the drawings accompanying the description of the embodiments will be briefly described below. It is apparent that the figures accompanying the description below are only some embodiments of the present disclosure, and it is obvious for one of ordinary skill in the art that other figures may be obtained according to the provided figures without inventive efforts, in which:

FIG. 1 is a schematic diagram illustrating a structure of a display device in the related art;

FIG. 2 is a schematic diagram of a relative brightness distribution according to an embodiment of the present disclosure;

FIG. 3 is a schematic diagram of a visual sensory distribution according to an embodiment of the present disclosure;

FIG. 4 is a schematic diagram illustrating a structure of a display device according to an embodiment of the present disclosure;

FIG. 5 is a schematic diagram of a relative brightness distribution of a subunit according to an embodiment of the present disclosure;

FIG. 6 is a schematic diagram of a visual sensory distribution of a subunit according to an embodiment of the present disclosure;

FIG. 7 is a schematic diagram of a visual sensory distribution of a plurality of subunits according to an embodiment of the present disclosure;

FIG. 8 is a schematic diagram illustrating light paths of light output from sub-pixels of a display device according to an embodiment of the present disclosure;

FIG. 9 is a schematic diagram illustrating light paths of light output from sub-pixels, which have been spliced together, of a display device according to an embodiment of the present disclosure;

FIG. 10 is a schematic diagram illustrating light paths of light output from sub-pixels of another display device according to an embodiment of the present disclosure;

FIG. 11 is a schematic diagram illustrating light paths of light output from sub-pixels, which have been spliced together, of another display device according to an embodiment of the present disclosure;

FIG. 12 is a schematic diagram illustrating a structure of another display device according to an embodiment of the present disclosure;

FIG. 13 is a schematic diagram illustrating a structure of a display panel according to an embodiment of the present disclosure;

FIG. 14 is a schematic diagram illustrating a structure of another display panel according to an embodiment of the present disclosure;

FIG. 15 is a schematic diagram illustrating a structure of another display device according to an embodiment of the present disclosure;

FIG. 16 is a schematic diagram illustrating a structure of another display device according to an embodiment of the present disclosure;

FIG. 17 is an enlarged schematic diagram illustrating a region B1 in FIG. 16 according to an embodiment of the present disclosure;

FIG. 18 is a schematic diagram illustrating a structure of another display device according to an embodiment of the present disclosure;

FIG. 19 is a schematic diagram illustrating a structure of another display device according to an embodiment of the present disclosure;

FIG. 20 is a schematic diagram illustrating a structure of another display device according to an embodiment of the present disclosure;

FIG. 21 is a schematic diagram illustrating a structure of another display device according to an embodiment of the present disclosure;

FIG. 22 is a schematic diagram illustrating a structure of another display device according to an embodiment of the present disclosure;

FIG. 23 is a schematic diagram illustrating a structure of another display device according to an embodiment of the present disclosure;

FIG. 24 is a schematic diagram illustrating a structure of another display device according to an embodiment of the present disclosure;

FIG. 25 is a schematic diagram illustrating a structure of another display device according to an embodiment of the present disclosure;

FIG. 26 is a schematic diagram illustrating a structure of another display device according to an embodiment of the present disclosure;

FIG. 27 is a schematic diagram illustrating a structure of another display device according to an embodiment of the present disclosure;

FIG. 28 is a schematic diagram illustrating a structure of another display device according to an embodiment of the present disclosure;

FIG. 29 is a schematic diagram illustrating a structure of another display device according to an embodiment of the present disclosure;

FIG. 30 is a schematic diagram illustrating a non-uniform distribution of brightness according to an embodiment of the present disclosure;

FIG. 31 is a schematic diagram illustrating an angular spectrogram with all pixels being turned on according to an embodiment of the present disclosure;

FIG. 32 is a schematic diagram illustrating a left eye angular spectrogram and a right eye angular spectrogram at a 0° viewing angle according to an embodiment of the present disclosure;

FIG. 33 is a schematic diagram illustrating a left eye angular spectrogram and a right eye angular spectrogram at a 15° viewing angle according to an embodiment of the present disclosure;

FIG. 34 is a schematic diagram illustrating a left eye angular spectrogram and a right eye angular spectrogram at a 28° viewing angle according to an embodiment of the present disclosure;

FIG. 35 is a schematic diagram illustrating another angular spectrogram with all pixels being turned on according to an embodiment of the present disclosure;

FIG. 36 is a schematic diagram illustrating a structure of another display device according to an embodiment of the present disclosure; and

FIG. 37 is a schematic diagram illustrating a structure of another display device according to an embodiment of the present disclosure.

### DETAILED DESCRIPTION OF EMBODIMENTS

To make the objects, technical solutions and advantages of the embodiments of the present disclosure more apparent, the technical solutions of the embodiments of the present disclosure will be clearly and completely described below with reference to the drawings accompanying the embodiments of the present disclosure. It is to be understood that the described embodiments are only a few, but not all, embodiments of the present disclosure. The embodiments and features of the embodiments of the present disclosure may be combined with each other in case of no conflict. All other embodiments, which may be derived by one of ordinary skill in the art from the described embodiments of the present disclosure without inventive step, are within the protection scope of the present disclosure.

Unless defined otherwise, technical or scientific terms used herein shall have the ordinary meaning as understood by one of ordinary skill in the art to which this disclosure belongs. The use of “first”, “second,” and the like in this disclosure is not intended to indicate any order, quantity, or importance, but rather is used for distinguishing one element from another. The word “include”, “comprise”, or the like, means that the element or item preceding the word contains the element or item listed after the word and its equivalent, but does not exclude the presence of other elements or items. The term “connected”, “coupled”, or the like is not limited to physical or mechanical connections, but may include electrical connections, whether direct or indirect.

It should be noted that the sizes and shapes of the various components in the drawings are not necessarily to scale, but are merely intended to schematically illustrate the present disclosure. Further, like reference numerals refer to like or similar elements or elements having like or similar functions throughout the drawings.

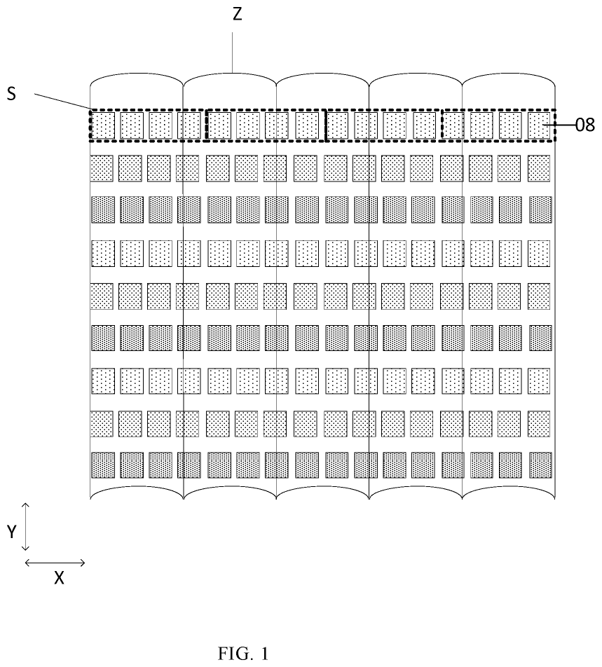

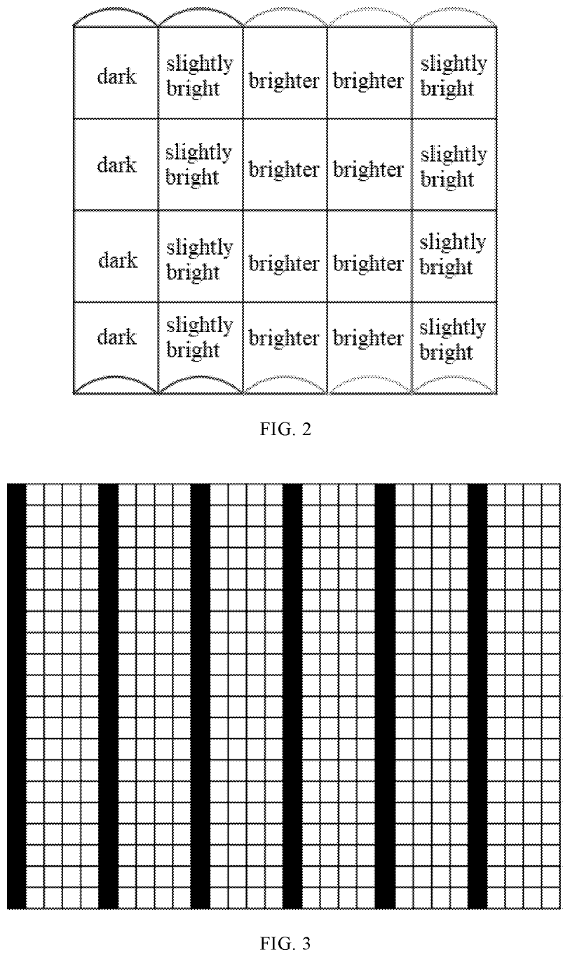

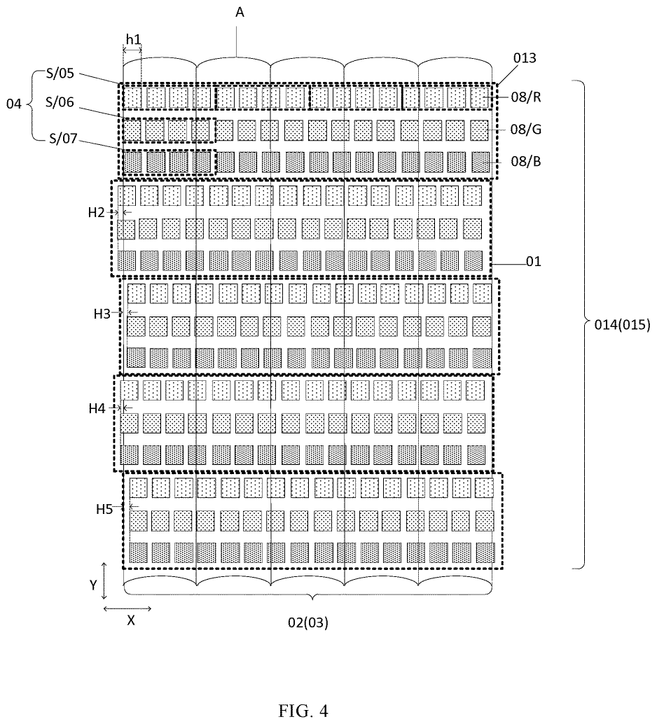

In the related art, as shown in FIG. 1, a display device includes a plurality of pixel islands S arranged to be spaced apart from each other in a row direction X and a column direction Y, and a plurality of cylindrical lenses Z. Each pixel island S has a plurality of sub-pixels 08 arranged to be spaced apart from each other in the row direction X. The M cylindrical lenses Z correspond to and cover N columns of sub-pixels, such that a problem of macroscopic Moire fringes is solved, but a problem of microscopic Moire fringes occurs. In a unit with M=5 as a period, a brightness of a region corresponding to each cylindrical lens is different at different viewing angles in a space, and the brightnesses of regions corresponding to the 5 cylindrical lenses seen at any viewing angle are different from each other. A relative brightness distribution of the 5 regions seen at one viewing angle is as shown in FIG. 2, and a visual sensory effect perceived by a person is as shown in FIG. 3, where one of the 5 regions has the lowest brightness, called a dark region. Dark regions connected to each other form a thin stripe, and thin stripes have a large distance (which is about 727.2 μm) therebetween and therefore are easily recognized by human eyes, resulting in that the display device has the problem of microscopic Moire fringes.

An embodiment of the present disclosure provides a display device. As shown in FIG. 4, the display device includes a display panel 01 and a light splitting assembly 02.

The display panel 01 includes a plurality of pixel repetition units 04 arranged in an array along a row direction X and a column direction Y. Each pixel repetition unit 04 includes a plurality of pixel islands S arranged consecutively in the column direction. Each pixel island S includes a plurality of sub-pixels 08 arranged to be spaced apart from each other in the row direction X. The plurality of pixel repetition units 04 include a plurality of pixel repetition unit rows 013 arranged in the column direction Y. For any adjacent two pixel repetition unit rows 013, sub-pixels 08 in one pixel repetition unit row 013 are staggered (or misaligned) relative to sub-pixels 08 in the other pixel repetition unit row 013 in the row direction X.

The light splitting assembly 02 is positioned on a display side of the display panel 01, and includes a plurality of light splitting repetition units 03 extending in the column direction Y and arranged consecutively in the row direction X. Each of the light splitting repetition units 03 includes M light splitting structures A extending in the column direction Y and arranged consecutively in the row direction X. Each light splitting repetition unit 03 corresponds to N columns of sub-pixels in each pixel repetition unit row, where each of M and N is an integer greater than 1, and M is coprime with N.

It should be noted that, the expression “for any adjacent two pixel repetition unit rows, sub-pixels in one pixel repetition unit row are staggered relative to sub-pixels in the other pixel repetition unit row in the row direction” means that centers of the sub-pixels in the adjacent two pixel repetition unit rows are not on a straight line in the column direction.

In the display device according to the present embodiment, the M light splitting structures correspond to N columns of sub-pixels in each pixel repetition unit row, and each of M and N is an integer greater than 1. That is, the light splitting structures are in a many-to-many correspondence with the sub-pixels. As such, it can be avoided that each light splitting structure has a too small size in the row direction, it can be avoided that the difficulty for manufacturing the light splitting assembly is increased, and it can be avoided that a divergence angle of light output from the sub-pixels being increased, crosstalk between views being increased, and the display effect being affected, are caused by the diffraction of each light splitting structure with a too small size. Further, since in at least some adjacent two pixel repetition unit rows, the sub-pixels in one pixel repetition unit row are staggered relative to the sub-pixels in another pixel repetition unit row adjacent to the one pixel repetition unit row in the row direction, such that the distribution of the dark regions corresponding to the light splitting repetition units can be disturbed, to make the dark regions arranged in a staggered manner, thereby preventing the dark regions from forming thin stripes continuously in the column direction, and mitigating the problem of microscopic Moire fringes.

It should be noted that, the expression that each light splitting repetition unit corresponds to N columns of sub-pixels in each pixel repetition unit row means that, an orthogonal projection of each light splitting repetition unit on a plane where the display panel is located overlaps with an orthogonal projection of the N columns of sub-pixels in each pixel repetition unit row on the plane where the display panel is located. Since for any adjacent two pixel repetition unit rows, sub-pixels in one pixel repetition unit row are staggered relative to sub-pixels in the other pixel repetition unit row in the row direction X, for example, for a part of pixel repetition unit rows, the orthogonal projection of the light splitting repetition unit on the plane where the display panel is located completely covers the orthogonal projection of the N columns of sub-pixels in the part of pixel repetition unit rows on the plane where the display panel is located; for the remaining pixel repetition unit rows, the orthogonal projection of the light splitting repetition unit on the plane where the display panel is located does not completely cover the orthogonal projection of the N columns of sub-pixels in the remaining pixel repetition unit rows on the plane where the display panel is located, i.e., for the sub-pixels located at an edge of the light splitting repetition unit, the orthogonal projection of the light splitting repetition unit on the plane where the display panel is located only covers a part of the orthogonal projection of these sub-pixels on the plane where the display panel is located.

In some embodiments, as shown in FIG. 4, the sub-pixels 08 in one pixel repetition unit row 013 are staggered relative to the sub-pixels 08 in another pixel repetition unit row 013 adjacent to the one pixel repetition unit row 013 in the row direction X. Therefore, there are no dark regions adjacent to each other in the column direction, thereby avoiding a thin stripe formed by continuous dark regions in the column direction, and effectively solving the problem of microscopic Moire fringes.

It should be noted that, the display device according to an embodiment of the present disclosure may implement three-dimensional (3D) display, and may also switch between 3D display and 2D display. Each pixel island may serve as a sub-pixel of 2D display. Since each pixel island includes a plurality of sub-pixels, a resolution in a 3D display mode may be kept to be the same as a resolution in a 2D display mode, and by being combined with an eye-tracking system, multi-view display with a large viewing angle and 3D display with higher pixel density (PPI) may be achieved, such that an information amount is large, and a color crosstalk between adjacent views is low.

In a specific implementation, the light splitting structures are configured to control a light outgoing angle of the sub-pixels, such that the sub-pixels emit light directionally.

In a specific implementation, the display panel may be one of a liquid crystal display (LCD) panel, an organic light emitting diode (OLED) display panel, a quantum dot light emitting diode (QLED), a micro inorganic light emitting diode (micro LED) display panel, or a mini light emitting diode (mini LED) display panel.

In some embodiments, as shown in FIG. 4, each pixel repetition unit 04 includes three pixel islands S arranged consecutively in the column direction Y; and in each pixel repetition unit 04, the sub-pixels 08 of a same pixel island S have a same display color, and the sub-pixels 08 of different pixel islands S have different display colors.

In some embodiments, as shown in FIG. 4, each pixel repetition unit 04 includes a first pixel island 05, a second pixel island 06, and a third pixel island 07. The first pixel island 05 includes a plurality of red sub-pixels R, the second pixel island 06 includes a plurality of green sub-pixels G, and the third pixel island 07 includes a plurality of blue sub-pixels B.

In some embodiments, as shown in FIG. 4, the sub-pixels 08 in a row of pixel islands S has a same display color.

In some embodiments, as shown in FIG. 4, the plurality of pixel repetition unit rows 013 are divided into a plurality of pixel repetition unit groups 014, and each pixel repetition unit group 014 includes M pixel repetition unit rows 013. In each pixel repetition unit group 014, the sub-pixels 08 in one pixel repetition unit row 013 are staggered relative to the sub-pixels 08 in another pixel repetition unit row 013 adjacent to the one pixel repetition unit row 013 in the row direction X. Each pixel repetition unit group 014 is divided into a plurality of subunits 015 in one-to-one correspondence with the light splitting repetition units 03, i.e., a portion, which corresponds to the M light splitting structures, of each pixel repetition unit group 014 is one subunit 015.

It should be noted that in FIG. 4, M=5, i.e., each pixel repetition unit group 014 includes 5 pixel repetition unit rows 013, and only one subunit 015, i.e. only the part of each pixel repetition unit group 014 corresponding to the 5 light splitting structures A, is shown in FIG. 4.

In some embodiments, as shown in FIG. 4, in each subunit, a ratio Jj of a staggered vector Hj by which a c-th sub-pixel 08 in a j-th pixel repetition unit row 013 is staggered relative to the c-th sub-pixel 08 in a first pixel repetition unit row 013 in the row direction X to a width h1 of each sub-pixel in the row direction X satisfies Jj=+E/M, where c is an integer greater than or equal to 1 and less than or equal to N, j is an integer greater than 1 and less than or equal to M, and E is an integer greater than or equal to 1, not equal to M, and not equal to an integer multiple of M.

That is, in the present embodiment, in each subunit, each sub-pixel in each of a 2-nd pixel repetition unit row to an M-th pixel repetition unit row is staggered relative to a corresponding sub-pixel in the first pixel repetition unit row by Jj×h1.

It should be noted that, the row direction X shown in FIG. 4 is a left-right extension direction in the figure. In a case where a sub-pixel 08 in the j-th pixel repetition unit row 013 is staggered to the left relative to a corresponding sub-pixel 08 in the first pixel repetition unit row 013, Hj is positive, and Jj=+E/M. In a case where a sub-pixel 08 in the j-th pixel repetition unit row 013 is staggered to the right relative to the corresponding sub-pixel 08 in the first pixel repetition unit row 013, Hj is negative, and Jj=−E/M.

In some embodiments, in each pixel repetition unit group, the sub-pixels of different subunits in a same pixel repetition unit row have a same staggered vector. That is, in each pixel repetition unit group, for the M pixel repetition unit rows 013, the ratio Jj of the staggered vector Hj by which a sub-pixel in the j-th pixel repetition unit row is staggered relative to a corresponding sub-pixel in the first pixel repetition unit row in the row direction to the width h1 of each sub-pixel in the row direction X satisfies Jj=+E/M.

It should be noted that, a relative brightness distribution of a region of each subunit corresponding to the M light splitting structures may be divided into M×M bright regions. For each subunit, in the case where each sub-pixel in each of the 2-nd pixel repetition unit row to the M-th pixel repetition unit row is staggered relative to a corresponding sub-pixel in the first pixel repetition unit row, a dark region with the lowest brightness in bright regions corresponding to the 2-nd to M-th pixel repetition unit rows is staggered relative to a dark region corresponding to the first pixel repetition unit row, such that a distribution of dark regions among the regions corresponding to the subunits can be disturbed, and the dark regions are staggered. Further, since the display panel includes a plurality of pixel repetition unit groups that include a plurality of subunits, each of the subunits serves as the minimum unit disturbing the distribution of dark regions. Since the distribution of the dark regions of each subunit is disturbed in the column direction, a thin stripe formed by the dark regions consecutively in the column direction for the whole display device can be avoided, and the problem of microscopic Moire fringes is solved.

In a specific implementation, M=5, and in this case, Jj may be −11/5, −6/5, −4/5, −3/5, −2/5, −1/5, 1/5, 2/5, 3/5, 4/5, 6/5, 11/5, or the like.

It should be noted that in a case where a difference between two values (e.g., −6/5 and −1/5) of Jj is M or an integer multiple of M, the number of bright regions between the dark region of a current row and the dark region of the first row when Jj is −6/5 is the same as the number of the bright regions between the dark region of the current row and the dark region of the first row when Jj is −1/5.

In some embodiments, in the 2-nd to the M-th pixel repetition unit rows in each subunit, Jj corresponding to any two pixel repetition unit rows is not equal to each other, and an absolute value of a difference between Jj corresponding to any two pixel repetition unit rows is not an integer greater than or equal to 1. Thus, in each pixel repetition unit group, the dark regions are not positioned in a same column in the column direction, such that a distance between two dark regions arranged in the column direction can be increased, and a thin stripe which is easily perceived by human eyes in the column direction is avoided.

In some embodiments, for each of at least some of pairs of adjacent two pixel repetition unit rows in each subunit, a ratio ΔJ of a staggered vector by which a c-th sub-pixel in one pixel repetition unit row is staggered relative to the c-th sub-pixel in the other pixel repetition unit row in the row direction to the width of each sub-pixel in the row direction is not equal to

$$\pm C \frac{1}{M} or \pm C \frac{M - 1}{M} ,$$

where C is an integer greater than 0. As such, any adjacent two dark regions in each pair of adjacent two pixel repetition unit rows have at least one bright region therebetween, thereby avoiding continuous dark regions, effectively preventing human eye from perceiving a thin stripe extending in an inclined direction, and effectively solving the problem of microscopic Moire fringes.

In some embodiments, E is an integer greater than or equal to 1 and less than or equal to M−1. That is, a staggered vector between the sub-pixels does not exceed the width of one sub-pixel in the row direction X. As such, the distribution of dark regions corresponding to the subunits can be disturbed, while a staggered distance between the sub-pixels is prevented from being too large, thereby effectively utilizing a space of the display panel.

It should be noted that, in the case where M=5 and E is an integer greater than or equal to 1 and less than or equal to M−1, Jj may be one of the following: −4/5, −3/5, −2/5, −1/5, 1/5, 2/5, 3/5, and 4/5. In the case where Jj is −4/5, the dark region corresponding to the current row is staggered to the right by 4 bright regions relative to the dark region corresponding to the first row (i.e., the dark region corresponding to the current row is separated from the dark region corresponding to the first row by 3 bright regions). In a case where Jj is −3/5, the dark region corresponding to the current row is staggered to the right by 3 bright regions relative to the dark region corresponding to the first row (i.e., the dark region corresponding to the current row is separated from the dark region corresponding to the first row by 2 bright regions). In a case where Jj is −2/5, the dark region corresponding to the current row is staggered to the right by 2 bright regions relative to the dark region corresponding to the first row (i.e., the dark region corresponding to the current row is separated from the dark region corresponding to the first row by 1 bright region). In a case where Jj is −1/5, the dark region corresponding to the current row is staggered to the right by 1 bright region relative to the dark region corresponding to the first row (i.e., the dark region corresponding to the current row is separated from the dark region corresponding to the first row by 0 bright regions). In a case where Jj is 1/5, the dark region corresponding to the current row is staggered to the left by 1 bright region relative to the dark region corresponding to the first row (i.e., the dark region corresponding to the current row is separated from the dark region corresponding to the first row by 0 bright regions). In a case where Jj is 2/5, the dark region corresponding to the current row is staggered to the left by 2 bright regions relative to the dark region corresponding to the first row (i.e., the dark region corresponding to the current row is separated from the dark region corresponding to the first row by 1 bright region). In a case where Jj is 3/5, the dark region corresponding to the current row is staggered to the left by 3 bright regions relative to the dark region corresponding to the first row (i.e., the dark region corresponding to the current row is separated from the dark region corresponding to the first row by 2 bright regions). In a case where Jj is 4/5, the dark region corresponding to the current row is staggered to the left by 4 bright regions relative to the dark region corresponding to the first row (i.e., the dark region corresponding to the current row is separated from the dark region corresponding to the first row by 3 bright regions).

In some embodiments, in the case where M is 5, J2 is −2/5 or 3/5, J3 is ⅕ or −4/5, J4 is −1/5 or 4/5, and J5 is ⅖ or −3/5.

In a specific implementation, for example, J2 is −2/5, J3 is 1/5, J4 is −1/5, J5 is 2/5, and accordingly, as shown in FIG. 4, H2=(−2/5)h1, H3=(1/5)h1, H4=(−1/5)h1, and H5=(2/5)h1.

Alternatively, in a specific implementation, J2 may be 3/5, J3 may be −4/5, J4 may be 4/5, and J5 may be −3/5.

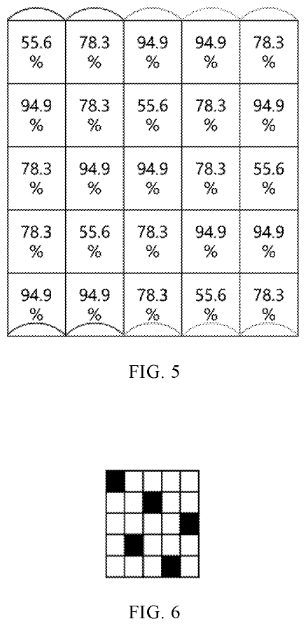

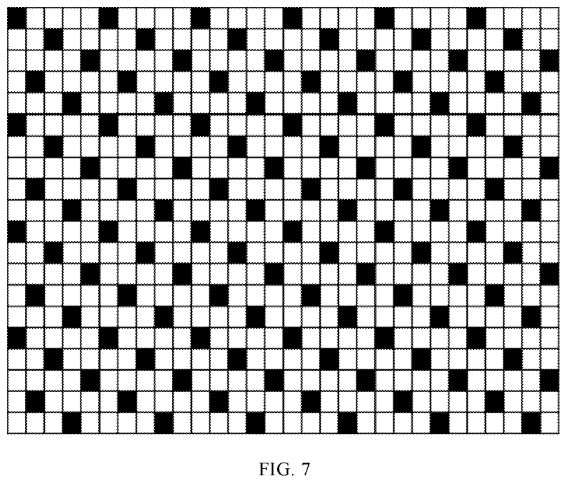

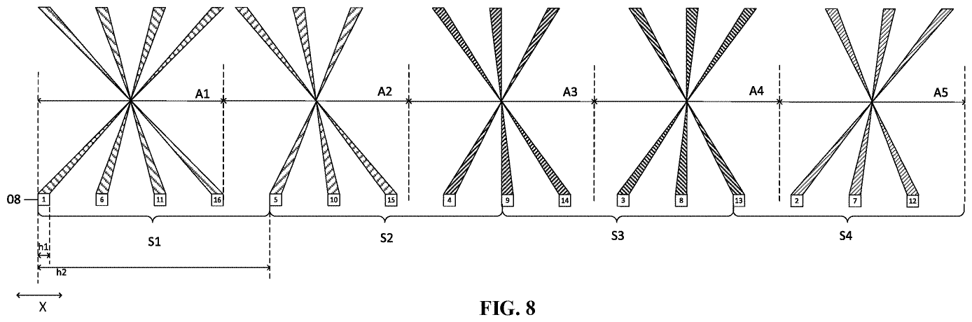

In a specific implementation, in the case where M=5, J2 is −2/5, J3 is 1/5, J4 is −1/5, and J5 is 2/5, the relative brightness distribution of the region of each subunit corresponding to 5 light splitting structures is as shown in FIG. 5, and may be divided into 5×5 bright regions, in which a region corresponding to the relative brightness of 55.6% is a dark region. The visual sensory effect of the region of each subunit shown in FIG. 5 is shown in FIG. 6, in which the dark regions of different rows are not in a same column, i.e. the dark regions of different rows are staggered relative to each other, and the visual sensory effect of the regions of a plurality of subunits is as shown in FIG. 7.

It should be noted that, although dark-region thin stripes are formed when dark regions are connected together as shown in FIG. 7, each of the dark-region thin stripes extends in a direction (hereinafter referred to as an inclined direction) having an angle greater than 0 with respect to each of the row direction and the column direction, and a distance between any two of the dark-region thin stripes extending in the inclined direction is 391.6 μm, which is much smaller than a distance (of 727.2 μm) between any two of the dark-region thin stripes extending in the column direction in the related art. For the distance of 391.6 microns, the dark-region thin stripes are not easy to be perceived at an observation distance of 300 mm, but in the normal case, the observation distance when a user uses the display device is usually 630 mm, at such an observation distance, the existence of the thin stripes extending in the inclined direction is not easy perceived by human eyes, thereby effectively solving the problem of microscopic Moire fringes.

In some embodiments, in a case where E is an integer greater than or equal to 1 and less than or equal to M−1, Jj for any two pixel repetition unit rows among the 2-nd to M-th pixel repetition unit rows in each subunit is not equal to each other, and in a case where one of Jj corresponding to two pixel repetition unit rows is positive (+) and the other is negative (−), a sum of the absolute values of the Jj corresponding to the two pixel repetition unit rows is not equal to 1. Thus, in each pixel repetition unit group, the dark regions are not positioned in a same column in the column direction, thereby increasing a distance between any two dark regions arranged in the column direction, and avoiding a thin stripe which is easily perceived by human eyes in the column direction.

In some embodiments, as shown in FIGS. 5 and 6, a line connecting centers of the dark regions in the bright region corresponding to each subunit is not on a same straight line. That is, in the bright region corresponding to each subunit, the dark regions are not sequentially arranged along a direction (which also referred to as the inclined direction) having an angle greater than 0 with respect to each of the row direction and the column direction, but are distributed on a plurality of straight lines extending along the inclined direction. Therefore, compared with the case where the line connecting the centers of the dark regions is on a same straight line, a distance between any two dark-region thin stripes in the whole display device as shown in FIG. 7 is small, such that the existence of the thin stripes extending in the inclined direction is not easy to be perceived by human eyes, and the problem of microscopic Moire fringes is effectively solved.

In some embodiments, in a case where E is an integer greater than or equal to 1 and less than or equal to M−1, for each of at least some of pairs of adjacent two pixel repetition unit rows in each subunit, a ratio ΔJ of a staggered vector by which a c-th sub-pixel in one pixel repetition unit row is staggered relative to the c-th sub-pixel in the other pixel repetition unit row in the row direction to the width of each sub-pixel in the row direction is not equal to ±1/M or ±(M−1)/M. As such, any adjacent two dark regions in each pair of adjacent two pixel repetition unit rows have at least one bright region therebetween, thereby avoiding continuous dark regions, effectively preventing human eyes from perceiving a thin stripe extending in the inclined direction, and effectively solving the problem of microscopic Moire fringes.

In some embodiments, each light splitting repetition unit corresponds to K columns of pixel islands in each pixel repetition unit row, where K is an integer greater than 1.

In the display device according to the present embodiment, each light splitting repetition unit corresponds to K columns of pixel islands in each pixel repetition unit row, i.e., M light splitting structures correspond to K columns of pixel islands in each pixel repetition unit row, where each of M and K is an integer greater than 1. That is, the light splitting structures are in many-to-many correspondence with pixel island columns. As such, it can be avoided that each light splitting structure has a too small size in the row direction, it can be avoided that the difficulty for manufacturing the light splitting assembly is increased, and it can be avoided that a divergence angle of light output from the sub-pixels being increased, the crosstalk between views being increased, and the display effect being affected, are caused by the diffraction of each light splitting structure with a too small size.

In some embodiments, N/K is an integer. That is, N columns of sub-pixels in each pixel repetition unit row and corresponding to the M light splitting structures can be equally divided into a plurality of columns of pixel islands.

In a specific implementation, as shown in FIG. 4, each pixel island S includes n sub-pixels 08 arranged to be spaced apart from each other in the row direction X, where n is an integer greater than 1; and each light splitting repetition unit corresponds to K columns of pixel islands in each pixel repetition unit row, where N=K×n, k is an integer greater than 1, and M is coprime with K.

Alternatively, in some embodiments, N is coprime with K. That is, the N columns of sub-pixels in each pixel repetition unit row and corresponding to the M light splitting structures cannot be equally divided into a plurality of columns of pixel islands.

In a specific implementation, even if N columns of sub-pixels in each pixel repetition unit row and corresponding to the M light splitting structures cannot be equally divided into a plurality of columns of pixel islands, the light splitting structures are still in many-to-many correspondence with the pixel islands, it can also be avoided that each light splitting structure has a too small size in the row direction, it can also be avoided that the difficulty for manufacturing the light splitting assembly is increased, and it can also be avoided that a divergence angle of light output from the sub-pixels being increased, crosstalk between views being increased, and the display effect being affected, are caused by the diffraction of each light splitting structure with a too small size.

In some embodiments, in a horizontal direction, a width of the M light splitting structures is equal to a width of the N columns of sub-pixels in each pixel repetition unit row.

In some embodiments, light emitting regions of the N columns of sub-pixels in each pixel repetition unit row are subjected to light splitting by the M light splitting structures, and then the emitted light forms continuous light emitting regions in the space.

In the display device according to the present embodiment, N columns of sub-pixels correspond to M light splitting structures, and light emitting regions of the sub-pixels in the N columns of sub-pixels are spatially staggered. Further, since each light splitting structure has a small size in the row direction, for N columns of sub-pixels corresponding to M light splitting structures, human eyes cannot distinguish which of light splitting structures light exits from, such that the human eyes can see that the light emitted from the N columns of sub-pixels and then being split by the M light splitting structures above the N columns of sub-pixels forms a continuous light emitting region in a space, and the human eyes cannot see a “black region” when moving in a visible space.

In some embodiments, each of the sub-pixels includes a sub-pixel opening (i.e., an opening of the sub-pixel), and in the row direction, a ratio of a total width of n sub-pixel openings to a width of each pixel island is greater than or equal to 0.9/M and less than or equal to 1. That is, an aperture ratio of the sub-pixels in each pixel island is greater than or equal to 0.9/M and less than or equal to 1.

In some embodiments, in the row direction, the light emitting regions of the N columns of sub-pixels in each pixel repetition unit row are spatially complementarily spliced together.

In some embodiments, a ratio of a width of each sub-pixel opening to the width of each pixel island in the row direction is 1/M. That is, an aperture ratio of each sub-pixel in each pixel island is 1/M. With such a configuration, the sub-pixels below each light splitting repetition unit are staggered and complementarily arranged relative to positions of the corresponding light splitting structures, such that the light emitting regions of N columns of sub-pixels are spatially complementarily spliced together, i.e., light paths of views (or viewpoints) are closely connected together, thereby mitigating the problem of macroscopic Moire fringes, and improving the display effect.

In some embodiments, in the row direction, the light emitting regions of the N columns of sub-pixels in each pixel repetition unit row spatially overlap with each other.

In some embodiments, in the row direction, the light emitting regions of the N columns of sub-pixels in each pixel repetition unit row overlap with each other uniformly in a space (i.e., overlap with each other uniformly and spatially).

In some embodiments, in the row direction, a ratio of the width of the sub-pixel opening to the width of each pixel island is i/M, where i is an integer greater than 1 and less than or equal to M−1.

It should be noted that, in the display device according to the present embodiment, M light splitting structures correspond to N columns of sub-pixels in each pixel repetition unit row, and correspond to K pixel islands in each pixel repetition unit row. That is, the sub-pixels are in many-to-many correspondence with the light splitting structures, and meanwhile, the pixel islands are in many-to-many correspondence with the light splitting structures. In the case where in the row direction, a width of M light splitting structures is equal to a width of N columns of sub-pixels in each pixel repetition unit row, even if the number of light splitting structures is increased, a size of each light splitting structure will not be too small in the row direction, and thus it is not difficult to manufacture the light splitting structures. Further, in the case where an aperture ratio of a sub-pixel is i/M, i being an integer greater than 1 and less than or equal to M−1, the aperture ratio of the sub-pixel can be increased when the number of light splitting structures is constant as compared to the case where a pixel island is in one-to-many correspondence with light splitting structures.

In a specific implementation, in a case where each light splitting repetition unit corresponds to K columns of pixel islands and N=K×n, the width of N columns of sub-pixels is the width of the K columns of pixel islands, and in the horizontal direction, the width of M light splitting structures is equal to the width of the K columns of pixel islands.

In a specific implementation, in the case where each light splitting repetition unit corresponds to K columns of pixel islands and N=K×n, the light emitting regions of the sub-pixels in the K pixel islands are staggered in a space (or spatially), such that the outgoing light emitted from the sub-pixels in the K pixel islands and having being split by the M light splitting structures forms a continuous light emitting region in a space.

It should be noted that, the space in the expression “the light emitting regions of the sub-pixels in the K pixel islands are staggered in a space” refers to a visible space of the display device.

In the display device according to the present embodiment, K pixel islands correspond to M light splitting structures, and the light emitting regions of the sub-pixels in the K pixel islands are staggered in the space. Since each light splitting structure has a small size in the row direction, for the K pixel islands covered by the M light splitting structures, human eyes cannot recognize which of the light splitting structures light emits from, such that the outgoing light emitted from the K pixel islands and then being split by the M light splitting structures located above the K pixel islands forms a continuous light emitting region in the space, and the human eyes cannot see a “black region” when moving in a visible space.

It should be noted that, a viewing angle includes a main lobe viewing angle and a side lobe viewing angle. The main lobe viewing angle refers to a viewing angle formed in a space after light emitted from the sub-pixels is split by the light splitting structure right above the sub-pixels. The side lobe viewing angle refers to a viewing angle formed in a space after light emitted from the sub-pixels is split by a light splitting structure beside the light splitting structure right above the sub-pixels, for example, a first-level side lobe viewing angle formed in a space after light emitted from the sub-pixels is split by a first light splitting structure adjacent to the light splitting structure right above the sub-pixels, a second-level side lobe viewing angle formed in a space after light emitted from the sub-pixels is split by a second light splitting structure adjacent to the light splitting structure right above the sub-pixels, and so on.

For better understanding of the present technical solution, a case where the main lobe viewing angle is adopted, and where each light splitting repetition unit corresponds to K columns of pixel islands and N=K×n is taken as an example, to exemplarily describe an example that the light emitting regions of the sub-pixels in the K pixel islands are staggered in a space, and that the outgoing light from the light emitting regions of the sub-pixels in the K pixel islands and then being split by the M light splitting structures forms a continuous light emitting region in the space.

In a specific implementation, in the M light splitting structures arranged in the row direction, a difference between the views (or viewpoints) of any adjacent two of the sub-pixels corresponding to each light splitting structure is M.

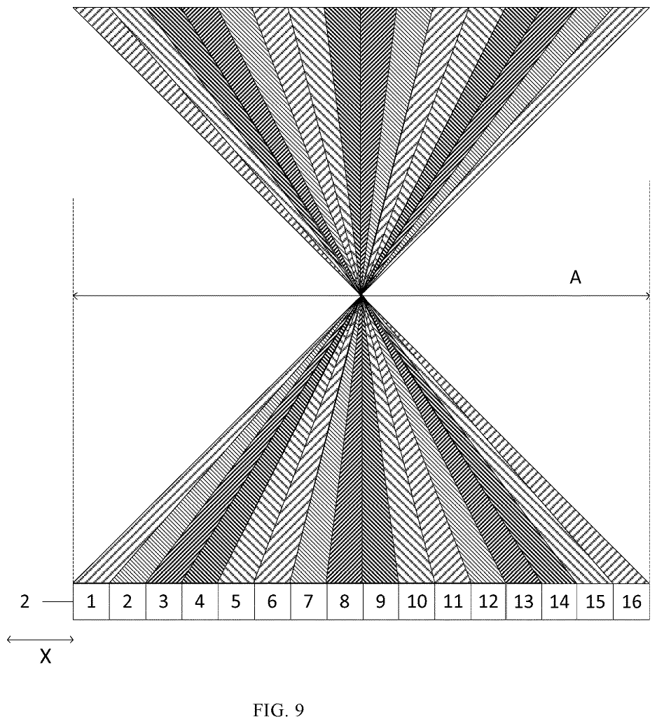

In some embodiments, K is 4, M is 5, n is 4, the aperture ratio of a sub-pixel is 1/5, and the light paths of the K columns of pixel islands are shown in FIGS. 8 and 9. Each row of 4 columns of pixel islands in each pixel repetition unit row corresponding to the 5 light splitting structures includes 16 sub-pixels which are respectively marked as a first sub-pixel 1 to a sixteenth sub-pixel 16, and the serial numbers of the sub-pixels represent the respective views (or viewpoints). The 4 pixel islands are a first pixel island S1, a second pixel island S2, a third pixel island S3 and a fourth pixel island S4. The first pixel island S1 includes the first sub-pixel 1, the sixth sub-pixel 6, the eleventh sub-pixel 11, and the sixteenth sub-pixel 16. The second pixel island S2 includes the fifth sub-pixel 5, the tenth sub-pixel 10, the fifteenth sub-pixel 15, and the fourth sub-pixel 4. The third pixel island S3 includes the ninth sub-pixel 9, the fourteenth sub-pixel 14, the third sub-pixel 3, and the eighth sub-pixel 8. The fourth pixel island S4 includes the thirteenth sub-pixel 13, the second sub-pixel 2, the seventh sub-pixel 7, and the twelfth sub-pixel 12. The light splitting structures corresponding to the 16 sub-pixels are marked as a first light splitting structure A1 to a fifth light splitting structure A5. As shown in FIG. 8, the first light splitting structure A1 covers the first sub-pixel 1, the sixth sub-pixel 6, the eleventh sub-pixel 11, and the sixteenth sub-pixel 16; the second light splitting structure A2 covers the fifth sub-pixel 5, the tenth sub-pixel 10, and the fifteenth sub-pixel 15; the third light splitting structure A3 covers the fourth sub-pixel 4, the ninth sub-pixel 9; and the fourteenth sub-pixel 14; the fourth light splitting structure A4 covers the third sub-pixel 3, the eighth sub-pixel 8, and the thirteenth sub-pixel 13; and the fifth light splitting structure A5 covers the second sub-pixel 2, the seventh sub-pixel 7, and the twelfth sub-pixel 12. As shown in FIG. 8, the relative positional relationship between each sub-pixel in the 4 pixel islands and the light splitting structures does not form a repetition unit. If the sub-pixels are sequentially spliced together according to a sequence of the views (or viewpoints), and the relative positions between the sub-pixels and the light splitting structures are kept unchanged, as shown in FIG. 9, after the sub-pixels corresponding to the light splitting structures are spliced together, the positions of the sub-pixels are complementary, i.e., a distance between any adjacent two of the sub-pixels is 0, the relative positional relationship between the sub-pixels and the light splitting structures forms a staggered and complementary arrangement. Accordingly, the light emitting regions of the sub-pixels in the 4 pixel islands are spatially staggered, and form a staggered and complementary arrangement. As shown in FIG. 8, since a gap exists between the first sub-pixel 1 and the fifth sub-pixel 5, light outgoing angles of light rays emitted from the adjacent sub-pixels corresponding to a same light splitting structure in the space after passing through the same light splitting structure A are discontinuous, but because the relative positions of the sub-pixels in the 4 pixel islands and the 5 light splitting structures A are in a staggered arrangement relationship, the light emitting regions of the sub-pixels in the 4 pixel islands are in a staggered arrangement in the space, and the light outgoing angles of the light splitting structures A are also staggered and complementary. Since the size of each light splitting structure A is very small, it cannot be distinguished for human eyes which of the light splitting structures A light emits from. As such, as shown in FIG. 9, the human eyes perceive that the outgoing light emitted from 16 sub-pixels in 4 pixel islands and then being split by 5 light splitting structures forms a continuous light emitting region in the space, and the human eyes cannot see a “black region” when moving in the space.

The continuity of the side lobe viewing angle is the same as the continuity of the main lobe viewing angle as described above, and two discontinuous first-level side lobe viewing angles of the K pixel islands through adjacent light splitting structures can complement each other to form a continuous first-level side lobe viewing angle. Further, in the horizontal direction, the width of the M light splitting structures is equal to the width of K columns of pixel islands in each pixel repetition unit row, such that a main lobe viewing angle boundary is parallel to a side lobe viewing angle boundary. Since human eyes cannot recognize a distance between the main lobe viewing angle boundary and the side lobe viewing angle boundary, the main lobe viewing angle and the side lobe viewing angle perceived by the human eyes are also continuous. Similarly, the first-level side lobe viewing angle and the second-level side lobe viewing angle are also continuous, the second-level side lobe viewing angle and a third-level side lobe viewing angle are also continuous, and so on. As such, a continuous viewing angle is obtained.

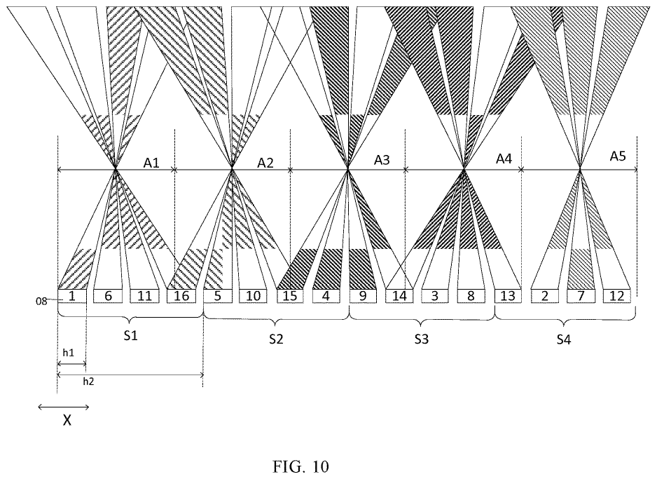

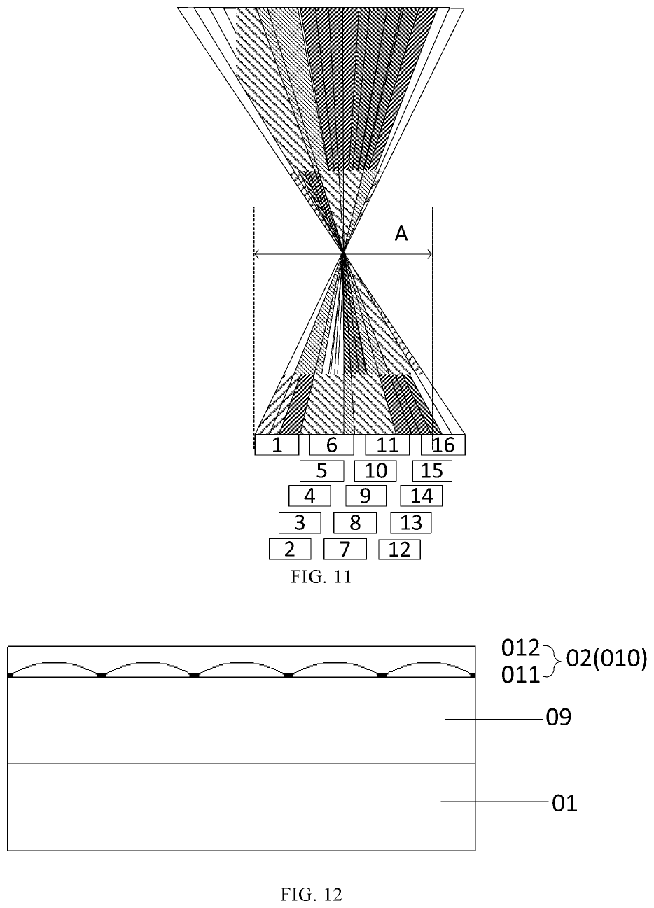

In some embodiments, K is 4, M is 5, n is 4, the aperture ratio of a sub-pixel is 4/5, and the light paths of K pixel islands in each pixel repetition unit row are shown in FIGS. 10 and 11. The 4 pixel islands corresponding to the 5 light splitting structures include 16 sub-pixels which are marked as a first sub-pixel 1 to a sixteenth sub-pixel 16, and the serial numbers of the sub-pixels represent the respective views (or viewpoints). The 4 pixel islands are a first pixel island S1, a second pixel island S2, a third pixel island S3, and a fourth pixel island S4. The first pixel island S1 includes a first sub-pixel 1, a sixth sub-pixel 6, an eleventh sub-pixel 11, and a sixteenth sub-pixel 16. The second pixel island S2 includes a fifth sub-pixel 5, a tenth sub-pixel 10, a fifteenth sub-pixel 15, and a fourth sub-pixel 4. The third pixel island S3 includes a ninth sub-pixel 9, a fourteenth sub-pixel 14, a third sub-pixel 3, and an eighth sub-pixel 8. The fourth pixel island S4 includes a thirteenth sub-pixel 13, a second sub-pixel 2, a seventh sub-pixel 7, and a twelfth sub-pixel 12. The light splitting structures corresponding to the 16 sub-pixels are marked as a first light splitting structure A1 to a fifth light splitting structure A5. As shown in FIG. 10, the first light splitting structure A1 covers the first sub-pixel 1, the sixth sub-pixel 6, the eleventh sub-pixel 11, and a part of the sixteenth sub-pixel 16; the second light splitting structure A2 covers the remaining part of the sixteenth sub-pixel 16, the fifth sub-pixel 5, the tenth sub-pixel 10, and a part of the fifteenth sub-pixel 15; the third light splitting structure A3 covers the remaining part of the fifteenth sub-pixel 15, the fourth sub-pixel 4, the ninth sub-pixel 9, and a part of the fourteenth sub-pixel 14; the fourth light splitting structure A4 covers the remaining part of the fourteenth sub-pixel 14, the third sub-pixel 3, the eighth sub-pixel 8, and the thirteenth sub-pixel 13; and the fifth light splitting structure A5 covers the second sub-pixel 2, the seventh sub-pixel 7, and the twelfth sub-pixel 12. As shown in FIG. 10, the relative positional relationship between the sub-pixels in the 4 pixel islands and the light splitting structures does not form a repetition unit, if the sub-pixels are sequentially spliced together according to a sequence of the views (or viewpoints) and the relative positions between the sub-pixels and the light splitting structures are kept unchanged, as shown in FIG. 11, after the sub-pixels corresponding to the light splitting structures are spliced together, the positions of the sub-pixels overlap each other, and the relative positional relationship between the sub-pixels and the light splitting structures forms a staggered and overlapped arrangement. Accordingly, the light emitting regions of the sub-pixels in the 4 pixel islands are spatially staggered, and also form a staggered and complementary arrangement in a space. As shown in FIG. 10, since a gap exists between any adjacent two of the first sub-pixel 1 and the fifth sub-pixel 5, light outgoing angles of light rays emitted from adjacent sub-pixels corresponding to a same light splitting structure in a space after passing through the same light splitting structure A are discontinuous, but since the relative positions of the sub-pixels in the 4 pixel islands and the 5 light splitting structures A are in a staggered and uniformly overlapped arrangement relationship, the light emitting regions of the sub-pixels in the 4 pixel islands are arranged uniformly and overlap with each other in the space, and thus the light outgoing angles of the light splitting structures A are also staggered and uniformly overlap each other. Since the size of each light splitting structure A is very small, human eyes cannot recognize which of the light splitting structures A light emits from. As such, as shown in FIG. 11, the human eyes perceive that the outgoing light emitted from 16 sub-pixels in 4 pixel islands and then being split by the 5 light splitting structures forms a continuous light emitting region in the space, and cannot see a “black region” when moving in the space.

In some embodiments, as shown in FIG. 10, in the row direction, a ratio of the total width n×h1 of the n sub-pixel openings to a width h2 of each pixel island is i/M, where i is an integer greater than 1 and less than or equal to M−1. That is, an aperture ratio of the sub-pixels in each pixel island is i/M. With such a configuration, the sub-pixels below each light splitting repetition unit are staggered and uniformly overlap with each other relative to the positions of the corresponding light splitting structures, such that the light emitting regions of the sub-pixels in the K pixel islands uniformly overlap with each other in a space, i.e., light paths of views (or viewpoints) uniformly overlap with each other, thereby eliminating macroscopic Moire fringes, and improving the display effect.

In a specific implementation, in the case where the light emitting regions of the sub-pixels in the K pixel islands uniformly overlap with each other in the space, a ratio of an area of the overlapping region of the light emitting regions of two sub-pixels with adjacent serial numbers to an area of the light emitting region of one of the two sub-pixels is (i−1)/i. The ratio of the area of the overlapping region of the light emitting regions of the two sub-pixels with adjacent serial numbers to an area of one of the two sub-pixels is (i−1)/M.

It should be noted that, in a case where in the row direction, the ratio of the total width n×h1 of the n sub-pixel openings to the width h2 of each pixel island is 1/M, i.e., when i=1, the light emitting regions of the sub-pixels do not overlap each other in the space. When i=2, the ratio of the area of the overlapping region of the light emitting regions of two sub-pixels with adjacent serial numbers to the area of the light emitting region of one of the two sub-pixels is 1/2, and the ratio of the area of the overlapping region of the light emitting regions of the two sub-pixels with adjacent serial numbers to an area of one of the two sub-pixels is 1/M. When i=3, the ratio of the area of the overlapping region of the light emitting regions of two sub-pixels with adjacent serial numbers to an area of the light emitting region of one of the two sub-pixels is 2/3, and the ratio of the area of the overlapping region of the light emitting regions of the two sub-pixels with adjacent serial numbers to an area of one of the two sub-pixels is 2/M. When i=4, the ratio of the area of the overlapping region of the light emitting regions of two sub-pixels with adjacent serial numbers to an area of the light emitting region of one of the two sub-pixels is 3/4, and the ratio of the area of the overlapping region of the light emitting regions of the two sub-pixels with adjacent serial numbers to an area of one of the two sub-pixels is 3/M. When i=M−1, the ratio of the area of the overlapping region of the light emitting regions of two sub-pixels with adjacent serial numbers to an area of the light emitting region of one of the two sub-pixels is (M−2)/(M−1), and the ratio of the area of the overlapping region of the light emitting regions of the two sub-pixels with adjacent serial numbers to an area of one of the two sub-pixels is (M−2)/M; and so on, detailed description thereof being omitted herein.

It should be noted that FIG. 10 exemplifies that the ratio of the total width of the n sub-pixel openings to the width of each pixel island in the row direction is (M−1)/M (i.e., 4/5), i.e., the aperture ratio of the sub-pixels in each pixel island in FIG. 4 is 4/5. In the case where the aperture ratio of the sub-pixels in each pixel island is (M−1)/M, the aperture ratio of the sub-pixels can be increased to the maximum extent while satisfying the requirement that the light emitting regions of the sub-pixels in the K pixel islands in the row direction uniformly overlap with each other in a space. Alternatively, in a specific implementation, the aperture ratio of the sub-pixels in each pixel island may be 2/M, 3/M, or the like.

In some embodiments, as shown in FIG. 12, the display device further includes:
a spacer dielectric layer 09 positioned between the light splitting assembly 02 and the display panel 01.

In some embodiments, each of the light splitting structures is a cylindrical lens.

In some embodiments, as shown in FIG. 12, the cylindrical lens 010 includes a first resin layer 011 having protrusions, and a planarization resin layer 012 on a side of the first resin layer 011 distal to the display panel 01. The planarization resin layer 012 has a refractive index smaller than a refractive index of the first resin layer 011.

Optionally, in some embodiments, the cylindrical lens is a liquid crystal lens.

Alternatively, in a specific implementation, each of the light splitting structures may be a geometric lens, a diffractive lens, a liquid lens, or the like, which is a structural device capable of controlling a light emitting direction of the sub-pixels.

In some embodiments, the display device further includes:
an eye tracking system for determining a position of an eye of a user in real time.

The display device according to an embodiment of the present disclosure may be a product or component with a display function, such as a mobile phone, a tablet computer, a television, a display, a notebook computer, a digital photo frame, a navigator, a smart watch, a fitness bracelet, a personal digital assistant, or the like. Other essential components of the display device should be understood by one of ordinary skill in the art, and are not described herein nor should they be construed as limiting the present disclosure.

To sum up, in the display device according to any one of the foregoing embodiments of the present disclosure, the M light splitting structures correspond to N columns of sub-pixels in each of the pixel repetition unit rows, where each of M and N is an integer greater than 1, i.e., the light splitting structures are in many-to-many correspondence with the sub-pixels. As such, each of the light splitting structures is prevented from having a too small size in the row direction, the difficulty of manufacturing the light splitting assembly is prevented from being increased, and the increase of a divergence angle of light emitted from the sub-pixels, the increase of crosstalk between views (or viewpoints), and the influence on the display effect, caused by the diffraction of each light splitting structure with a too small size can also be avoided. Further, the sub-pixels in at least some adjacent two pixel repetition unit rows are arranged in a staggered manner in the row direction, such that the distribution of the dark regions corresponding to the light splitting repetition units can be disturbed. As a result, the dark regions are arranged in a staggered manner, and the dark regions are prevented from consecutively forming a thin stripe in the column direction, thereby effectively mitigating the problem of microscopic Moire fringes.

An embodiment of the present disclosure provides another display device, as shown in FIGS. 12 to 17, the display device including the following:
the display panel 01; the display panel 01 includes a display region AA and a peripheral region NA surrounding the display region AA; the display panel 01 further includes: a plurality of pixel bars 2 extending in a first direction a1 and arranged in a second direction a2, and a plurality of light shielding portions 3; the first direction a1 intersects with the second direction a2, and each pixel bar 2 includes a plurality of sub-pixels 201 arranged along the first direction a1 (e.g., each sub-pixel 201 may be the same as each sub-pixel 08); an orthogonal projection of the plurality of light shielding portions 3 on the display panel 01 includes in the display region AA: a plurality of opening regions 9 arranged in an array and light shielding regions 8 each at least located between the opening regions 9; the plurality of light shielding portions 3 include: a plurality of first light shielding portions 301 extending in the first direction a1, and a plurality of second light shielding portions 302 extending in a direction intersecting with the first direction a1; orthogonal projections of at least some of the first light shielding portions 301 on the display panel 01 respectively overlap with orthogonal projections of regions between pixel bars 2 adjacent to the at least some of the first light shielding portions 301 on the display panel 01, and orthogonal projections of at least some of the second light shielding portions 302 on the display panel 01 respectively overlap with orthogonal projections of the pixel bars 2 on the display panel 01; and
the light splitting assembly 02 positioned on the display side of the display panel 01; the light splitting assembly 02 includes a plurality of light splitting structures 401 (e.g., each light splitting structure 401 may be the same as each light splitting structure A) extending along a third direction a3 and arranged along a fourth direction a4; the third direction a3 intersects with the fourth direction a4; an included angle θ1 between the third direction a3 and a direction of a normal line 6 of the first direction a1 is greater than or equal to 0° and less than or equal to 90°.

In the display device according to the present embodiment, the orthogonal projections of the at least some of the first light shielding portions on the display panel respectively overlap with the orthogonal projections of the regions between the pixel bars adjacent to the at least some of the first light shielding portions on the display panel, so that the regions between the pixel bars adjacent to the at least some of the first light shielding portions can be shielded by the at least some of the first light shielding portions, thereby avoiding the crosstalk between the pixel bars of different colors. The orthogonal projections of the at least some of the second light shielding portions on the display panel respectively overlap with the orthogonal projections of the pixel bars on the display panel, so that a periodic arrangement of the sub-pixels in the pixel bars can be disturbed, thereby mitigating the Moire fringes.

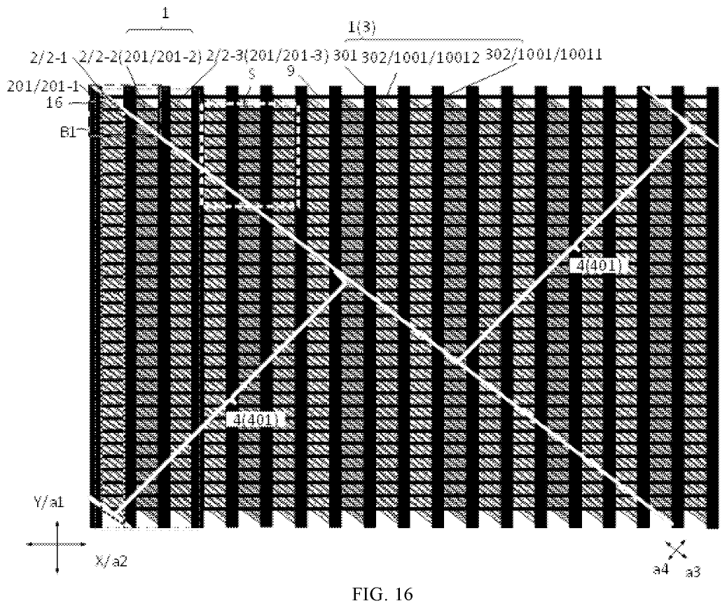

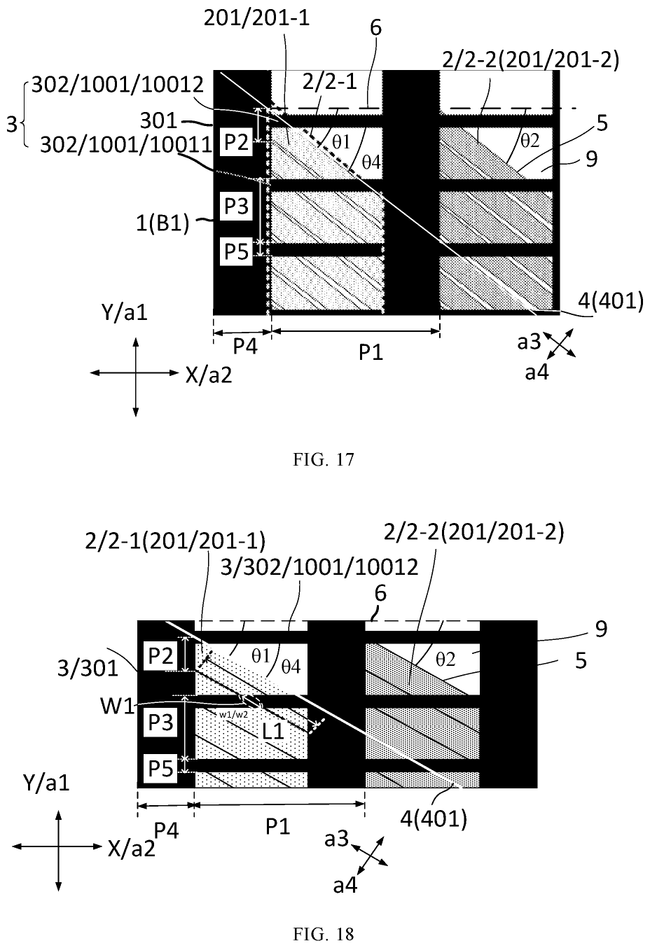

In some embodiments, as shown in FIGS. 16 to 17, the total number of the opening regions 9 included in the plurality of light shielding portions 3 is less than the total number of the sub-pixels 201 included in all the pixel bars 2.

In the display device according to the present embodiment, since the number of the plurality of opening regions is less than the number of the sub-pixels in the plurality of pixel bars, i.e., the number of the second light shielding portions is less than the number of the sub-pixels included in each of the pixel bars, the Moire fringes can be mitigated, and meanwhile, the light shielding portions can be prevented from being excessive to affect an aperture ratio.

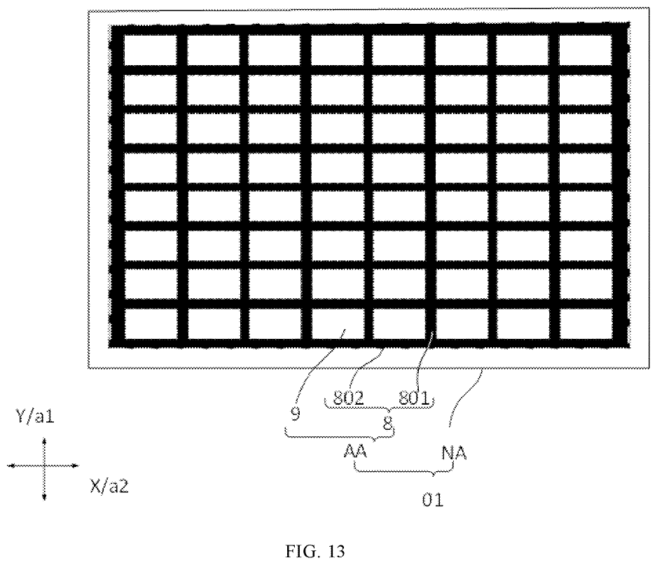

It should be noted that FIG. 17 is an enlarged schematic diagram illustrating a region B1 in FIG. 16. FIG. 13 and FIGS. 15 to 17 illustrate an example in which the first direction a1 is perpendicular to the second direction a2, and the direction of the normal line 6 of the first direction a1 is the second direction a2.

It should be noted that an included angle present in an embodiment of the present disclosure is defined as the mathematical included angle, i.e., a smaller angle at which two straight lines intersect with each other.

It should be noted that a pattern of orthogonal projections of the second light shielding portions on the display panel and orthogonal projections of the first light shielding portions on the display panel divides the display region into the plurality of opening regions arranged in an array and the light shielding regions.

In some embodiments, as shown in FIG. 13, a region between each opening region 9 at an edge of the display region AA and the peripheral region NA is also one of the light shielding regions 8. The light shielding regions 8 are divided into a plurality of first light shielding regions 801 and a plurality of second light shielding regions 802. The first light shielding regions 801 each extend in the first direction a1, and the second light shielding regions 802 each extend in a direction intersecting with the first direction a1. The light shielding region 8 between any adjacent two of the opening regions 9 in the first direction a1 is one of the second light shielding regions 802, and the light shielding region 8 between any adjacent two of the opening regions 9 in the second direction a2 is one of the first light shielding regions 801. The first light shielding regions 801 correspond to regions of the orthogonal projections of respective first light shielding portions 301 on the display panel 01, and the second light shielding regions 802 correspond to regions of the orthogonal projections of respective second light shielding portions 302 on the display panel 01.

In some embodiments, the display panel further includes a plurality of signal lines and binding pins electrically connected to the plurality of signal lines.

As shown in FIG. 15, an orthogonal projection of a portion, which is located in the display region (not shown), of each signal line 10 on the display panel 01 falls within a respective light shielding region 8.

In the display device according to the present embodiment, the number of the opening regions is less than the number of the sub-pixels, and at least in one direction, the number of the opening regions corresponding to a respective pixel bar is less than the number of the sub-pixels included in the respective pixel bar. Since the signal lines are located in respective light shielding regions, and at least in one direction, the number of signal lines corresponding to a respective pixel bar is less than the number of sub-pixels included in the respective pixel bar, thereby reducing the number of signal lines. Since the signal lines are usually electrically connected to the binding pins, the number of the binding pins can be reduced accordingly. As a result, cost can be saved, and wiring difficulty can be simplified.

In some embodiments, the display device further includes driver chips bound with the binding pins. In a practical implementation, the display panel may be bound to one or more driver chips. In a case where the display panel needs to be bound with a plurality of driver chips, the number of the driver chips can be reduced when the number of the binding pins is reduced, thereby saving the cost thereof.

In some embodiments, as shown in FIG. 16, the plurality of pixel bars 2 include a plurality of pixel bars 2 emit light of different colors, and are divided into a plurality of repetition units 16. Each repetition unit 16 includes a plurality of pixel bars 2 emit light of different colors. Each repetition unit 16 includes a plurality of pixel islands S. Each pixel island S includes a plurality of sub-pixels 201 in the first direction a1.

It should be noted that the display device according to an embodiment of the present disclosure may be applied to three-dimensional (3D) display, and may also implement switching between the 3D display and two-dimensional (2D) display. Each pixel island may be used as a pixel of the 2D display. Since each pixel island includes a plurality of sub-pixels arranged in an array, a resolution in a 3D display mode may be kept to be the same as a resolution in a 2D display mode, which, when being combined with an eye-tracking system, can realize multi-view display with a large viewing angle, and can realize 3D display with a higher pixel density (ppi) that has a larger information amount and a lower color crosstalk between adjacent views.

In some embodiments, when a display mode of the display device is the 3D display mode, the light emitted from the sub-pixels of the pixel bars through the light splitting assembly is continuous light.

Specifically, since the light splitting structures each have a small size in a direction in which the light splitting structures are arranged, human eyes cannot distinguish which light splitting structure the light is emitted from, and the light emitted from the sub-pixels of the pixel bars through the light splitting assembly is continuous light, so that the human eyes cannot see a “black region” when the human eyes move in a visible space, thereby eliminating the Moire fringes and improving the display effect.

In some embodiments, the display panel includes PX1 repetition units, each repetition unit includes PX2 pixel islands, each pixel bar includes PX2×PX3 sub-pixels; the resolution of the 3D display is PX1× PX2× PX3, and the resolution of the 2D display is PX1×PX2.

In some embodiments, as shown in FIG. 16, the plurality of pixel bars 2 include a plurality of first pixel bars 2-1, a plurality of second pixel bars 2-2, and a plurality of third pixel bars 2-3. The plurality of pixel bars 2 are periodically arranged by taking one of the first pixel bars 2-1, one of the second pixel bars 2-2 and one of the third pixel bars 2-3 as one of the repetition units 16.

Each first pixel bar 2-1 includes a plurality of first sub-pixels 201-1, each second pixel bar 2-2 includes a plurality of second sub-pixels 201-2, and each third pixel bar 2-3 includes a plurality of third sub-pixels 201-3.

For example, each first sub-pixel is a red sub-pixel, each second sub-pixel is a green sub-pixel, and each third sub-pixel is a blue sub-pixel.

In a specific implementation, the light splitting assembly is a one-dimensional light control device, and each light splitting structure has one-dimensional direction light control capability to control a light emitting angle of the sub-pixels to emit light directionally. Specifically, each light splitting structure does not control light in the third direction, and has light control capability in the fourth direction.

In some embodiments, the light splitting assembly includes one of a cylindrical lens array (i.e., an array of cylindrical lenses), a liquid crystal cylindrical lens array (i.e., an array of liquid crystal cylindrical lenses), a parallax barrier, or a liquid crystal dynamic parallax barrier.

In some embodiments, in a case where the light splitting assembly includes the cylindrical lens array as shown in FIG. 12, each light splitting structure 401 is a cylindrical lens 010. As shown in FIG. 12, the light splitting assembly 02 includes a first resin layer 011 having protrusions, and a planarization resin layer 012 on a side of the first resin layer 011 distal to the display panel 01. The planarization resin layer 012 has a refractive index less than a refractive index of the first resin layer 011.

In some embodiments, in a case where the light splitting assembly includes the liquid crystal cylindrical lens array, specifically, the light splitting assembly is a liquid crystal cell which is driven to form the liquid crystal cylindrical lens array, and each light splitting structure is a resultant liquid crystal cylindrical lens.

In some embodiments, as shown in FIG. 12, the display device further includes a spacer dielectric layer 13; and
the spacer dielectric layer 13 is positioned between the light splitting assembly 02 and the display panel 01.

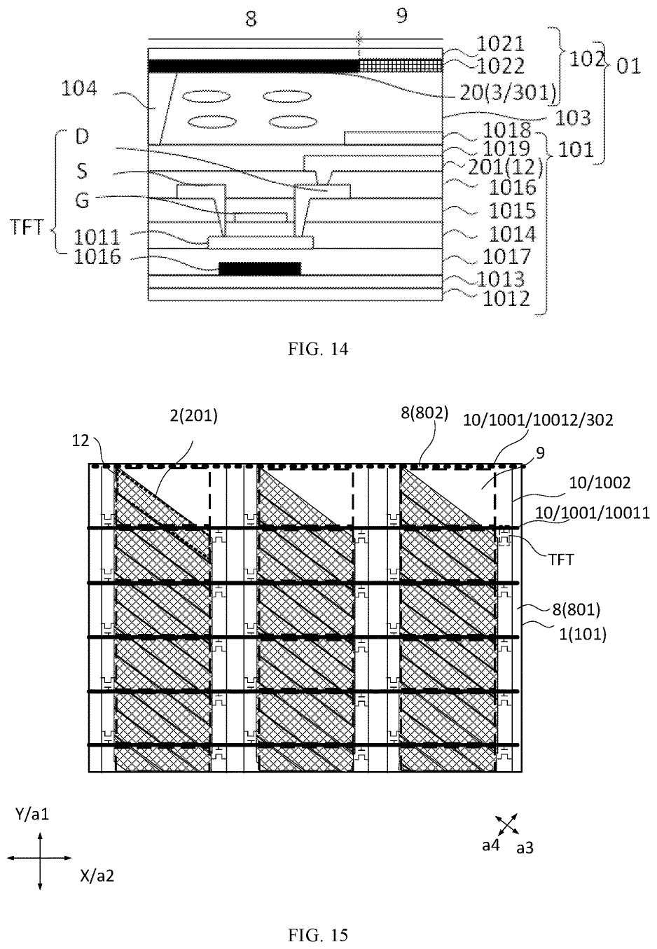

In some embodiments, as shown in FIG. 14, the display panel 01 is a liquid crystal display panel. The display panel 01, i.e., the liquid crystal display panel, includes an array substrate 101, an opposite substrate 102, and a first liquid crystal layer 103.

The array substrate 101 includes the plurality of pixel bars 2 and a plurality of signal lines 10, as shown in FIG. 15.

The opposite substrate 102 is disposed opposite to the array substrate 101, and includes a light shielding layer 20 which includes the first light shielding portion 301.

The first liquid crystal layer 103 is located between the array substrate 101 and the opposite substrate 102.

In some embodiments, the opposite substrate is located on a side of the array substrate proximal to the light splitting assembly.

In some embodiments, as shown in FIG. 14, each sub-pixel 201 includes a pixel electrode 12.

In some embodiments, as shown in FIG. 14, the array substrate 101 further includes: a first base substrate 1012, and a thin film transistor TFT located between the first base substrate 1012 and the pixel electrode 12. The thin film transistor TFT includes an active layer 1011, a gate electrode G, a source electrode S, and a drain electrode D. The pixel electrode 12 is electrically connected to the drain electrode D of the thin film transistor TFT, and the thin film transistor TFT and the pixel electrode 12 are located on a side of the first base substrate 1012 proximal to the first liquid crystal layer 103.

The opposite substrate 102 further includes a second base substrate 1021 and a plurality of color resists 1022. The first light shielding portions 301 and the color resists 1022 are located on a side of the second base substrate 1021 proximal to the first liquid crystal layer 103. At least a portion of an orthogonal projection of each color resist 1022 on the display panel is located in a respective opening region 9, and each color resist 1022 includes at least a portion located in a layer where the first light shielding portions 301 are located.

In some embodiments, one pixel bar corresponds to one color resist. The plurality of color resists include first color resists respectively corresponding to the first sub-pixels, second color resists respectively corresponding to the second sub-pixels, and third color resists respectively corresponding to the third sub-pixels.

It should be noted that in the related art, an opening region of a light shielding layer is generally a region of a sub-pixel, i.e., an opening region of a sub-pixel. In the display device according to an embodiment of the present disclosure, the number of the sub-pixels is less than the number of the opening regions of the light shielding layer, and the regions of the sub-pixels are no longer identical to the opening regions of the light shielding layer; the region of each sub-pixel corresponds to the region of a respective pixel electrode, i.e., is a region where a signal of the pixel electrode included in the sub-pixel drives liquid crystal molecules in the liquid crystal layer to rotate.

In some embodiments, as shown in FIG. 14, the array substrate 101 further includes: a first buffer layer 1013 located between the first base substrate 1012 and the active layer 1011, a gate insulating layer 1014 located between the gate electrode G and the active layer 1011, an interlayer insulating layer 1015 located between the gate electrode G and both the source electrode S and the drain electrode D, and a first insulating layer 1016 located between the pixel electrode 12 and the drain electrode D. It should be noted that FIG. 14 illustrates an example in which the thin film transistor TFT has a top gate structure, i.e., the gate electrode is located on a side of the active layer 1011 distal to the first base substrate 1012.

Alternatively, in a specific implementation, the thin film transistor may have a bottom gate structure, i.e., the active layer is located on a side of the gate electrode distal to the first base substrate.

In some embodiments, as shown in FIG. 14, the array substrate 101 further includes: a light shielding pattern 1016, and a second buffer layer 1017 located between the light shielding pattern 1016 and the active layer 1011.

Specifically, an orthogonal projection of the light shielding pattern on the first base substrate covers an orthogonal projection of a channel region of a respective thin film transistor on the first base substrate.

In some embodiments, the array substrate 101 may further include a common electrode 1018, and FIG. 14 illustrates an example in which the common electrode 1018 is located on a side of the pixel electrode 12 distal to the first base substrate 1012. The array substrate 101 further includes a second insulating layer 1019 located between the common electrode 1018 and the pixel electrode 12.

Alternatively, in a specific implementation, the common electrode may be located between the pixel electrode and the drain electrode.

In a specific implementation, thin film transistors, pixel electrodes, and the sub-pixels may be in one-to-one correspondence with each other. That is, each sub-pixel corresponds to a group of a thin film transistor and a pixel electrode which are electrically connected to each other, so that display information of each sub-pixel can be independently controlled.

In some embodiments, as shown in FIG. 15, the plurality of signal lines 10 includes: a plurality of first signal lines 1001 and a plurality of second signal lines 1002. At least some of the first signal lines 1001 and at least some of the second signal lines 1002 are electrically connected to the plurality of pixel bars 2, and the plurality of first signal lines 1001 and the plurality of second signal lines 1002 are arranged to intersect with each other.

In some embodiments, the first signal lines and the second signal lines extend to the peripheral region.

In some embodiments, as shown in FIG. 15, the plurality of first signal lines 1001 extend in the horizontal direction X, and the plurality of second signal lines 1002 extend in the vertical direction Y. The horizontal direction X is perpendicular to the vertical direction Y, and the first direction a1 is the horizontal direction X or the vertical direction Y.

It should be noted that the horizontal direction X and the vertical direction Y of the display device are respectively a preset fixed horizontal direction and a preset fixed vertical direction from the external appearance of the display device. The horizontal direction X and the vertical direction Y do not represent an actual horizontal direction and an actual vertical direction relative to human eyes when a user watches the display device, and do not change with operations such as rotation of the display device. The horizontal direction X and the vertical direction Y of the display device may be set according to the use, the shape, and the like of the display device. For example, in a case where the display panel or the display device is a rectangle or a rounded rectangle, and the rectangle or the rounded rectangle has a pair of long sides and a pair of short sides, a direction parallel to the long sides may be the horizontal direction and a direction parallel to the short sides may be the vertical direction, or the direction parallel to the long sides may be the vertical direction and the direction parallel to the short sides may be the horizontal direction. For example, for the display device such as a mobile phone, the direction parallel to the short sides may be set as the horizontal direction, and for the display device such as a tablet computer, the direction parallel to the long sides may be set as the horizontal direction.

It should be noted that, the plurality of first signal lines extending along the horizontal direction X may be the plurality of first signal lines extending linearly along the horizontal direction X, or may be the plurality of first signal lines extending non-linearly along the horizontal direction X, for example, the plurality of first signal lines extend along a zigzag line along the horizontal direction X, and an included angle between at least a partial region of each first signal line and the horizontal direction X is greater than 0. The plurality of second signal lines extending along the vertical direction Y may be the plurality of second signal lines extending linearly along the vertical direction Y, or may be the plurality of second signal lines extending non-linearly along the vertical direction Y, for example, the plurality of second signal lines extend along a zigzag line along the vertical direction Y, and an included angle between at least a partial region of each second signal line and the vertical direction Y is greater than 0.

It should be noted that, FIG. 15 illustrates an example in which the first direction a1 is the vertical direction Y, the first signal lines 1001 and the second light shielding regions 802 extend in a same direction, the second signal lines 1002 and the first light shielding regions 801 extend in a same direction; orthogonal projections of the first signal lines 1001 located in the display region (not shown) on the display panel 01 fall into respective second light shielding regions 802, and orthogonal projections of the second signal lines 1002 located in the display region (not shown) on the display panel 01 fall into respective first light shielding regions 801.

It should be noted that, the plurality of first signal lines extending along the horizontal direction X may be the plurality of first signal lines extending linearly along the horizontal direction X, or may be the plurality of first signal lines extending non-linearly along the horizontal direction X, for example, the plurality of first signal lines extend along a zigzag line along the horizontal direction X. Similarly, the plurality of second signal lines extending along the vertical direction Y may be the plurality of second signal lines extending linearly along the vertical direction Y, or may be the plurality of second signal lines extending non-linearly along the vertical direction Y, for example, the plurality of second signal lines extend along a zigzag line along the vertical direction Y.

In some embodiments, each first signal line electrically connected to the gate electrode of the thin film transistor is a scan line, and each second signal line electrically connected to the source electrode of the thin film transistor is a data line.

In some embodiments, the light shielding layer of the opposite substrate further includes the second light shielding portions, i.e., includes the opening regions.

Alternatively, in some embodiments, the first signal lines or the second signal lines are multiplexed as (i.e., also serve as) the second light shielding portions. FIGS. 16 and 17 illustrate an example in which the first signal lines 1001 also serve as the second light shielding portions.

It should be noted that, the signal lines are usually made of a metal material, and thus have a light shielding effect. In a case where the first signal lines or the second signal lines also serve as the second light shielding portions, the first signal lines or the second signal lines have the light shielding effect besides a signal transmission effect.

In some embodiments, in a case where the first signal lines or the second signal lines also serve as the second light shielding portions, the orthogonal projections of the second light shielding portions on the display panel overlap with the orthogonal projections of the first light shielding portions on the display panel. In a pattern formed by the orthogonal projections of the second light shielding portions on the display panel intersecting with the orthogonal projections of the first light shielding portions on the display panel, blank regions (i.e., regions without any one of the light shielding portions therein) located in the display region are the opening regions.

In some embodiments, the first signal lines or the second signal lines also serve as the second light shielding portions, and in the light shielding regions each located between adjacent two of the opening regions in the first direction, the opposite substrate does not include the light shielding layer. That is, the opposite substrate is not provided with the light shielding layer in partial regions corresponding to the second light shielding portions. That is, the display panel shields light through cooperation of the light shielding layer and the second light shielding portions.

Alternatively, in some embodiments, in the light shielding regions each located between adjacent two of the opening regions in the first direction, the opposite substrate is provided with the light shielding layer.

In some embodiments, as shown in FIGS. 16 and 17, the number of the second light shielding portions 302 is less than the number of the sub-pixels 201 included in each pixel bar 2. Specifically, since the region of each pixel electrode corresponds to the region of one sub-pixel, the number of the second light shielding portions 302 is less than the number of the pixel electrodes (not shown) included in each pixel bar 2. That is, in the case where the first signal lines or the second signal lines also serve as the second light shielding portions, the number of the first signal lines or the number of the second signal lines is less than the number of the sub-pixels or the pixel electrodes included in each pixel bar.

In some embodiments, the sub-pixels arranged in the horizontal direction are the sub-pixels in a row, and the sub-pixels arranged in the vertical direction are the sub-pixels in a column.

In some embodiments, in a case where the first direction is the horizontal direction, the number of data lines is half the number of sub-pixels included in each pixel bar, and each data line is electrically connected to two columns of sub-pixels.

In some embodiments, in the case where the first direction is the horizontal direction, the plurality of second signal lines include at least one dummy second signal line in addition to the plurality of data lines, and the dummy second signal line is not electrically connected to any pixel bar.

In some embodiments, in a case where the first direction is the vertical direction, the number of scan lines is half the number of sub-pixels included in each pixel bar, and each scan line is electrically connected to adjacent two of the sub-pixels in each pixel bar.

In some embodiments, as shown in FIG. 16, in the case where the first direction a1 is the vertical direction Y, the plurality of first signal lines 1001 further includes at least one dummy first signal line 10012 in addition to the plurality of scan lines 10011, and the dummy first signal line 10012 is not electrically connected to any pixel bar 2.

In some embodiments, the first one and/or the last one of the plurality of first signal lines in the direction in which the plurality of first signal lines are arranged is (are) dummy first signal line(s). FIG. 16 illustrates an example in which the first one of the plurality of first signal lines 1001 in the direction in which the plurality of first signal lines 1001 are arranged (i.e., the uppermost first signal line 1001) is the dummy first signal line 10012.

In some embodiments, as shown in FIG. 17, each sub-pixel 201 includes a pair of first sides 5 extending in a direction intersecting with the first direction a1.

In some embodiments, as shown in FIGS. 16 and 17, an outline shape of each sub-pixel 201 in a direction perpendicular to the display panel 01 is non-rectangular.

In some embodiments, as shown in FIGS. 16 and 17, the outline shape of each sub-pixel 201 in the direction perpendicular to the display panel 01 is substantially a parallelogram.

In some embodiments, as shown in FIGS. 16 and 17, each sub-pixel 201 further has a pair of sides extending along the first direction a1. A length of each of the first sides 5 is greater than a length of each of the sides of each sub-pixel 201 extending in the first direction a1. That is, the first sides 5 are long sides of each sub-pixel 201.

In some embodiments, as shown in FIG. 17, an included angle 02 between each first side 5 and the direction of the normal line 6 of the first direction a1 is greater than 0° and less than 90°, and an included angle 04 between an extending direction of each second light shielding portion 302 (i.e., a direction in which each second light shielding portion 302 extends) and each first side 5 is greater than 0°.

The orthogonal projections of the second light shielding portions 302 on the display panel 01 overlap with the orthogonal projections of the sub-pixels 201 on the display panel 01.

In the display device according to the present embodiment, the included angle between the extending direction of each second light shielding portion and each first edge is greater than 0°, namely the extending direction of each second light shielding portion is different from the extending direction of a pair of opposite sides of each sub-pixel, so that the regular arrangement of sub-pixel regions can be broken, and the Moire fringes can be mitigated.

In some embodiments, as shown in FIG. 15, an extending direction of each pixel electrode 12 is the same as the extending direction of each first side (not shown in this figure). The orthogonal projections of the pixel electrodes 12 on the display panel 01 overlap with the orthogonal projections of the second light shielding portions 302 on the display panel 01, and the orthogonal projections of the opening regions 9 on the display panel 01 overlap with the orthogonal projections of the pixel electrodes 12 on the display panel 01, respectively.

In some embodiments, as shown in FIG. 17, the orthogonal projections of the opening regions 9 on the display panel 01, the orthogonal projections of the plurality of sub-pixels 2 on the display panel 01, and the orthogonal projections of the plurality of pixel electrodes (not shown in this figure) on the display panel 01 overlap with each other. The orthogonal projections of the second light shielding portions 302 on the display panel 01, the orthogonal projections of the plurality of sub-pixels 2 on the display panel 01, and the orthogonal projections of the plurality of pixel electrodes (not shown in this figure) on the display panel 01 overlap with each other.

The orthogonal projections of the second light shielding portions 302 on the display panel 01 divide a region of the sub-pixels 2 into a plurality of portions.

In some embodiments, any straight line along the third direction a3 passes through a center of a first sub-pixel, a center of a second sub-pixel, and a center of a third sub-pixel, thereby avoiding color separation between different sub-pixels in the 3D display mode.

In some embodiments, as shown in FIG. 17, an included angle 01 between the third direction a3 and the direction of the normal line 6 of the first direction a1 satisfies the following formula:

$$0.9 \times \frac{j \times P 2}{P 1} \leq \vert tan θ 1 \vert \leq 1.1 \times \frac{j \times P 2}{P 1} ;$$

where P1 is a period in which the pixel bars 2 are arranged, P2 is a period in which the plurality of sub-pixels 201 in each pixel bar 2 are arranged in the first direction a1, and j is an integer greater than or equal to 0.

In the display device according to the present embodiment, with

$$0.9 \times \frac{j \times P 2}{P 1} \leq \vert tan θ 1 \vert \leq 1.1 \times \frac{j \times P 2}{P 1} ,$$

it is ensured that any straight line along the third direction a3 substantially passes through the center of a first sub-pixel, the center of a second sub-pixel, and the center of a third sub-pixel within a reasonable process tolerance range, thereby preventing color separation between different sub-pixels in the 3D display mode.

In some embodiments, as shown in FIG. 17,

$$\vert tan θ 1 \vert = \frac{j \times P 2}{P 1} ,$$

which ensures that any straight line along the third direction a3 passes through the center of a first sub-pixel, the center of a second sub-pixel, and the center of a third sub-pixel, thereby further preventing color separation between different sub-pixels in the 3D display mode.

In some embodiments, in the display device shown in FIG. 17, j=4. That is, in FIG. 17,

$$\vert tan θ 1 \vert = \frac{4 \times P 2}{P 1} .$$

Alternatively, in a specific implementation, it is possible that j=1, or j=3, etc.

In some embodiments, as shown in FIG. 17, in the case of

$$0.9 \times \frac{j \times P 2}{P 1} \leq \vert tan θ1 \vert \leq 1.1 \times \frac{j \times P 2}{P 1} , θ 1 = θ 2 ,$$

which further reduces crosstalk in the displayed picture in the 3D display mode.

It should be noted that

$$0.9 \times \frac{j \times P 2}{P 1} \leq \vert tan θ1 \vert \leq 1.1 \times \frac{j \times P 2}{P 1}$$

is a setting method from the perspective of avoiding color separation. In specific implementations, θ1 and θ2 may be set in other ways if other issues are considered.

In some embodiments, as shown in FIG. 18, the total length of a region W1 where a first preset length line segment L1 overlaps with a second light shielding portion 302 in the third direction a3 is a first length w1, and within each light splitting structure 401, first lengths w1 corresponding to any first preset length line segment L1 are equal to each other.

The first preset length line segment L1 extends along the third direction a3, and a length of a projection of the first preset length line segment L1 in the direction of the normal line 6 of the first direction a1 (which is the same as the second direction a2 in FIG. 18) is a difference between P1 and P4, i.e., (P1−P4), which is equal to a width of each opening region 9 in the second direction a2. P3 is a period in which the second light shielding portions 302 are arranged in the first direction a1, and P4 is a width of each first light shielding portion 301 in a direction perpendicular to the first direction a1.

In some embodiments, as shown in FIG. 18, a length of each second light shielding portion 302 in the third direction a3 is a second length w2.

It should be noted that, the number of entire second light shielding portions 302 passing through any first preset length line segment L1 in the third direction a3 is defined as an integer part of a ratio of the first length w1 to the second length w2. In the case where the first lengths w1 corresponding to any first preset length line segment L1 are equal to each other within each light splitting structure 401, the number of entire second light shielding portions 302 passing through any first preset length line segment L1 in the third direction a3 is equal (or constant) within each light splitting structure 401.

In the display device according to the present embodiment, within each light splitting structure, the first lengths w1 corresponding to any first preset length line segment L1 are equal to each other, i.e., the number of entire second light shielding portions passing through any first preset length line segment in the third direction is equal, so that the Moire fringes can be mitigated or even eliminated, and the display effect is improved.

In some embodiments, in the case where the first lengths w1 corresponding to any first preset length line segment L1 are equal to each other, the ratio of the first length w1 to the second length w2 is an integer.

It should be noted that, FIG. 18 illustrate an example in which the ratio of the first length w1 to the second length w2 is 1, i.e., the number of entire second light shielding portions 302 passing through any first preset length line segment L1 in the third direction a3 within each light splitting structure 401 is 1. FIG. 18 illustrates that the first preset length line segment L1 overlaps with only 1 (one) second light shielding portion 302, and the first preset length line segment L1 passes through an entire second light shielding portion 302. However, within each light splitting structure 401, in the third direction a3, and at some other unmarked positions, the first preset length line segment L1 overlaps with 2 (two) second light shielding portions 302, the first preset length line segment L1 passes through 2 (two) partial (i.e., not entire) second light shielding portions 302, and the first length w1 corresponding to the first preset length line segment L1 is still equal to the second length w2; in this case, the number of entire second light shielding portions 302 passing through any first preset length line segment L1 in the third direction a3 is still 1.

In some embodiments, as shown in FIG. 18, the included angle θ1 between the third direction a3 and the direction of the normal line 6 of the first direction a1 satisfies the following formula:

$$0.9 \times \frac{i \times P 3}{P 1 - P 4} \leq \vert tan θ 1 \vert \leq 1.1 \times \frac{i \times P 3}{P 1 - P 4} ;$$

where P1 is the period in which the pixel bars 2 are arranged, P3 is the period in which the second light shielding portions 302 are arranged in the first direction a1, P4 is the width of each first light shielding portion 301 in the direction perpendicular to the first direction a1, and i is a value obtained by rounding the ratio of the first length w1 to the second length w2.

In the display device according to the present embodiment, with

$$0.9 \times \frac{i \times P 3}{P 1 - P 4} \leq \vert tan θ1 \vert \leq 1.1 \times \frac{i \times P 3}{P 1 - P 4} ,$$

within a reasonable process tolerance range, the number of entire second light shielding portions passing through any first preset length line segment in the third direction can be equal, thereby mitigating or even eliminating the Moire fringes and improving the display effect.

In some embodiments, as shown in FIG. 18,

$$\vert tan θ 1 \vert = \frac{i \times P 3}{P 1 - P 4} .$$

In some embodiments, in the display device corresponding to FIG. 18, within each light splitting structure 401, the ratio of the first length w1 to the second length w2 is 1, i.e., the number of entire second light shielding portions 302 passing through any first preset length line segment L1 in the third direction a3 is 1, i=1, and

$$\vert tan θ1 \vert = \frac{1 \times P 3}{P 1 - P 4} .$$

In some embodiments, it is possible to simultaneously satisfy both

$$0.9 \times \frac{i \times P 3}{P 1 - P 4} \leq \vert tan θ 1 \vert \leq 1.1 \times \frac{i \times P 3}{P 1 - P 4} and 0.9 \times \frac{i \times P 3}{P 1 - P 4} \leq \vert tan θ 1 \vert \leq 1.1 \times \frac{j \times P 2}{P 1} ,$$

thereby mitigating or even eliminating the Moire fringes and further improving the display effect while preventing color separation between different sub-pixels in the 3D display mode.

In some embodiments, as shown in FIGS. 16 to 18, the extending direction of each of the second light shielding portions 302 is perpendicular to the first direction a1. In FIGS. 16 to 18, the first direction a1 is perpendicular to the second direction a2, and the extending direction of each of the second light shielding portions 302 is the second direction a2.

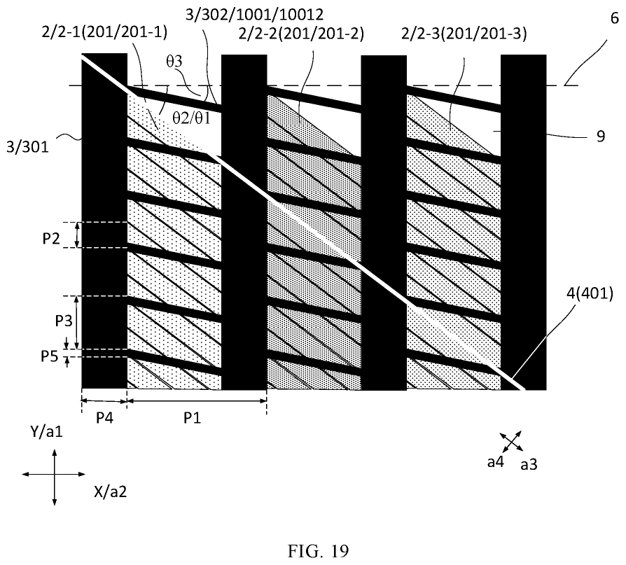

Alternatively, in some embodiments, as shown in FIG. 19, an included angle θ3 between the extending direction of each second light shielding portion 302 and the direction of the normal line 6 of the first direction a1 is greater than 0° and less than 90°.

It should be noted that in a case where the extending direction of each second light shielding portion is perpendicular to the first direction, and the condition

$$0.9 \times \frac{i \times P 3}{P 1 - P 4} \leq \vert tan θ1 \vert \leq 1. 1 \times \frac{i \times P 3}{P 1 - P 4}$$

cannot be satisfied, within each light splitting structure, the first lengths w1 corresponding to any first preset length line segment L1 are not completely equal to each other. That is, the numbers of entire second light shielding portions passing through the first preset length line segment in different regions in the third direction are not completely equal to each other, resulting in a risk that the Moire fringes occur. In the display device according to the present embodiment, θ3 is greater than 0° and less than 90°, i.e., the extending direction of each second light shielding portion is not perpendicular to the first direction a1, which can achieve that within each light splitting structure, the first lengths w1 corresponding to any first preset length line segment L1 are equal to each other, i.e., the numbers of entire second light shielding portions passing through the first preset length line segment in any region in the third direction are equal to each other, which is beneficial to mitigating or even eliminating the Moire fringes and improving the display effect.

In a case where the condition

$$0.9 \times \frac{i \times P 3}{P 1 - P 4} \leq \vert tan θ 1 \vert \leq 1.1 \times \frac{i \times P 3}{P 1 - P 4}$$

is not satisfied, i.e.,

$$\vert tan θ 1 \vert > 1.1 \times \frac{i \times P 3}{P 1 - P 4} , or \vert tan θ 1 \vert < 0.9 \times \frac{i \times P 3}{P 1 - P 4} ,$$

in some embodiments, as shown in FIG. 19, the included angle θ1 between the third direction a3 and the direction of the normal line 6 of the first direction a1 satisfies the following formula:

$$0.9 \times \frac{i \times P 3 - ( P 1 - P 4 ) \times tan θ 3}{P 1 - P 4} \leq \vert tan θ 1 \vert \leq 1.1 \times \frac{i \times P 3 - ( P 1 - P 4 ) \times tan θ 3}{P 1 - P 4} ;$$

where P1 is the period in which the pixel bars 2 are arranged, θ3 is the included angle between the extending direction of each second light shielding portion 302 and the direction of the normal line 6 of the first direction a1, and i is the value obtained by rounding the ratio of the first length w1 to the second length w2.

In the display device according to the present embodiment, the extending direction of each second light shielding portion is not perpendicular to the first direction a1, and considering a reasonable process tolerance range, θ3 and θ1 satisfy the condition 0.9×

$$\frac{i \times P 3 - ( P 1 - P 4 ) \times tan θ3}{P 1 - P 4} \leq \vert tan θ 1 \vert \leq 1.1 \times \frac{i \times P 3 - ( P 1 - P 4 ) \times tan θ3}{P 1 - P 4} ,$$

thereby ensuring that within each light splitting structure, the first lengths w1 corresponding to any first preset length line segment L1 are equal to each other, i.e., the numbers of entire second light shielding portions passing through the first preset length line segment in any region in the third direction are equal to each other, which further mitigates or even eliminates the Moire fringes and improves the display effect.

In some embodiments,

$$\vert tan θ 1 \vert = \frac{i \times P 3 - ( P 1 - P 4 ) \times tan θ3}{P 1 - P 4} .$$

In some embodiments, in the display device corresponding to FIG. 19, within each light splitting structure 401, the first length corresponding to any first preset length line segment is 1, i.e., the number of entire second light shielding portions 302 passing through any first preset length line segment L1 in the third direction a3 is 1, i=1, and

$$\vert tan θ 1 \vert = \frac{P 3 - ( P 1 - P 4 ) \times tan θ3}{P 1 - P 4} .$$

Alternatively, in a specific implementation, in a case of

$$\vert tan θ 1 \vert > 1.1 - \times \frac{i \times P 3}{P 1 - P 4} or \vert tan θ 1 \vert < 0.9 \times \frac{i \times P 3}{P 1 - P 4} ,$$

within each light splitting structure, the first lengths w1 corresponding to any first preset length line segment L1 are not completely equal to each other, i.e., the numbers of entire second light shielding portions passing through the first preset length line segment in different regions in the third direction are not completely equal to each other. In such a case, the Moire fringes may be mitigated or even eliminated in other ways.

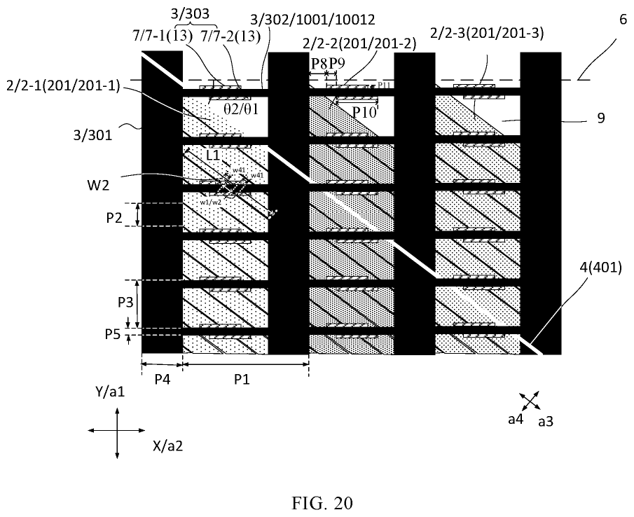

In some embodiments, as shown in FIGS. 20 to 24, the extending direction of each second light shielding portion 302 is perpendicular to the first direction a1, and the display panel 01 further includes a plurality of third light shielding portions 303. Each of the third light shielding portions 303 includes at least one light shielding sub-portion 7, and each light shielding sub-portion 7 includes a first portion 13.

An orthogonal projection of each first portion 13 on the display panel 01 does not overlap with the orthogonal projections of each first light shielding portion 301 and each second light shielding portion 302 on the display panel 01, and the orthogonal projection of each first portion 13 on the display panel 01 is adjacent to the orthogonal projection of a respective first light shielding portion 301 or a respective second light shielding portion 302 on the display panel 01.

In the case where the first lengths w1 corresponding to any first preset length line segment L1 are not completely equal to each other within each light splitting structure, in some embodiments, as shown in FIG. 20, the total length of a region where the first preset length line segment L1 overlaps with each first portion 13 of each third light shielding portion 303 in the third direction a3 is a third length (which is denoted as w3), and w3 is greater than or equal to 0; the total length of all the first portions 13 of each third light shielding portion 303 in the third direction is a fourth length (which is denoted as w4).

The value obtained by rounding the ratio of the first length w1 to the second length w2 is a first ratio, and a value obtained by rounding a ratio of the third length w3 to the fourth length w4 is a second ratio.

In each light splitting structure 401, a sum of the first ratio and the second ratio corresponding to any first preset length line segment L1 is equal (or constant).

The first preset length line segment L1 extends along the third direction a3, and a length of a projection of the first preset length line segment L1 on the direction of the normal line 6 of the first direction a1 (which is the same as the second direction a2 in FIG. 20) is the difference between P1 and P4 (i.e., P1−P4), i.e. is equal to the width of each opening region 9 in the second direction a2. P3 is the period in which the second light shielding portions 302 are arranged in the first direction a1, and P4 is the width of each first light shielding portion 301 in the direction perpendicular to the first direction a1.

It should be noted that, within each light splitting structure, any first preset length line segment L1 has an overlapping region with (i.e., overlaps with) the second light shielding portions. But the first preset length line segment L1 has no overlapping region with (i.e., does not overlap with) any first portion at some positions, i.e., w3 is equal to 0 at these positions. The number of entire third light shielding portions passing through any first preset length line segment L1 in the third direction a3 is defined as an integer part of the ratio of the third length w3 to the fourth length w4. Within each light splitting structure, in a case where the sum of the first ratio and the second ratio corresponding to any first preset length line segment L1 is equal (i.e., constant), a sum of the number of entire third light shielding portions passing through any first preset length line segment L1 and the number of entire second light shielding portions passing through any first preset length line segment L1 in the third direction a3 is equal (i.e., constant).

In the display device according to the present embodiment, the display panel further includes the third light shielding portions, and each first portion of each third light shielding portion is adjacent to a respective first light shielding portion or a respective second light shielding portion, so that each opening region is no longer a regular rectangle; within each light splitting structure, the sum of the first ratio and the second ratio corresponding to any first preset length line segment is equal, which realizes that the sum of the number of the third light shielding portions and the number of the second light shielding portions passing through the first preset length line segment in different regions in the third direction within each light splitting structure is equal. With such an arrangement, the Moire fringes can be mitigated or even eliminated.

In some embodiments, in the case where the sum of the first ratio and the second ratio corresponding to any first preset length line segment is equal, the ratio of the first length w1 to the second length w2 is an integer, and the ratio of the third length w3 to the fourth length w4 is an integer.

In some embodiments, as shown in FIGS. 20 to 24, a sum S of areas of orthogonal projections of the first portions 13 included in each third light shielding portion 303 on the display panel 01 satisfies the following formula:

$$0 \text{.9} \times ( P 4 - \frac{P 1 \times \vert tan θ 1 \vert - {i}^{′} \times P 3}{\vert tan θ 1 \vert} ) \times P 5 \leq S \leq 1.1 \times ( P 4 - \frac{P 1 \times \vert tan θ 1 \vert - {i}^{′} \times P 3}{\vert tan θ 1 \vert} ) \times P 5 ;$$

where

$$\vert tan θ 1 \vert > 1.1 \times \frac{i \times P 3}{P 1 - P 4} or \vert tan θ 1 \vert < 0.9 \times \frac{i \times P 3}{P 1 - P 4} ;$$

P1 is the period in which the pixel bars 2 are arranged; P3 is the period in which the second light shielding portions 302 are arranged in the first direction a1; P4 is the width of each first light shielding portion 301 in the direction perpendicular to the first direction a1; P5 is a width of each second light shielding portion 302 in the first direction a1; i is the value obtained by rounding of the ratio of the first length w1 to the second length w2, and i′ is the sum of the first ratio and the second ratio.

In some embodiments,

$$S = ( P 4 - \frac{P 1 \times \vert tan θ 1 \vert - {i}^{′} \times P 3}{\vert tan θ 1 \vert} ) \times P 5 ,$$

which is more beneficial to mitigating or even eliminating the Moire fringes. However, considering a process error, if S satisfies:

$$0.9 \times ( P 4 - \frac{P 1 \times \vert tan θ 1 \vert - {i}^{′} \times P 3}{\vert tan θ 1 \vert} ) \times P 5 \leq S \leq 1.1 \times ( P 4 - \frac{P 1 \times \vert tan θ 1 \vert - {i}^{′} \times P 3}{\vert tan θ 1 \vert} ) \times P 5 ,$$

a relatively good effect of mitigating or even eliminating the Moire fringes can still be achieved.

It should be noted that in a case where the first lengths w1 corresponding to any first preset length line segment L1 are not completely equal to each other, the values obtained by rounding the ratios of different first lengths w1 to different second lengths w2 may be the same or different, i.e., i can take more than one value. In the case where i can take more than one value, as long as one value thereof satisfies

$$\vert tan θ 1 \vert > 1.1 \times \frac{i \times P 3}{P 1 - P 4} or \vert tan θ 1 \vert < 0.9 \times \frac{i \times P 3}{P 1 - P 4} ,$$

it can be considered that the condition

$$\vert tan θ 1 \vert > 1.1 \times \frac{i \times P 3}{P 1 - P 4} or \vert tan θ 1 \vert < 0.9 \times \frac{i \times P 3}{P 1 - P 4}$$

is satisfied.

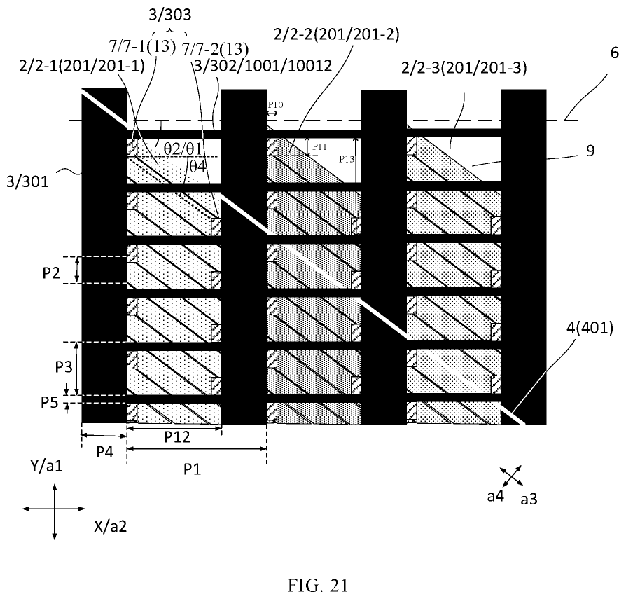

In some embodiments, as shown in FIGS. 20 to 21, each third light shielding portion 303 includes a plurality of light shielding sub-portions 7 that have an equal area.

In some embodiments, as shown in FIGS. 20 to 21, the plurality of light shielding sub-portions 7 include a first light shielding sub-portion 7-1 and a second light shielding sub-portion 7-2 located on both sides of a respective second light shielding portion 302 in the first direction a1.

In some embodiments, as shown in FIG. 20, orthogonal projections of the first portions 13 of the first light shielding sub-portion 7-1 and the second light shielding sub-portion 7-2 on the display panel 01 are adjacent to the orthogonal projection of the respective second light shielding portion 302 on the display panel 01.

In some embodiments, as shown in FIG. 20, the first light shielding sub-portion 7-1 and the second light shielding sub-portion 7-2 are staggered relative to each other in the direction of the normal line 6 of the first direction a1.

Therefore, the two light shielding sub-portions are not regularly arranged, which is more beneficial to realizing that within each light splitting structure, the sum of the first ratio and the second ratio corresponding to any first preset length line segment L1 is equal, i.e., the sum of the number of the third light shielding portions and the number of the second light shielding portions passing through the first preset length line segment in different regions along the third direction a3 is equal, and such an arrangement can further mitigate or even eliminate the Moire fringes.

In some embodiments, as in the display device shown in FIG. 20, an example in which the sum of the first ratio and the second ratio is 2 is illustrated; a length of each first portion 13 in the third direction is w41, and each third light shielding portion 303 includes two first portions 13 each having the length w41 in the third direction, thus w4=2×w41. In the example illustrated in FIG. 20, the first preset length line segment L1 has an overlapping region with the second light shielding portion 302 and the third light shielding portion 303 in the region W2, and in the region W2, w3=w4=2×w41, and w2=w1. At some other unmarked positions, there is also a case where the first preset length line segment L1 has no overlapping region with any first portion, and w3 is equal to 0; the first preset length line segment L1 has overlapping regions with 2 (two) second light shielding portions 302, and w2=2×w1. That is, for the display device shown in FIG. 20, within each light splitting structure 401, the number of entire second light shielding portions 302 passing through the first preset length line segment L1 in the third direction a3 is 1 or 2, and the number of entire third light shielding portions 303 passing through the first preset length line segment L1 in the third direction a3 is 1 or 0; that is, the sum of the number of entire second light shielding portions 302 and the number of entire third light shielding portions 303 passing through the first preset length line segment L1 in the third direction a3 is 2, i=1, 2, and i′=2.

In some embodiments, as shown in FIG. 20, in the direction of the normal line 6 of the first direction a1, a distance P9 by which the first light shielding sub-portion 7-1 and the second light shielding sub-portion 7-2 are staggered relative to each other satisfies:

$$0.9 \times \frac{P 5}{\vert tan θ 1 \vert} \leq P 9 \leq 1.1 \times \frac{P 5}{\vert tan θ 1 \vert} .$$

A distance P8 between the first light shielding sub-portion 7-1 or the second light shielding sub-portion 7-2 and the nearest first light shielding portion 301 satisfies:

$$0.9 \times ( P 1 - P 4 - \frac{( {i}^{′} - 1 ) \times P 3 + \frac{P 5}{2}}{\vert tan θ 1 \vert} ) \leq P 8 \leq 1.1 \times ( P 1 - P 4 - \frac{( {i}^{′} - 1 ) \times P 3 + \frac{P 5}{2}}{\vert tan θ 1 \vert} ) ,$$

where i′ is greater than or equal to 2.

In some embodiments, as shown in FIG. 20,

$$P 9 = \frac{P 5}{\vert tan θ1 \vert} , P 8 = P 1 - P 4 - \frac{( {i}^{′} - 1 ) \times P 3 + P 5 / 2}{\vert tan θ1 \vert} ,$$

which can further mitigate or even eliminate the Moire fringes.

It should be noted that during a manufacturing process of the display panel, factors such as process errors may occur, resulting in cases of P9 not being equal to

$$\frac{P 5}{\vert tan θ1 \vert}$$

and P8 not being equal to

$$( P 1 - P 4 - \frac{( {i}^{′} - 1 ) \times P 3 + P 5 / 2}{\vert tan θ1 \vert} .$$

Within a reasonable process tolerance range, P8 satisfies:

$$0.9 \times ( P 1 - P 4 - \frac{( {i}^{′} - 1 ) \times P 3 + \frac{P5}{2}}{\vert tan θ1 \vert} ) \leq P 8 \leq 1.1 \times ( P 1 - P 4 - \frac{( {i}^{′} - 1 ) \times P 3 + \frac{P5}{2}}{\vert tan θ1 \vert} ) ,$$

and P9 satisfies:

$$0.9 \times \frac{P 5}{\vert tan θ1 \vert} \leq P 9 \leq 1.1 \times \frac{P 5}{\vert tan θ1 \vert} ,$$

which can still mitigate or even eliminate the Moire fringes.

In some embodiments, as shown in FIG. 20, the first portion 13 of the first light shielding sub-portion 7-1 and the first portion 13 of the second light shielding sub-portion 7-2 have a same shape, which is a shape of a strip.

Each first portion 13 has a pair of sides parallel to the first direction a1, and another pair of sides perpendicular to the first direction a1.

A length P10 of each side perpendicular to the first direction a1 of the first portion 13 satisfies:

$$0.9 \times ( P 4 - \frac{P 1 \times \vert tan θ1 \vert - {i}^{′} \times P 3}{\vert tan θ1 \vert} ) \times \frac{P 5}{2} \leq P 10 \leq 1.1 \times ( P 4 - \frac{P 1 \times \vert tan θ1 \vert - {i}^{′} \times P 3}{\vert tan θ1 \vert} ) \times \frac{P 5}{2} ;$$

and
a length P11 of each side in the first direction a1 of the first portion

$$0.9 \times \frac{P 5}{2} \leq P 11 \leq 1.1 \times \frac{P 5}{2} ,$$

where i′ is greater than or equal to 2.

In the case where the first light shielding sub-portion and the second light shielding sub-portion are respectively positioned on two sides of the respective second light shielding portion in the first direction, and the orthogonal projections of the first light shielding sub-portion and the second light shielding sub-portion on the display panel 01 are adjacent to the orthogonal projection of the respective second light shielding portion on the display panel 01, the light shielding sub-portions meet the foregoing conditions within a reasonable process tolerance range, which can further mitigate or even eliminate the Moire fringes, and meanwhile, can prevent a size of each opening region from being influenced as much as possible.

In some embodiments, as shown in FIG. 20,

$$P 10 = ( P 4 - \frac{P 1 \times \vert tan θ1 \vert - {i}^{′} \times P 3}{\vert tan θ1 \vert} ) \times \frac{P 5}{2} ,$$

the length P11 of each side in the first direction a1 of the first portion 13 satisfies

$$P 11 = \frac{P 5}{2} ,$$

which can better mitigate or even eliminate the Moire fringes.

In some embodiments, as shown in FIG. 21, the orthogonal projections of the two first portions 13 on the display panel 01 are adjacent to the orthogonal projections of the first light shielding portions 301 on both sides of a respective pixel bar 2 on the display panel 01, respectively.

In some embodiments, as shown in FIG. 21, a distance P12 between two farthest sides of the first light shielding sub-portion 7-1 and the second light shielding sub-portion 7-2 in the direction of the normal line 6 of the first direction a1 satisfies: 0.9×(P1−P4)≤P12≤1.1×(P1−P4).

In some embodiments, as shown in FIGS. 21, P12=(P1−P4), which can better mitigate or even eliminate the Moire fringes.

It should be noted that in a manufacturing process of the display panel, when factors such process errors occur, the situation that P12≠(P1−P4) may occur, and within a reasonable process tolerance range, P12 satisfies the following conditions: 0.9×(P1−P4)≤P12≤1.1×(P1−P4), which can still mitigate or even eliminate the Moire fringes.

In some embodiments, as shown in FIG. 21, a distance P13 between two farthest sides of the first light shielding sub-portion 7-1 and the second light shielding sub-portion 7-2 in the first direction a1 satisfies: 0.9×(i′×P3−P5)≤P13≤1.1×(i′×P3−P5), where P5 is the width of each second shielding portion 302 in the first direction a1, and i′ is greater than or equal to 1.

In some embodiments, as shown in FIG. 21, P13=i′×P3−P5, which can better mitigate or even eliminate the Moire fringes.

It should be noted that during a manufacturing process of the display panel, when factors such as process errors occur, a case where P13 #i′×P3−P5 may occur. Within a reasonable process tolerance range, P13 satisfies: 0.9×(i′×P3−P5)≤P13≤1.1×(i′×P3−P5), which can still mitigate or even eliminate the Moire fringes.

In some embodiments, as shown in FIG. 21, the first portion 13 of the first light shielding sub-portion 7-1 and the first portion 13 of the second light shielding sub-portion 7-2 have a same shape, which is a shape of a strip.

A pair of sides of each first portion 13 are parallel to the first direction a1, and the other pair of sides of the first portion 13 are perpendicular to the first direction a1.

A length P10 of each side perpendicular to the first direction a1 of the first portion 13 satisfies:

$$0.9 \times \frac{P5}{\vert tan θ1 \vert} \leq P 10 \leq 1.1 \times \frac{P 5}{\vert tan θ1 \vert} ;$$

and

A length P11 of each side in the first direction a1 of the first portion 13 satisfies:

$$0.9 \times ( P 4 - \frac{P 1 \times \vert tan θ1 \vert - {i}^{′} \times P 3}{\vert tan θ1 \vert} ) \times \frac{\vert tan θ1 \vert}{2} \leq P 11 \leq 1.1 \times ( P 4 - \frac{P 1 \times \vert tan θ1 \vert - {i}^{′} \times P 3}{\vert tan θ1 \vert} ) \times \frac{\vert tan θ1 \vert}{2} ;$$

where i′ is greater than or equal to 1.

In some embodiments,

$$P 10 = \frac{P 5}{\vert tan θ1 \vert} , and P 11 = ( P 4 - \frac{P 1 \times \vert tan θ1 \vert - {i}^{′} \times P 3}{\vert tan θ1 \vert} ) \times \frac{\vert tan θ1 \vert}{2} ,$$

which can better mitigate or even eliminate the Moire fringes.

It should be noted that during a manufacturing process of the display panel, factors such as process errors may occur, resulting in the cases of

$$P 10 \neq i \frac{P 5}{\vert tan θ1 \vert} , and P 11 \neq i ( P 4 - \frac{P 1 \times \vert tan θ1 \vert - {i}^{′} \times P 3}{\vert tan θ1 \vert} ) \times \frac{\vert tan θ1 \vert}{2} ,$$

Within a reasonable process tolerance range, P10 satisfies:

$$0.9 \times \frac{P 5}{\vert tan θ1 \vert} \leq P 10 \leq 1.1 \times \frac{P 5}{\vert tan θ1 \vert} ,$$

and P11 satisfies:

$$0.9 \times ( P 4 - \frac{P 1 \times \vert tan θ1 \vert - {i}^{′} \times P 3}{\vert tan θ1 \vert} ) \times \frac{\vert tan θ1 \vert}{2} \leq P 11 \leq 1.1 \times ( P 4 - \frac{P 1 \times \vert tan θ1 \vert - {i}^{′} \times P 3}{\vert tan θ1 \vert} ) \times \frac{\vert tan θ1 \vert}{2} ,$$

which can still mitigate or even eliminate the Moire fringes.

In some embodiments, as shown in FIG. 21, a line connecting endpoints, which are at one end of their extending direction, of the two closest sides extending along the first direction a1 and respectively located in the first light shielding sub-portion 7-1 and the second light shielding sub-portion 7-2 and the direction of the normal line 6 of the first direction a1 have an included angle θ4 therebetween, and the included angle θ4 is equal to θ1.

In a case where the first light shielding sub-portion and the second light shielding sub-portion are respectively positioned on two sides of a respective second light shielding portion in the first direction, and orthogonal projections of the first light shielding sub-portion and the second light shielding sub-portion on the display panel 01 are adjacent to the orthogonal projections of respective first light shielding portions on the display panel 01, the light shielding sub-portions meet the foregoing conditions, so that the Moire fringes can be further mitigated or even eliminated, and meanwhile, the size of each opening region is prevented from being influenced as much as possible.

It should be noted that in the display device shown in FIG. 21, within each light splitting structure 401, the number of entire second light shielding portions 302 passing through the first preset length line segment L1 in the third direction a3 is 1 or 2, and the number of entire third light shielding portions 303 passing through the first preset length line segment L1 in the third direction a3 is 1 or 0. That is, the sum of the number of entire second light shielding portions 302 and the number of entire third light shielding portions 303 passing through the first preset length line segment L1 in the third direction a3 is 2, i=1, 2, and i′=2.

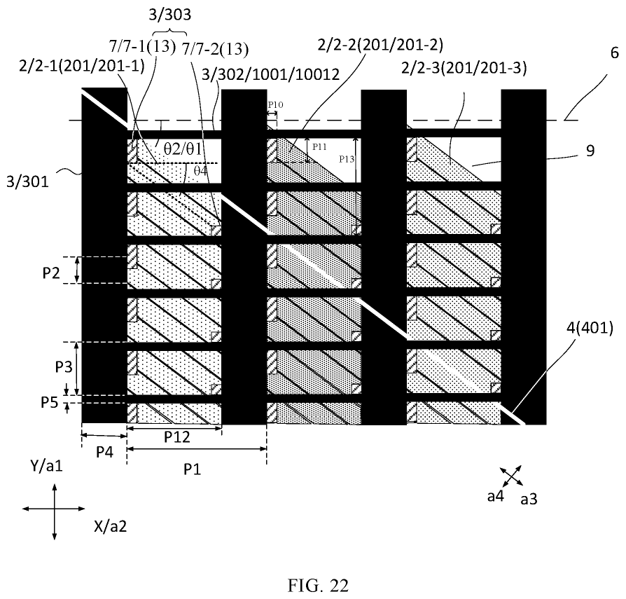

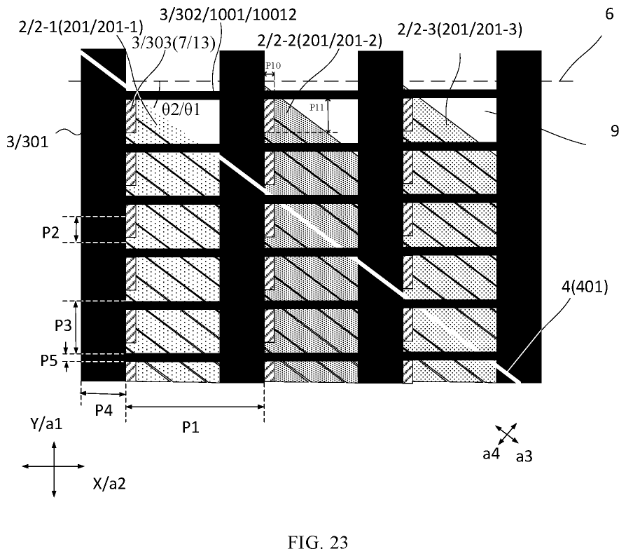

Alternatively, in some embodiments, as shown in FIG. 22, in the case where each third light shielding portion 303 includes a plurality of light shielding sub-portions 7, it is possible that each third light shielding portion 303 includes a plurality of light shielding sub-portions 7 having unequal areas. Further alternatively, in a specific implementation, each third light shielding portion 303 may include 1 (one) light shielding sub-portion 7, as shown in FIG. 23.

In some embodiments, as shown in FIGS. 22 and 23, each light shielding sub-portion 7 includes a pair of opposite sides parallel to the first direction a1, and the other pair of opposite sides perpendicular to the first direction a1.

In the first direction a1, a sum H of lengths of the sides of all the first portions 13 included in each third light shielding portion 303 satisfies:

$$0.9 \times ( P 4 - \frac{P 1 \times \vert tan θ 1 \vert - {i}^{′} \times P 3}{\vert tan θ 1 \vert} ) \times \vert tan θ 1 \vert \leq H \leq 1.1 \times ( P 4 - \frac{P 1 \times \vert tan θ 1 \vert - {i}^{′} \times P 3}{\vert tan θ 1 \vert} ) \times \vert tan θ 1 \vert ;$$

and
in the direction perpendicular to the first direction a1, the length P10 of a side of each first portion 13 satisfies:

$$0.9 \times \frac{P 5}{\vert tan θ 1 \vert} \leq P 10 \leq 1.1 \times \frac{P 5}{\vert tan θ 1 \vert} ;$$

where i′ is greater than or equal to 1.

In some embodiments,

$$H = ( P 4 - \frac{P 1 \times \vert tan θ 1 \vert - {i}^{′} \times P 3}{\vert tan θ 1 \vert} ) \times \vert tan θ 1 \vert , and P 10 = \frac{P 5}{\vert tan θ 1 \vert} ,$$

which can better mitigate or even eliminate the Moire fringes.

It should be noted that during a manufacturing process of the display panel, factors such as process errors may occur, resulting in situations of

$$H \neq ( P 4 - \frac{P 1 \times \vert tan θ 1 \vert - {i}^{′} \times P 3}{\vert tan θ 1 \vert} ) \times \vert tan θ 1 \vert , and P 10 \neq \frac{P 5}{\vert tan θ 1 \vert} .$$

Within a reasonable process tolerance range, H satisfies:

$$0.9 \times ( P 4 - \frac{P 1 \times \vert tan θ 1 \vert - {i}^{′} \times P 3}{\vert tan θ 1 \vert} ) \times \vert tan θ 1 \vert \leq H \leq 1.1 \times ( P 4 - \frac{P 1 \times \vert tan θ 1 \vert - {i}^{′} \times P 3}{\vert tan θ 1 \vert} ) \times \vert tan θ 1 \vert ,$$

and P10 satisfies:

$$0.9 \times \frac{P 5}{\vert tan θ 1 \vert} \leq P 10 \leq 1.1 \times \frac{P 5}{\vert tan θ 1 \vert} ,$$

which can still mitigate or even eliminate the Moire fringes.

In some embodiments, as shown in FIG. 22, each third light shielding portion 303 includes a first light shielding sub-portion 7-1 and a second light shielding sub-portion 7-2 having unequal areas.

Orthogonal projections of the first portions 13 on the display panel 01 are adjacent to the orthogonal projections of the first light shielding portions 301 on both sides of a respective pixel bar 2 on the display panel 01.

In some embodiments, as shown in FIG. 22, in the direction of the normal line 6 of the first direction a1, the distance P12 between the two farthest sides of the first light shielding sub-portion 7-1 and the second light shielding sub-portion 7-2 satisfies: 0.9×(P1−P4)≤P12≤1.1× (P1−P4).

In the first direction a1, a distance P13 between the two farthest sides of the first light shielding sub-portion 7-1 and the second light shielding sub-portion 7-2 satisfies: 0.9×(P3−P5)≤P13≤1.1×(P3−P5), where P5 is the width of each second light shielding portion 302 in the first direction a1, and i′ is greater than or equal to 1.

A line connecting endpoints, which are at one end of their extending direction, of the two closest sides extending in the first direction a1 and respectively located in the first light shielding sub-portion 7-1 and the second light shielding sub-portion 7-2 and the direction of the normal line 6 of the first direction a1 have an included angle θ4 therebetween, and the included angle θ4 is equal to θ1.

It should be noted that in the display device shown in FIGS. 22 and 23, within each light splitting structure 401, the number of entire second light shielding portions 302 passing through the first preset length line segment L1 in the third direction a3 is 1 or 2, and the number of entire third light shielding portions 303 passing through the first preset length line segment L1 in the third direction a3 is 1 or 0. That is, the sum of the number of entire second light shielding portions 302 and the number of entire third light shielding portions 303 passing through the first preset length line segment L1 in the third direction a3 is 2, i=1, 2, and i′=2.

In some embodiments, P12=P1−P4, and P13=P3−P5, which can better mitigate or even eliminate the Moire fringes.

It should be noted that in a manufacturing process of the display panel, when factors such as process errors occur, there may be situations where P12≠(P1−P4), and P13≠P3−P5. Within a reasonable process tolerance range, P12 satisfies: 0.9×(P1−P4)≤P12≤1.1×(P1−P4), and P13 satisfies: 0.9×(P3−P5)≤P13≤1.1×(P3−P5), which can still mitigate or even eliminate the Moire fringes.

In some embodiments, the third light shielding portions are located in a layer where the first light shielding portions are located. That is, the light shielding layer further includes the third light shielding portions.

Alternatively, in some embodiments, the light shielding layer does not include the third light shielding portions.

In some embodiments, the gate electrode and the first signal lines are disposed in a same layer that is a metal layer.

In some embodiments, the source electrode, the drain electrode, and the second signal lines are disposed in a same layer that is also a metal layer.

In some embodiments, the third light shielding portions and at least one of the light shielding pattern, the first signal lines, and the source electrode are disposed in a same layer. Since each of the light shielding pattern and the metal layer has light shielding properties, the third light shielding portions and at least one of the light shielding pattern, the gate electrode, and the source electrode being disposed in a same layer can realize light shielding effect.

In some embodiments, to simplify wiring difficulty of the display panel, the third light shielding portions and the light shielding pattern are disposed in a same layer.

In some embodiments, in a case where the first signal lines also serve as the second light shielding portions, the third light shielding portions and the second light shielding portions are located in a same layer. In the case where the third light shielding portions and the second light shielding portions are located in a same layer, as shown in FIGS. 20 to 23, the orthogonal projections of the light shielding sub-portions 7 on the display panel 01 do not overlap with the orthogonal projections of the second light shielding portions 302 on the display panel 01. That is, each light shielding sub-portion 7 includes only the first portion 13.

Alternatively, in some embodiments, in the case where the first signal lines also serve as the second light shielding portions, the third light shielding portions are located in a layer different from a layer where the second light shielding portions are located. In the case where the third light shielding portions are located in a layer different from a layer where the second light shielding portions are located, in some embodiments, as shown in FIGS. 20 to 23, the orthogonal projections of the light shielding sub-portions 7 on the display panel 01 do not overlap with the orthogonal projection of the light shielding layer 3 on the display panel 01. That is, each light shielding sub-portion 7 includes only the first portion 13.

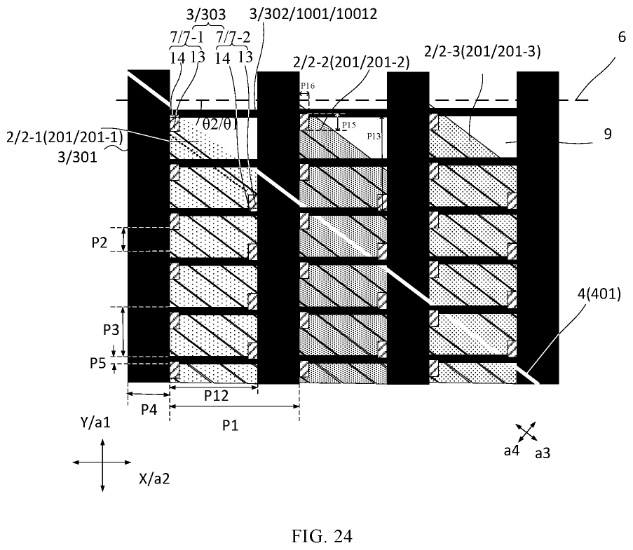

Alternatively, in the case where the third light shielding portions are located in a layer different from a layer where the second light shielding portions are located, in some embodiments, as shown in FIG. 24, each light shielding sub-portion 7 further includes a second portion 14.

An orthogonal projection of the second portion 14 on the display panel 01 falls within the orthogonal projection of the light shielding layer 3 on the display panel 01.

In some embodiments, as shown in FIG. 24, each third light shielding portion 303 includes two light shielding sub-portions 7 having equal areas.

In the first direction a1, orthogonal projections of the two light shielding sub-portions 7 included in each third light shielding portion 303 on the display panel 01 are located on both sides of the orthogonal projection of a respective second light shielding portion 302 on the display panel 01, respectively. An orthogonal projection of each second portion 14 on the display panel 01 overlaps with the orthogonal projection of a respective second light shielding portion 302 on the display panel 01.

In some embodiments, as shown in FIG. 24, an area S′ of the orthogonal projection of each light shielding sub-portion 7 on the display panel 01 satisfies:

$$0.9 \times \frac{P {5}^{2}}{2 \vert tan θ 1 \vert} \leq S ’ \leq 1.1 \times \frac{P {5}^{2}}{2 \vert tan θ 1 \vert} ;$$

$$where \vert tan θ 1 \vert > 1.1 \times \frac{i \times P 3}{P 1 - P 4} , or \vert tan θ 1 \vert < 0.9 \times \frac{i \times P 3}{P 1 - P 4} ;$$

P1 is the period in which the pixel bars 2 are arranged; P3 is the period in which the second light shielding portions 302 are arranged in the first direction a1; P4 is the width of each first light shielding portion 301 in the direction perpendicular to the first direction a1; P5 is the width of each second light shielding portion 302 in the first direction a1; i is the number of entire second light shielding portions 302 passing through the first preset length line segment L1 in the third direction a3 within each light splitting structure 401, and i is a positive integer.

In some embodiments,

$$S ’ = \frac{P {5}^{2}}{2 \vert tan θ 1 \vert} ,$$

which can better mitigate or even eliminate the Moire fringes.

It should be noted that during a manufacturing process of the display panel, factors such as process errors may occur, resulting in a case of

$$S ’ \neq \frac{P {5}^{2}}{2 \vert tan θ 1 \vert} .$$

Within a reasonable process tolerance range, S′ satisfies:

$$0.9 \times \frac{P {5}^{2}}{2 \vert tan θ 1 \vert} \leq S ’ \leq 1.1 \times \frac{P {5}^{2}}{2 \vert tan θ 1 \vert} ,$$

which can still mitigate or even eliminate the Moire fringes.

In some embodiments, as shown in FIG. 24, each light shielding sub-portion 7 includes one pair of sides parallel to the first direction a1, and the other pair of sides perpendicular to the first direction a1.

A length P15 of each side parallel to the first direction a1 of each light shielding sub-portion 7 satisfies:

$$0.9 \times \frac{P 5}{2} \leq P 15 \leq 1.1 \times \frac{P 5}{2} ;$$

and

A length P16 of each side perpendicular to the first direction a1 of each light shielding sub-portion 7 satisfies:

$$0.9 \times \frac{P 5}{\vert tan θ 1 \vert} \leq P 16 \leq 1.1 \times \frac{P 5}{\vert tan θ 1 \vert} .$$

It should be noted that in the display device shown in FIG. 24, within each light splitting structure 401, the number of entire second light shielding portions 302 passing through the first preset length line segment L1 in the third direction a3 is 1 or 2, and the number of entire third light shielding portions 303 passing through the first preset length line segment L1 in the third direction a3 is 1 or 0. That is, the sum of the number of entire second light shielding portions 302 and the number of entire third light shielding portions 303 passing through the first preset length line segment L1 in the third direction a3 is 2, and i′=2.

In some embodiments,

$$P 15 = \frac{P 5}{2} , and P 16 \frac{P 5}{\vert tan θ 1 \vert} ,$$

which can better mitigate or even eliminate the Moire fringes.

It should be noted that during a manufacturing process of the display panel, factors such as process errors may occur, resulting in cases of

$$P 15 \neq \frac{P 5}{2} and P 16 \neq \frac{P 5}{\vert tan θ 1 \vert} .$$

Within a reasonable process tolerance range, P15 satisfies:

$$0.9 \times \frac{P 5}{2} \leq P 15 \leq 1.1 \times \frac{P 5}{2} ,$$

and P16 satisfies:

$$0.9 \times \frac{P 5}{\vert tan θ 1 \vert} \leq P 16 \leq 1.1 \times \frac{P 5}{\vert tan θ 1 \vert} ,$$

which can still mitigate or even eliminate the Moire fringes.

In some embodiments, as shown in FIGS. 21 to 24, the orthogonal projection of each first portion 13 on the display panel 01 is also adjacent to the orthogonal projection of a respective second light shielding portion 302 on the display panel 01.

In some embodiments, as shown in FIGS. 18 to 24, θ2=θ1, which can further reduce the crosstalk of display pictures in the 3D display mode.

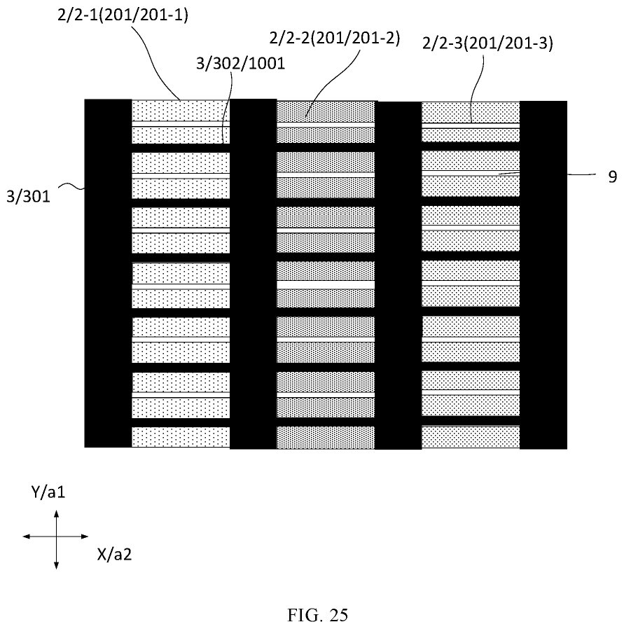

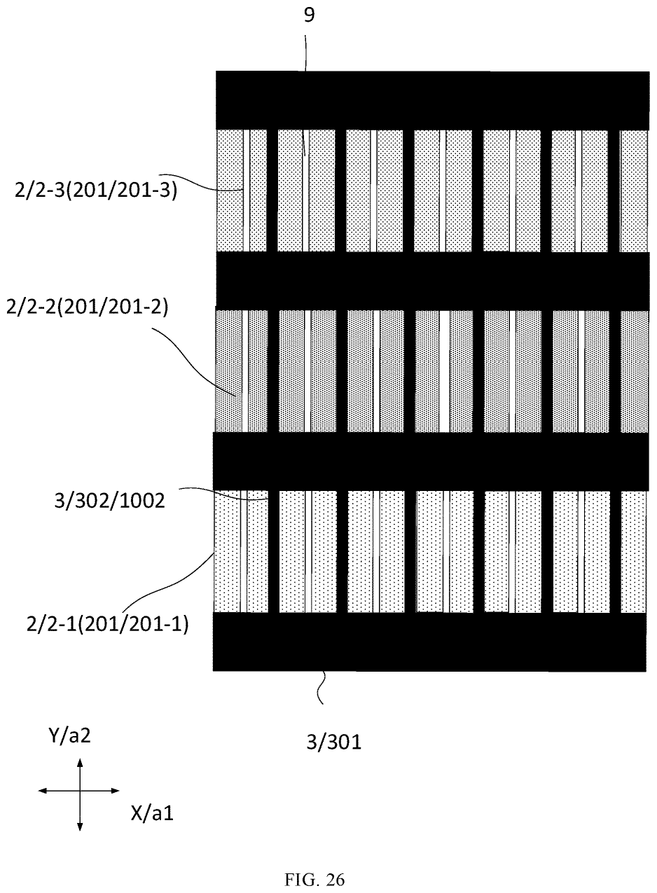

It should be noted that FIGS. 16 to 24 illustrate an example in which each sub-pixel is non-rectangular and includes a pair of sides not perpendicular to the first direction a1. Alternatively, in some embodiments, as shown in FIGS. 25 and 26, each sub-pixel 201 includes the pair of first sides 5 extending perpendicular to the first direction a1, and the extending direction of each second light shielding portion 302 is perpendicular to the first direction a1, i.e., θ2=θ3=0°.

In some embodiments, the first direction a1 is the vertical direction Y as shown in FIG. 25. Specifically, the number of the scan lines is half of the number of the sub-pixels included in each pixel bar, and each scan line corresponds to two rows of sub-pixels.

In some embodiments, the first direction a1 is the horizontal direction X as shown in FIG. 26. Specifically, the number of the data lines is half of the number of the sub-pixels included in each pixel bar, and each data line corresponds to two columns of sub-pixels.

In some embodiments, in a case of θ2=θ3=0°, the third direction is perpendicular to the first direction.

Alternatively, in some embodiments, in the case of θ2=θ3=0°, the included angle between the third direction and the first direction may be greater than 0° and less than 90°.

In some embodiments, the sub-pixels in each pixel bar uniformly emit light in a direction intersecting with the sub-pixels, thereby preventing the Moire fringes from occurring, and improving the display effect.

However, in a specific implementation, the sub-pixels in each pixel bar may emit light non-uniformly in the direction intersecting with the sub-pixels. In this case, if one ends of the pixel bars are positioned on a same straight line, the Moire fringes are easy to occur, which deteriorates the display effect.

In some embodiments, the sub-pixels in each pixel bar emit light non-uniformly in the direction intersecting with the sub-pixels,

$$0.9 \times \frac{j \times P 2}{P 1} \leq \vert tan θ 1 \vert \leq 1.1 \times \frac{j \times P 2}{P 1} ,$$

and θ1=θ2; further, a line connecting the one ends of the plurality pixel bars included in the display panel together is not a straight line. Such arrangements are beneficial to mitigating or even eliminating the Moire fringes.

In some embodiments, a line connecting the one ends of any adjacent two of the pixel bars together is located on a straight line different from the normal line of the first direction. That is, any adjacent two of the pixel bars have a displacement relative to each other in the first direction, which can periodically compensate brightness uniformity of the sub-pixels, and is beneficial to mitigating or even eliminating the Moire fringes.

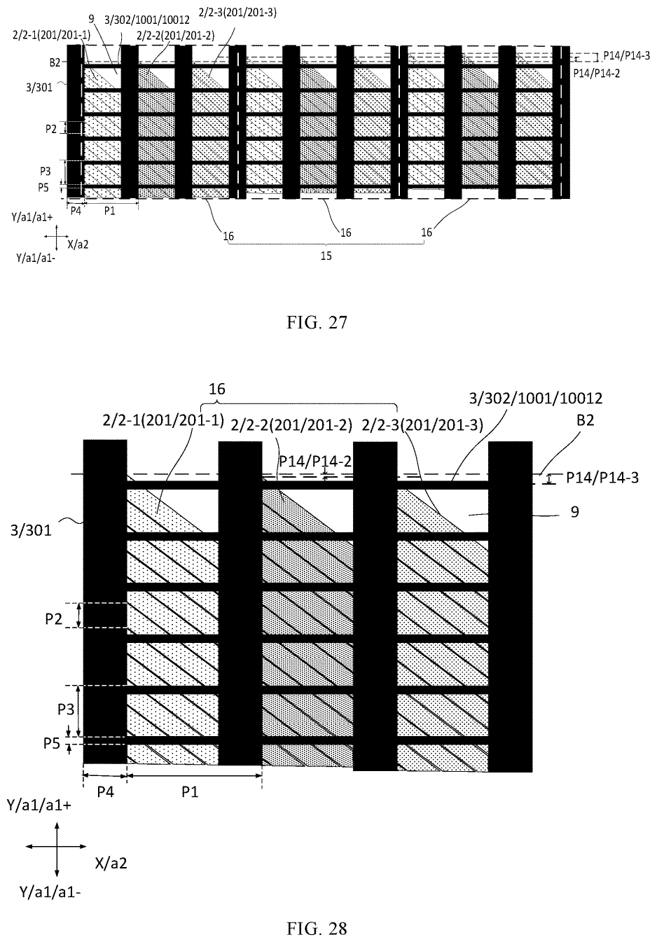

In some embodiments, as shown in FIG. 27, the plurality of pixel bars 2 are divided into a plurality of compensation groups 15; each compensation group 15 includes N repetition units 16, and each repetition unit 16 includes a plurality of pixel bars 2 emitting light of different colors.

In the first direction a1, a ratio Vk of a distance P14 between a start point of the first sub-pixel 201 in each pixel bar in each repetition unit 16 and a preset start point B2 to the period P2 in which the sub-pixels 201 are arranged satisfies

$$Vk = \pm C \frac{E}{N} ,$$

where k is an integer greater than or equal to 1 and less than or equal to N, C is an integer greater than 0, and E is an integer greater than or equal to 0 and less than N.

It should be noted that in a case where Vk is not 0 and

$$\pm C \frac{E}{N}$$

is + (i.e., positive), it represents that the start point of the first sub-pixel 201 in each pixel bar has a displacement relative to the preset start point B2 in the positive direction of the first direction; in a case where Vk is not 0 and

$$\pm C \frac{E}{N}$$

is − (I.e., negative), it represents that the start point of the first sub-pixel 201 in each pixel bar has a displacement relative to the preset start point B2 in the negative direction of the first direction. In FIG. 27, the upward direction is taken as the positive direction a1+ of the first direction a1, and the downward direction is taken the negative direction a1− of the first direction a1.

In some embodiments, the preset start point B2 is the start point of the first sub-pixel 201 in each pixel bar with Vk=0.

In some embodiments, C=1; in each compensation group 15, a plurality of values of Vk corresponding to the N repetition units 16 form an arithmetic progression (i.e., an arithmetic sequence), and the arithmetic progression has a common difference of 1/N.

In the display device according to the present embodiment, the repetition units arranged periodically are divided into the plurality of compensation groups; in each compensation group, the ratio of the distance between the start point of the first sub-pixel in each pixel bar and the preset start point to the period in which the sub-pixels are arranged is Vk; and the plurality of values of Vk corresponding to the N repetition units form the arithmetic progression; so that in each compensation group, any adjacent two of the pixel bars have a displacement relative to each other in the first direction, which can perform periodic compensation on the brightness uniformity of the sub-pixels, and is beneficial to mitigating or even eliminating the Moire fringes.

Specifically, in a case of C=1, Vk takes one of the following values: −(N−1)/N, −(N−2)/N, . . . , −1/N, 0, 1/N, . . . , (N−2)/N, or (N−1)/N.

In some embodiments, as shown in FIG. 27, N=3, i.e. each compensation group 15 includes 3 repetition units 16. Vk takes one of the following values: −2/3, −1/3, 0, 1/3, or 2/3. The arithmetic progression formed by V1, V2, and V3 corresponding to 3 repetition units 16 may be any one of the following: (−2/3, −1/3, 0), (−1/3, 0, 1/3), or (0, 1/3, 2/3).

It should be noted that k does not necessarily represent an arrangement sequence number of the repetition units in each compensation group in the second direction, as long as the values of Vk corresponding to the repetition units in each compensation group satisfy the above requirement for the arithmetic progression, where N values of the arithmetic progression may be arbitrarily allocated to N repetition units in each compensation group. Taking N=3 as an example, the values of Vk corresponding to 3 repetition units may be allocated in 6 manners, which may be: Vk=V1 for the pixel bars in a first repetition unit, Vk=V2 for the pixel bars in a second repetition unit, and Vk=V3 for the pixel bars in a third repetition unit; or, Vk=V1 for the pixel bars in the first repetition unit, Vk=V3 for the pixel bars in the second repetition unit, and Vk=V2 for the pixel bars in the third repetition unit; or, Vk=V2 for the pixel bars in the first repetition unit, Vk=V1 for the pixel bars in the second repetition unit, and Vk=V3 for the pixel bars in the third repetition unit; or, Vk=V2 for the pixel bars in the first repetition unit, Vk=V3 for the pixel bars in the second repetition unit, and Vk=V1 for the pixel bars in the third repetition unit; or, Vk=V3 for the pixel bars in the first repetition unit, Vk=V2 for the pixel bars in the second repetition unit, and Vk=V1 for the pixel bars in the third repetition unit; or, Vk=V3 for the pixel bars in the first repetition unit, Vk=V1 for the pixel bars in the second repetition unit, and Vk=V2 for the pixel bars in the third repetition unit.

In some embodiments, in each compensation group 15 as shown in FIG. 27, in the first direction a1, the distance P14 between the start point of the first sub-pixel 201 of each pixel bar in the first repetition unit 16 and the preset start point B2 satisfies P14-0, the distance P14-2 between the start point of the first sub-pixel 201 of each pixel bar in the second repetition unit 16 and the preset start point B2 is greater than 0, the distance P14-3 between the start point of the first sub-pixel 201 of each pixel bar in the third repetition unit 16 and the preset start point B2 is also greater than 0, and P14-3 is greater than P14-2. The values of Vk corresponding to the three repetition units are (0, 1/3, 2/3).

In some embodiments, the sub-pixels 201 in each pixel bar 2 emit light non-uniformly in the direction intersecting with the sub-pixels 201,

$$\vert tan θ 1 \vert > 1.1 \times \frac{j \times P 2}{P 1} or \vert tan θ 1 \vert < 0.9 \times \frac{j \times P 2}{P 1} ,$$

and θ1=θ2.

To mitigate or even eliminate the Moire fringes, the included angle θ1 between the third direction a3 and the direction of the normal line 6 of the first direction a1 satisfies:

$$0.9 \times \frac{( 3 j \pm \frac{1}{Q} ) \times P 2}{3 P 1} \leq \vert tan θ 1 \vert \leq 1.1 \times \frac{( 3 j \pm \frac{1}{Q} ) \times P 2}{3 P 1} ;$$

where Q is an integer greater than or equal to 2.

In some embodiments,

$$\vert tan θ 1 \vert = \frac{( 3 j \pm \frac{1}{Q} ) \times P 2}{3 P 1} .$$

It should be noted that during a manufacturing process of the display panel, factors such as process errors may occur, resulting in a situation of

$$\vert tan θ 1 \vert \neq \frac{( 3 j \pm \frac{1}{Q} ) \times P 2}{3 P 1} .$$

Within a reasonable process tolerance range, θ1 satisfies

$$0.9 \times \frac{( 3 j \pm \frac{1}{Q} ) \times P 2}{3 P 1} \leq \vert tan θ 1 \vert \leq 1.1 \times \frac{( 3 j \pm \frac{1}{Q} ) \times P 2}{3 P 1} ,$$

which can still mitigate or even eliminate the Moire fringes.

In some embodiments, to further eliminate the Moire fringes, while θ1 satisfies

$$0.9 \times \frac{( 3 j \pm \frac{1}{Q} ) \times P 2}{3 P 1} \leq \vert tan θ 1 \vert \leq 1.1 \times \frac{( 3 j \pm \frac{1}{Q} ) \times P 2}{3 P 1} ,$$

it can also be arranged so that within each light splitting structure, the number of entire second light shielding portions 302 passing through any first preset length line segment L1 in the third direction a3 is equal.

In some embodiments, to avoid color separation, while θ1 satisfies

$$\vert tan θ 1 \vert = \frac{( 3 j \pm \frac{1}{Q} ) \times P 2}{3 P 1} ,$$

it can also be arranged so that the center of a first sub-pixel, the center of a respective second sub-pixel, and the center of a respective third sub-pixel are located on a same straight line in the third direction a3. That is, any straight line along the third direction a3 passes through the center of the first sub-pixel, the center of the respective second sub-pixel, and the center of the respective third sub-pixel.

In some embodiments, as shown in FIG. 28, in the first direction a1, a ratio Vk of the distance P14 between the start point of the first sub-pixel 201 in each pixel bar 2 and the preset start point B2 and the period P2 in which the sub-pixels 201 are arranged satisfies

$$Vk = \pm C \frac{E}{3 Q} ,$$

where k is an integer greater than or equal to 1 and less than or equal to 3, C is an integer greater than 0, and E is an integer greater than or equal to 0 and less than 3.

As such, it can be ensured that the center of a first sub-pixel, the center of a respective second sub-pixel, and the center of a respective third sub-pixel are located on a same straight line in the third direction, thereby avoiding color separation among different sub-pixels in the 3D display mode.

It should be noted that in a case where Vk is not 0 and

$$\pm C \frac{E}{3 Q}$$

is + (i.e., positive), it represents that the start point of the first sub-pixel 201 in each pixel bar has a displacement relative to the preset start point B2 in the positive direction of the first direction; in a case where Vk is not 0 and

$$\pm C \frac{E}{3 Q}$$

is − (i.e., negative), it represents that the start point of the first sub-pixel 201 in each pixel bar has a displacement relative to the preset start point B2 in the negative direction of the first direction. In FIG. 28, the upward direction is taken as the positive direction a1+ of the first direction a1, and the downward direction is taken as the negative direction a1− of the first direction a1.

In some embodiments, the preset start point B2 is the start point of the first sub-pixel 201 in each pixel bar with Vk=0.

In some embodiments, C=1; in each repetition unit 16, the values of Vk corresponding to 3 pixel bars 2 form an arithmetic progression having a common difference of

$$\frac{1}{3 Q} .$$

In the display device according to the present embodiment, it is equivalent to taking each repetition unit as one compensation group; within each repetition unit, the ratio of the distance between the start point of the first sub-pixel in each pixel bar and the preset start point to the period in which the sub-pixels are arranged is Vk, and the values of Vk corresponding to 3 pixel bars in each repetition unit form an arithmetic progression, so that within each repetition unit, any adjacent two of the pixel bars have a displacement relative to each other in the first direction, which can perform periodic compensation on the brightness uniformity of the sub-pixels, and are beneficial to mitigating or even eliminating the Moire fringes.

Specifically, in a case of C=1, Vk takes one of the following values: −(2)/3Q, −(1)/3Q, 0, 1/3Q, . . . , or 2/3Q.

In some embodiments, Q=3. Vk takes one of the following values: −2/9, −1/9, 0, 1/9, or 2/9. An arithmetic progression formed by V1, V2, and V3 corresponding to 3 pixel bars may be any one of the following: (−2/9, −1/9, 0), (−1/9, 0, 1/9), or (0, 1/9, 2/9).

It should be noted that k does not necessarily represent an arrangement sequence number of the pixel bars in each repetition unit in the second direction, as long as the values of Vk corresponding to the pixel bars in each repetition unit satisfy the above requirement for the arithmetic progression, where the 3 values of the arithmetic progression may be arbitrarily allocated to the 3 pixel bars in each repetition unit. Taking Q=3 as an example, the values of Vk corresponding to the 3 pixel bars may be allocated in 6 manners, which may be: Vk=V1 for the pixel bars in a first repetition unit, Vk=V2 for the pixel bars in a second repetition unit, and Vk=V3 for the pixel bars in a third repetition unit; or, Vk=V1 for the pixel bars in the first repetition unit, Vk=V3 for the pixel bars in the second repetition unit, and Vk=V2 for the pixel bars in the third repetition unit; or, Vk=V2 for the pixel bars in the first repetition unit, Vk=V1 for the pixel bars in the second repetition unit, and Vk=V3 for the pixel bars in the third repetition unit; or, Vk=V2 for the pixel bars in the first repetition unit, Vk=V3 for the pixel bars in the second repetition unit, and Vk=V1 for the pixel bars in the third repetition unit; or, Vk=V3 for the pixel bars in the first repetition unit, Vk=V2 for the pixel bars in the second repetition unit, and Vk=V1 for the pixel bars in the third repetition unit; or, Vk=V3 for the pixel bars in the first repetition unit, Vk=V1 for the pixel bars in the second repetition unit, and Vk=V2 for the pixel bars in the third repetition unit.

In some embodiments, in each repetition unit 16 as shown in FIG. 28, in the first direction a1, the distance P14 between the start point of the first sub-pixel 201 in the first pixel bar and the preset start point B2 satisfies P14=0, the distance P14-2 between the start point of the first sub-pixel 201 in the second pixel bar and the preset start point B2 is greater than 0, the distance P14-3 between the start point of the first sub-pixel 201 in the third pixel bar and the preset start point B2 is also greater than 0, and P14-3 is greater than P14-2. The values of Vk corresponding to the three pixel bars are (0, −1/9, −2/9).

In some embodiments, to further eliminate the Moire fringes, while

$$V k = \pm C \frac{E}{3 Q} ,$$

it may also be arranged so that within each light splitting structure, the number of entire second light shielding portions passing through any first preset length line segment L1 in the third direction a3 is equal.

Alternatively, in some embodiments, the sub-pixels 201 in each pixel bar 2 emit light non-uniformly in the direction intersecting with the sub-pixels 201,

$$0.9 \times \frac{j \times P 2}{P 1} \leq \vert tan θ 1 \vert \leq 1.1 \times \frac{j \times P 2}{P 1} ,$$

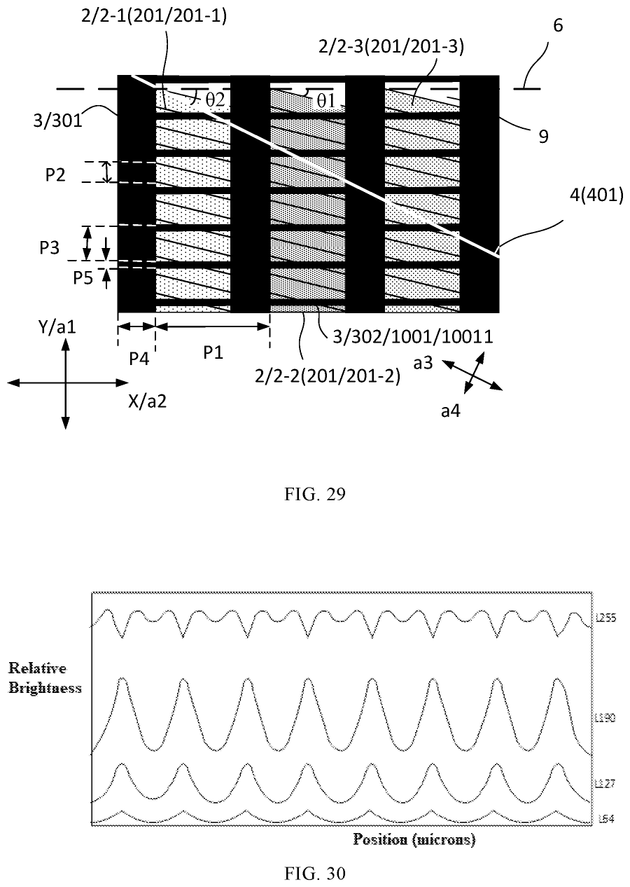

and θ2+θ1, as shown in FIG. 29.

In order to mitigate or even eliminate the Moire fringes, the included angle θ1 between the third direction a3 and the direction of the normal line 6 of the first direction a1, and the included angle θ2 between each first side 5 and the direction of the normal line 6 of the first direction a1 satisfy:

$$0.9 \times P 2 \leq P 1 \times ( \vert tan θ 1 \vert - \vert tan θ 2 \vert ) \leq 1.1 \times P 2 .$$

In some embodiments, P1×(|tan θ1|−|tan θ2|)=P2.

It should be noted that during a manufacturing process of the display panel, factors such as process errors may occur, resulting in a situation of P1×(|tan θ1|−|tan θ2|)=P2. Within a reasonable process tolerance range, θ2 satisfies: 0.9×P2≤P1×(|tan θ1|−| tan θ2|)≤1.1×P2, which can still mitigate or even eliminate the Moire fringes.

In some embodiments, to further eliminate the Moire fringes, while ensuring 0.9×P2≤P1×(|tan θ1|−|tan θ2|)≤1.1×P2, it can also be arranged so that within each light splitting structure, the number of entire second light shielding portions passing through any first preset length line segment L1 in the third direction a3 is equal.

The following example explains how the cases where P1×(|tan θ1|−|tan θ2|)=P2 and the number of entire second light shielding portions passing through any first preset length line segment L1 in the third direction a3 is equal within each light splitting structure can significantly mitigate the Moire fringes. Since the number of entire second light shielding sections passing through any first preset length line segment L1 in the third direction a3 is equal within each light splitting structure, and

$$\vert tan θ 1 \vert = \frac{i \times P 3}{P 1 - P 4} ,$$

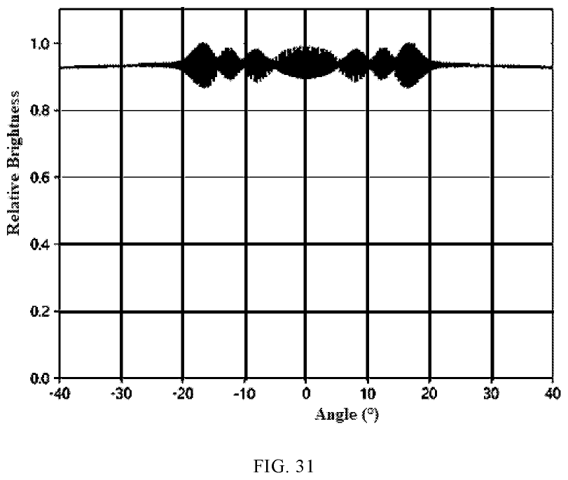

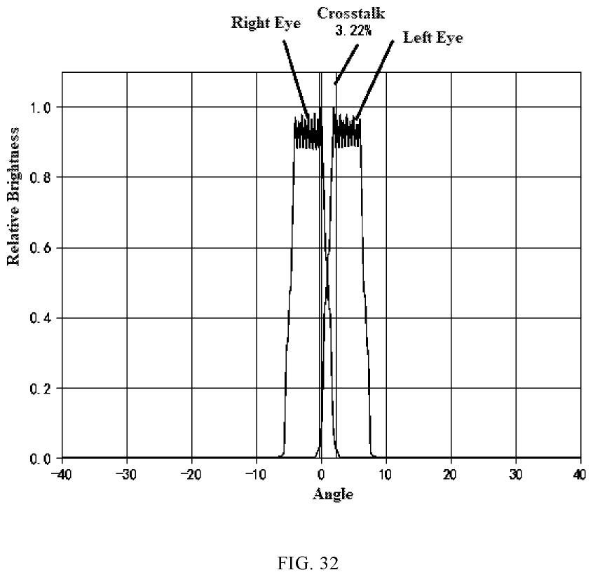

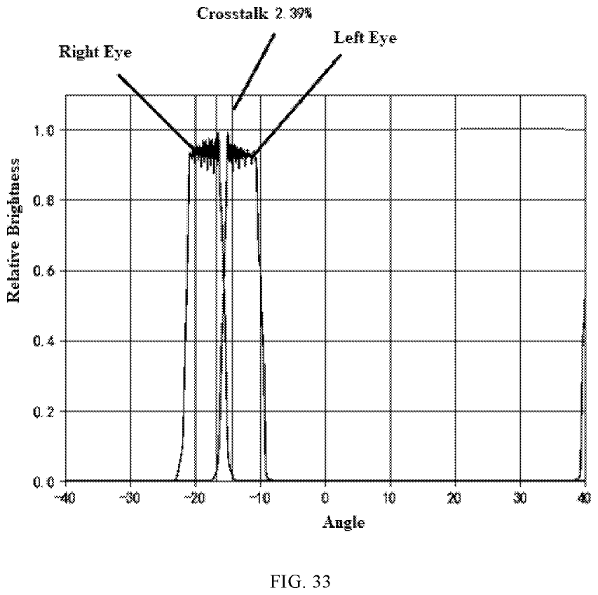

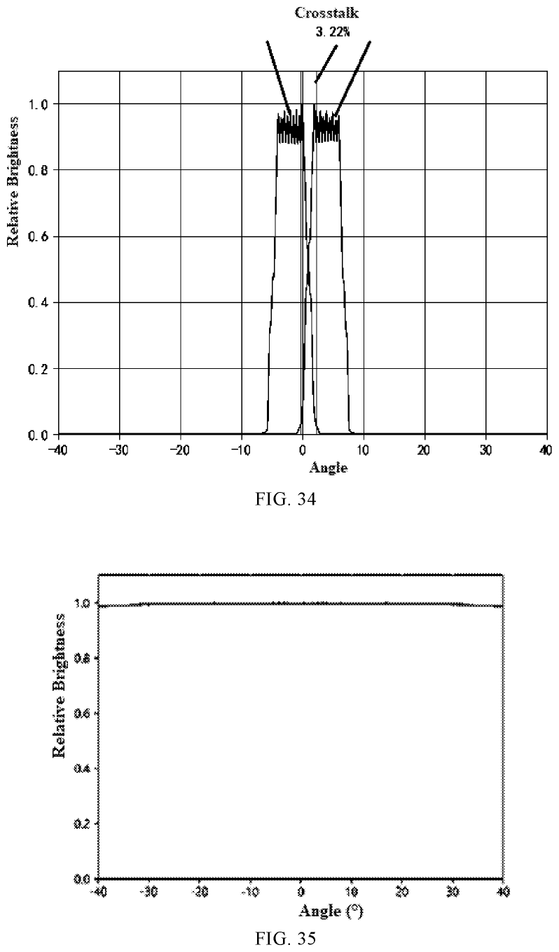

the sub-pixels emit light non-uniformly, and the morphology of emitted light is shown in FIG. 30. An angular spectrum obtained with all pixels being turned on is shown in FIG. 31. Calculations show that at a viewing distance of 1.5 meters, with an angular brightness integral scan comparison based on a pupil diameter of 4 mm, the Moire fringes account for 6.22%. Based on the display device, the pixels for the left eye and the pixels for the right eye are turned on separately, resulting in a left eye angular spectrogram and a right eye angular spectrogram at a 0° viewing angle as shown in FIG. 32, a left eye angular spectrogram and a right eye angular spectrogram at a 15° viewing angle as shown in FIG. 33, and a left eye angular spectrogram and a right eye angular spectrogram at a 28° viewing angle as shown in FIG. 34; calculations of a crosstalk between the left and right eyes based on an interpupillary distance of 65 mm result in the following crosstalk values: 3.22% at the 0° viewing angle, 2.39% at the 15° viewing angle, and 22.43% at the 28° viewing angle. A low-crosstalk 3D display effect is achieved, but the Moire fringes are relatively severe. A case where P1×(|tan θ1|−|tan θ2|)=P2 and where the number of entire second light shielding portions passing through any first preset length line segment L1 in the third direction a3 is equal within each light splitting structure results in an angular spectrogram with all pixels being turned on as shown in FIG. 35. Calculations show that at the viewing distance of 1.5 meters and with the angular brightness integral scan comparison based on the pupil diameter of 4 mm, the Moire fringes account for 0.23%, thereby achieving a 3D display effect with a low crosstalk and few Moire fringes. Further, as can be seen from FIGS. 31 to 34, an angle without repeated viewpoints is 56°; therefore, the display device according to the present embodiment can also allow multiple persons to watch the display device at the same time, and the multiple persons see different 3D display contents.

In some embodiments, as shown in FIG. 14, the display panel 01 further includes: a plurality of first spacers 104 located between the array substrate 101 and the opposite substrate 102.

Specifically, each first spacer may be a main spacer, and the display panel may further include a plurality of auxiliary spacers located between the array substrate and the opposite substrate. A thickness of each auxiliary spacer is less than a thickness of each main spacer.

In some embodiments, an area of a pattern formed by the orthogonal projections of the first light shielding portions and the second light shielding portions on the display panel is a first area, and an area of a pattern formed by the orthogonal projections of the first light shielding portions, the second light shielding portions, and the opening regions on the display panel is a second area.

A ratio of the first area to the second area is

$$\frac{Z 1}{Z 2} ,$$

less where Z1 is than Z2,

$$\frac{Z 1}{Z 2}$$

is a rational number, Z1 is an integer, and Z2 is an integer greater than or equal to 2.

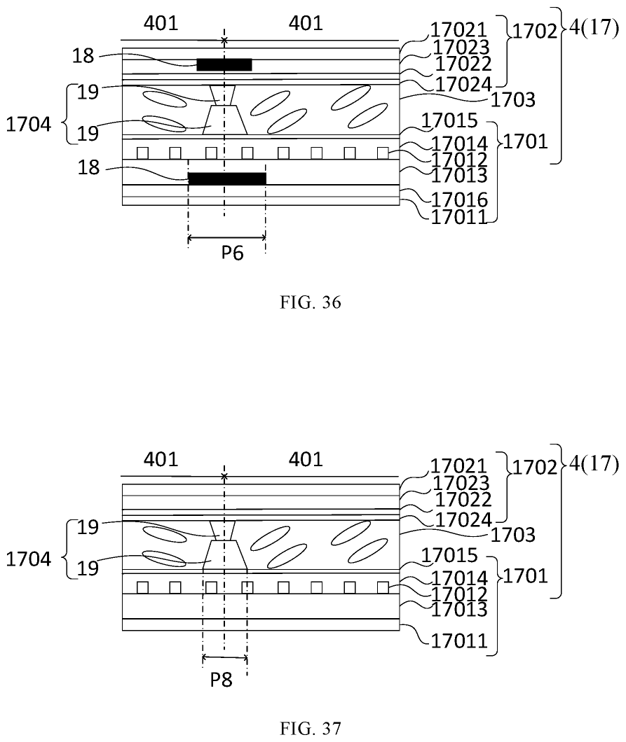

In some embodiments, in a case where each light splitting assembly includes a liquid crystal cylindrical lens array as shown, for example, in FIGS. 36 and 37, the light splitting assembly 02 is a liquid crystal cell 17. The liquid crystal cell 17 includes: a first substrate 1701 and a second substrate 1702 which are arranged opposite to each other, and a second liquid crystal layer 1703 located between the first substrate 1701 and the second substrate 1702. The second substrate 1702 is located on a side of the first substrate 1701 distal to the display panel (not shown).

In some embodiments, as shown in FIGS. 36 and 37, the first substrate 1701 includes: a third base substrate 17011, a first electrode 17012, a second insulating layer 17013 located between the first electrode 17012 and the third base substrate 17011, a third insulating layer 17014 located on a side of the first electrode 17012 distal to the third base substrate 17011, and a first alignment layer 17015 located on a side of the third insulating layer 17014 distal to the third base substrate 17011.

The second substrate 1702 includes: a fourth base substrate 17021, a second electrode 17022, a fourth insulating layer 17023 located between the second electrode 17022 and the fourth base substrate 17021, and a second alignment layer 17024 located on a side of the second electrode 17022 distal to the fourth base substrate 17021.

An orthogonal projection of the first electrode 17012 on the fourth base substrate 17021 intersects with an orthogonal projection of the second electrode 17022 on the fourth base substrate 17021.

In some embodiments, as shown in FIG. 36, the second substrate 1702 and/or the first substrate 1701 includes a plurality of fourth light shielding portions 18. An orthogonal projection of each fourth light shielding portion 18 on the second substrate 1702 overlaps with an orthogonal projection of a region between adjacent two of the light splitting structures 401 on the second substrate 1702. In the horizontal direction X or the vertical direction Y, a width P6 of each fourth light shielding portion 18 and a width P7 of each first spacer (not shown in this figure) satisfy: Z3×P6=Z4×P7, where Z3 and Z4 are integers and are coprime, and Z3=Z2.

In some embodiments, as shown in FIG. 36, the liquid crystal cell 17 further includes a plurality of second spacers 1704 positioned between the first substrate 1701 and the second substrate 1702.

In a specific implementation, an orthogonal projection of each second spacer on the display panel falls into an orthogonal projection of a respective fourth light shielding portion on the display panel. The orthogonal projections of the fourth light shielding portions and the second spacers on the display panel fall into the orthogonal projection of the light shielding layer on the display panel.

In some embodiments, as shown in FIG. 36, each of the second substrate 1702 and the first substrate 1701 includes a plurality of fourth light shielding portions 18.

In the display device according to the present embodiment, in the case where P6 and P7 satisfy: Z3×P6=Z4×P7, it is possible to avoid the Moire fringes generated by interference between the fourth light shielding portions in the light splitting assembly and the display panel, thereby improving the display effect.

In some embodiments, as shown in FIG. 36, in the first substrate 1701, the fourth light shielding portions 18 are located between the second insulating layer 17013 and the third base substrate 17011, and the first substrate 1701 further includes a fifth insulating layer 17016 located between each fourth light shielding portion 18 and the third base substrate 17011.

In the second substrate 1702, the fourth light shielding portions 18 are located between the fourth base substrate 17021 and the fourth insulating layer 17023.

Alternatively, in some embodiments, the liquid crystal cell 17 does not include the fourth light shielding portions. As shown in FIG. 37, the liquid crystal cell 17 further includes the plurality of second spacers 1704 located between the first substrate 1702 and the second substrate 1702. In the horizontal direction X or the vertical direction Y, a width P8 of each second spacer 1704 and the width P7 of each first spacer (not shown in this figure) satisfy: Z3×P8=Z4×P7, where Z3 and Z4 are integers and are coprime, and Z3=Z2.

In a specific implementation, orthogonal projections of the second spacers on the display panel falls into the orthogonal projection of the light shielding layer on the display panel.

In the display device according to the present embodiment, in the case where P8 and P7 satisfy: Z3×P8=Z4×P7, it is possible to avoid the Moire fringes generated by interference between the fourth light shielding portions in the light splitting assembly and the display panel, thereby improving the display effect.

In some embodiments, Z4=3m±1, where m is an integer greater than or equal to 1, thereby eliminating a local rainbow pattern and further improving the display effect.

Specifically, the second spacers may be main spacers, and the light splitting assembly may further include a plurality of auxiliary spacers located between the first substrate and the second substrate, where a thickness of each auxiliary spacer is less than a thickness of each main spacer.

In some embodiments, each first spacer may be disposed on the array substrate, or may be disposed on the opposite substrate. Alternatively, each first spacer may include two sub-spacers, which are respectively disposed on the array substrate and the opposite substrate, and are opposite to and in contact with each other to form the entire (i.e., complete) first spacer.

In some embodiments, each second spacer may be disposed on the first substrate, or may be disposed on the second substrate. Alternatively, in some embodiments, as shown in FIGS. 36 and 37, each second spacer includes two sub-spacers 19, which are respectively located on the first substrate 1701 and the second substrate 1702, and are opposite to and in contact with each other to form the entire (i.e., complete) second spacer 1704.

In some embodiments, the two sub-spacers which are opposite to and in contact with each other may intersect with each other to form a cross shape.

In some embodiments, the two sub-spacers which are opposite to and in contact with each other may have a same width or different widths in the horizontal direction or a predetermined vertical direction. In the case where the two sub-spacers which are opposite to and in contact with each other have different widths in the horizontal direction or the predetermined vertical direction, the maximum width of any one of the two sub-spacers in the horizontal direction or the predetermined vertical direction is a width of each first spacer or each second spacer in the horizontal direction or the predetermined vertical direction.

In some embodiments, for example, each of the first electrode and the second electrode may have a shape of a strip. The first substrate includes a plurality of first electrodes, and the second substrate includes a plurality of second electrodes. Alternatively, the second electrode may be a planar electrode (i.e., a plate-shaped electrode), and the first substrate may include a plurality of first electrodes.

In some embodiments, an extending direction of each first electrode may be the same as the extending direction of each light splitting structure (i.e., each first electrode may extend in a direction in which each light splitting structure extends).

In some embodiments, each first electrode and each second electrode are both transparent electrodes, which are made of, for example, indium tin oxide.

In some embodiments, in the display panel, the pixel electrode and the common electrode are also transparent electrodes, which are made of, for example, indium tin oxide.

The display device according to any one of the foregoing embodiments of the present disclosure may be any product or component with a display function, such as a mobile phone, a tablet computer, a television, a display, a notebook computer, a digital photo frame, a navigator, or the like. Other essential components of the display device are understood by one of ordinary skill in the art, and are not described herein nor should they be construed as limiting the present disclosure.

In summary, in the display device according to any one of the foregoing embodiments of the present disclosure, the number of the opening regions is less than the number of the sub-pixels, and at least in one direction, the number of the opening regions corresponding to each pixel bar is less than the number of the sub-pixels included in the pixel bar. Since the signal lines are located in the light shielding regions, and the number of signal lines corresponding to each pixel bar is less than the number of sub-pixels included in the pixel bar at least in one direction, the number of signal lines can be reduced. Further, the signal lines are usually required to be electrically connected to the binding pins, and accordingly, the number of the binding pins can be reduced, thereby saving the cost thereof and simplifying wiring difficulty.

Although preferred embodiments of the present disclosure have been described, additional variations and modifications in these embodiments may be made by one of ordinary skill in the art once he/she learn of the basic inventive concepts. Therefore, it is intended that the appended claims be interpreted as including the preferred embodiments and all variations and modifications that fall within the scope of the present disclosure.

It will be apparent to one of ordinary skill in the art that various modifications and variations may be made in the foregoing embodiments of the present disclosure without departing from the spirit or scope of these embodiments of the present disclosure. Thus, if such modifications and variations of these embodiments of the present disclosure fall within the scope of the claims of the present disclosure and their equivalents, the present disclosure is also intended to encompass these modifications and variations.

What is claimed is:

1. A display device, comprising:
a display panel, comprising a plurality of pixel repetition units arranged in an array along a first direction and a second direction, wherein each of the pixel repetition units comprises a plurality of pixel islands arranged consecutively in the second direction, each of the pixel islands comprises a plurality of sub-pixels arranged to be spaced apart from each other in the first direction, the plurality of pixel repetition units comprise a plurality of pixel repetition unit rows arranged in the second direction, and the sub-pixels in one pixel repetition unit row of a pair of adjacent two pixel repetition unit rows of at least some of pairs of adjacent two pixel repetition unit rows are staggered relative to the sub-pixels in the other pixel repetition unit row of the pair of adjacent two pixel repetition unit rows in the first direction; and
a light splitting assembly, positioned on a display side of the display panel and comprising M light splitting structures which extend in a third direction and are arranged in a fourth direction, wherein the third direction intersects with the fourth direction, an included angle θ1 between the third direction and a direction of a normal line of the first direction is greater than or equal to 0° and less than or equal to 90°, and the light splitting assembly corresponds to N columns of the sub-pixels in each pixel repetition unit row, where each of M and N is an integer greater than 1, and M is coprime with N;
wherein a lengthwise direction of each sub-pixel is neither parallel nor perpendicular to the second direction.

2. The display device according to claim 1, wherein the display panel further comprises a display region and a plurality of light shielding portions;
the first direction intersects with the second direction, an orthogonal projection of the plurality of light shielding portions on the display panel comprises in the display region: a plurality of opening regions arranged in an array, and light shielding regions located between the opening regions; and
the plurality of light shielding portions comprise: a plurality of first light shielding portions extending in the first direction, and a plurality of second light shielding portions extending in a direction intersecting with the first direction.

3. The display device according to claim 2, wherein a column of sub-pixels arranged in the second direction forms a pixel bar; and
orthogonal projections of at least some of the first light shielding portions on the display panel respectively overlap with orthogonal projections of regions between pixel bars adjacent to the at least some of the first light shielding portions on the display panel, and orthogonal projections of at least some of the second light shielding portions on the display panel respectively overlap with orthogonal projections of the pixel bars on the display panel.

4. The display device according to claim 3, wherein the display panel is a liquid crystal display panel, the liquid crystal display panel comprising:
an array substrate comprising the pixel bars, a plurality of first signal lines, and a plurality of second signal lines; orthogonal projections of the first signal lines on the display panel and orthogonal projections of the second signal lines on the display panel fall into the light shielding regions; at least some of the first signal lines and at least some of the second signal lines are electrically connected to the pixel bars; the plurality of first signal lines extend along a horizontal direction, and the plurality of second signal lines extend along a vertical direction; the horizontal direction is perpendicular to the vertical direction, and the first direction is the horizontal direction or the vertical direction; and the first signal lines or the second signal lines also serve as the second light shielding portions;
an opposite substrate arranged opposite to the array substrate and comprising the first light shielding portions; and
a first liquid crystal layer positioned between the array substrate and the opposite substrate.

5. The display device according to claim 4, wherein the sub-pixels comprise pixel electrodes, orthogonal projections of the opening regions on the display panel overlap with orthogonal projections of the pixel electrodes on the display panel; and
a number of the second light shielding portions is less than a number of the pixel electrodes comprised in each pixel bar.

6. The display device according to claim 4, wherein each sub-pixel comprises a pair of first sides extending in a direction intersecting with the first direction, an included angle θ2 between each first side and the direction of the normal line of the first direction is greater than 0° and less than 90°, and an included angle between an extending direction of each second light shielding portion and each first side is greater than 0°; and
orthogonal projections of the second light shielding portions on the display panel overlap with orthogonal projections of the sub-pixels on the display panel.

7. The display device according to claim 6, wherein the pixel electrodes comprised in the sub-pixels and the first sides extend in a same direction, and orthogonal projections of the pixel electrodes on the display panel overlap with the orthogonal projections of the second light shielding portions on the display panel.

8. The display device according to claim 6, wherein the included angle θ1 between the third direction and the direction of the normal line of the first direction satisfies:
$$0.9 \times \frac{j \times P 2}{P 1} \leq \vert tan θ 1 \vert \leq 1.1 \times \frac{j \times P 2}{P 1} ,$$
where P1 is a period in which the pixel bars are arranged, P2 is a period in which the sub-pixels in each pixel bar are arranged in the first direction, and j is an integer greater than or equal to 0.

9. The display device according to claim 6, wherein a total length of a region where a first preset length line segment overlaps with each second light shielding portion in the third direction is a first length; within each light splitting structure, first lengths corresponding to any first preset length line segment are equal to each other; and
the first preset length line segment extends along the third direction, and a length of a projection of the first preset length line segment on the direction of the normal line of the first direction is a difference between P1 and P4, where P1 is a period in which the pixel bars are arranged, and P4 is a width of each first light shielding portion in a direction perpendicular to the first direction.

10. The display device according to claim 9, wherein the included angle θ1 between the third direction and the direction of the normal line of the first direction satisfies:
$$0.9 \times \frac{i \times P 3}{P 1 - P 4} \leq \vert tan θ 1 \vert \leq 1.1 \times \frac{i \times P 3}{P 1 - P 4} ,$$
where P3 is a period in which the second light shielding portions are arranged in the first direction, a length of each second light shielding portion in the third direction is a second length, and i is a value obtained by rounding a ratio of the first length to the second length.

11. The display device according to claim 8, wherein the extending direction of each second light shielding portion is perpendicular to the first direction.

12. The display device according to claim 9, wherein an included angle θ3 between the extending direction of each second light shielding portion and the direction of the normal line of the first direction is greater than 0° and less than 90°.

13. The display device according to claim 12, wherein the included angle θ1 between the third direction and the direction of the normal line of the first direction satisfies:
$$\vert tan θ 1 \vert > 1.1 \times \frac{i \times P 3}{P 1 - P 4} or \vert tan θ 1 \vert < 0.9 \times \frac{i \times P 3}{P 1 - P 4} ; and$$
$$0.9 \times \frac{i \times P 3 - ( P 1 - P 4 ) \times tan θ 3}{P 1 - P 4} \leq \vert tan θ 1 \vert \leq 1.1 \times \frac{i \times P 3 - ( P 1 - P 4 ) \times tan θ 3}{P 1 - P 4} ;$$
where P3 is a period in which the second light shielding portions are arranged in the first direction, θ3 is the included angle between the extending direction of each second light shielding portion and the direction of the normal line of the first direction, a length of each second light shielding portion in the third direction is a second length, and i is a value obtained by rounding a ratio of the first length to the second length.

14. The display device according to claim 6, wherein the extending direction of each second light shielding portion is perpendicular to the first direction, the plurality of light shielding portions further comprise a plurality of third light shielding portions, each third light shielding portion comprises at least one light shielding sub-portion, and each light shielding sub-portion comprises a first portion;
an orthogonal projection of each first portion on the display panel does not overlap with the orthogonal projection of each of a respective first light shielding portion and a respective second light shielding portion on the display panel, and the orthogonal projection of each first portion on the display panel is adjacent to the orthogonal projection of the respective first light shielding portion or the respective second light shielding portion on the display panel;
a total length of a region where a first preset length line segment overlaps with each second light shielding portion in the third direction is a first length, a total length of a region where the first preset length line segment overlaps with each first portion of each third light shielding portion in the third direction is a third length, the third length is greater than or equal to 0; a length of each second light shielding portion in the third direction is a second length, and a total length of all first portions of each third light shielding portion in the third direction is a fourth length;
a value obtained by rounding a ratio of the first length to the second length is a first ratio, and a value obtained by rounding a ratio of the third length to the fourth length is a second ratio;
within each light splitting structure, a sum of the first ratio and the second ratio corresponding to any first preset length line segment is equal; and
the first preset length line segment extends along the third direction, and a length of a projection of the first preset length line segment on the direction of the normal line of the first direction is a difference between P1 and P4, where P1 is a period in which the pixel bars are arranged, and P4 is a width of each first light shielding portion in a direction perpendicular to the first direction.

15. The display device according to claim 14, wherein a sum S of areas of orthogonal projections of the first portions comprised in each third light shielding portion on the display panel satisfies:
$$0.9 \times ( P 4 - \frac{P 1 \times \vert tan θ 1 \vert - {i}^{′} \times P 3}{\vert tan θ 1 \vert} ) \times P 5 \leq S \leq 1.1 \times ( P 4 - \frac{P 1 \times \vert tan θ 1 \vert - {i}^{′} \times P 3}{\vert tan θ 1 \vert} ) \times P 5 ;$$
where
$$\vert tan θ 1 \vert > 1. 1 \times \frac{i \times P 3}{P 1 - P 4} , or \vert tan θ 1 \vert < 0. 9 \times \frac{i \times P 3}{P 1 - P 4} ;$$
P3 is a period in which the second light shielding portions are arranged in the first direction, P5 is a width of each second light shielding portion in the first direction, i is the value obtained by rounding the ratio of the first length to the second length, and i′ is the sum of the first ratio and the second ratio.

16. The display device according to claim 15, wherein each third light shielding portion comprises a plurality of light shielding sub-portions having equal areas.

17. The display device according to claim 16, wherein the plurality of light shielding sub-portions comprise a first light shielding sub-portion and a second light shielding sub-portion respectively located on both sides of a respective second light shielding portion in the first direction; and
orthogonal projections of first portions on the display panel are adjacent to the orthogonal projection of the respective second light shielding portion on the display panel.

18. The display device according to claim 17, wherein the first light shielding sub-portion and the second light shielding sub-portion are staggered relative to each other in the direction of the normal line of the first direction.

19. The display device according to claim 18, wherein a distance P9 by which the first light shielding sub-portion and the second light shielding sub-portion are staggered relative to each other in the direction of the normal line of the first direction satisfies:
$$0.9 \times \frac{P 5}{\vert tan θ 1 \vert} \leq P 9 \leq 1.1 \times \frac{P 5}{\vert tan θ 1 \vert} .$$

20. The display device according to claim 1, wherein in the first direction, a width of the M light splitting structures is equal to a width of N columns of sub-pixels.
